(19) United States
(12) Patent Application Publication
(10) Pub. No.: US 2022/0122062 A1
(43) Pub. Date: Apr. 21, 2022

(54) SYSTEMS AND METHODS FOR FACILITATING TRANSACTIONS USING A DIGITAL CURRENCY

(71) Applicants: Jonathan Mayblum, Palm Beach Gardens, FL (US); Zachary Mayblum, Palm Beach Gardens, FL (US)

(72) Inventors: Jonathan Mayblum, Palm Beach Gardens, FL (US); Zachary Mayblum, Palm Beach Gardens, FL (US)

(21) Appl. No.: 17/564,988

(22) Filed: Dec. 29, 2021

Related U.S. Application Data
(63) Continuation-in-part of application No. 17/020,653, filed on Sep. 14, 2020.
Application No. 17/020,653 is a continuation of application No. 16/529,265, filed on Aug. 1, 2019, now Pat. No. 10,776,781.
(60) Provisional application No. 63/161,421, filed on Mar. 15, 2021.
(60) Provisional application No. 63/141,867, filed on Jan. 26, 2021.
(60) Provisional application No. 63/132,099, filed on Dec. 30, 2020.
(60) Provisional application No. 62/752,174, filed on Oct. 29, 2018.
(60) Provisional application No. 62/736,306, filed on Sep. 25, 2018.
(60) Provisional application No. 62/713,374, filed on Aug. 1, 2018.

(51) Int. Cl. G06Q 20/36; G06Q 20/40

(52) U.S. Cl. CPC G06Q 20/3678; G06Q 20/4016

(57) ABSTRACT

Systems and methods for facilitating transactions using a digital currency are described. In some aspects, a system is described for facilitating a private transaction between a first entity and a second entity using a government issued digital currency issued by a government institution. In some aspects, a system is described for facilitating a transaction between a first entity and a second entity using a digital currency issued by a bank or an entity with a bank charter. In some aspects, a digital wallet is described for one or more digital currencies from one or more financial institutions where the digital wallet is a self-hosted digital wallet. In some aspects, a digital wallet is described for one or more digital currencies from one or more financial institutions, including a line of credit based on a digital currency issued by a financial institution and that is fixed with respect to a fiat currency.

### CROSS REFERENCE TO RELATED APPLICATIONS

This application claims the benefit under 35 U.S.C. § 119(e) of U.S. Provisional Patent Application Ser. No. 63/132,099, filed Dec. 30, 2020, under Attorney Docket No. M1489.70001US00 and entitled “SYSTEMS AND METHODS FOR FACILITATING TRANSACTIONS USING A DIGITAL CURRENCY,” U.S. Provisional Patent Application Ser. No. 63/141,867, filed Jan. 26, 2021, under Attorney Docket No. M1489.70001US01 and entitled “SYSTEMS AND METHODS FOR FACILITATING TRANSACTIONS USING A DIGITAL CURRENCY,” and U.S. Provisional Patent Application Ser. No. 63/161,421, filed Mar. 15, 2021, under Attorney Docket No. M1489.70001US02 and entitled “SYSTEMS AND METHODS FOR FACILITATING TRANSACTIONS USING A DIGITAL CURRENCY,” each of which are hereby incorporated herein by reference in their entirety.

This application is a Continuation-in-Part of U.S. patent application Ser. No. 17/020,653, filed Sep. 14, 2020, under Attorney Docket No. M1489.70000US05 and entitled “SYSTEMS AND METHODS FOR FACILITATING TRANSACTIONS USING A DIGITAL CURRENCY,” which is a Continuation of U.S. patent application Ser. No. 16/529,265, filed Aug. 1, 2019, under Attorney Docket No. M1489.70000US03 and entitled “SYSTEMS AND METHODS FOR FACILITATING TRANSACTIONS USING A DIGITAL CURRENCY,” which claims the benefit under 35 U.S.C. § 119(e) of U.S. Provisional Patent Application Ser. No. 62/713,374, filed Aug. 1, 2018, under Attorney Docket No. M1489.70000US00 and entitled “SYSTEMS AND METHODS FOR FACILITATING TRANSACTIONS USING A DIGITAL CURRENCY,” U.S. Provisional Patent Application Ser. No. 62/736,306, filed Sep. 25, 2018, under Attorney Docket No. M1489.70000US01 and entitled “SYSTEMS AND METHODS FOR FACILITATING TRANSACTIONS USING A DIGITAL CURRENCY,” and U.S. Provisional Patent Application Ser. No. 62/752,174, filed Oct. 29, 2018, under Attorney Docket No. M1489.70000US02 and entitled “SYSTEMS AND METHODS FOR FACILITATING TRANSACTIONS USING A DIGITAL CURRENCY,” each of which are hereby incorporated herein by reference in their entirety.

### BACKGROUND

Cryptocurrencies, such as Bitcoin, are growing in popularity every day. These cryptocurrencies rely on blockchain technology that facilitates financial transactions without need for a central authority, such as a central server. However, the lack of a central authority that monitors such transactions has led to various issues for cryptocurrency adopters, including prevalence of fraudulent transactions, widely fluctuating value of the cryptocurrency, and lack of transparency regarding the transactions using the cryptocurrency. Typical financial institutions have been hesitant to adopt cryptocurrencies due to at least some of these issues. In one instance, financial institution JP Morgan's Chairman and CEO, Jamie Dimon, has called the Bitcoin cryptocurrency a “fraud” and has said it “won't end well.”

A cryptocurrency is a digital asset that can be used to perform financial transactions between two entities, such as a seller and a buyer. Financial transactions using the cryptocurrency are facilitated using a decentralized computing system that uses cryptography to secure the financial transactions. While the decentralized computing system may include multiple computing nodes, such as servers, computers, or other suitable computing nodes, the decentralized computing system does not have a central authority, such as a central server, that monitors financial transactions using the cryptocurrency. Instead, the computing nodes in the decentralized computing system use voting or another form of arriving at a consensus to approve or deny a certain financial transaction. Because cryptocurrencies have inherently low levels of regulation and are not governed by a central authority, the transactions cannot be closely monitored. These transactions do not require real names, so the involved parties can remain anonymous. However, this anonymity aspect of cryptocurrency can empower criminal activity. Cryptocurrencies have also become attractive to criminals thanks to their ability to easily carry millions of dollars' worth of cryptocurrency across international borders without detection.

In one instance, the decentralized computing system facilitates financial transactions using the cryptocurrency through a blockchain that serves as a database for financial transactions using the cryptocurrency. A blockchain is a continuously growing list of records, called blocks or transaction blocks, which are linked and secured using cryptography. Each new financial transaction may be added as a transaction block to the blockchain. For example, the block for a new financial transaction may include a cryptographic hash of the previous block, a time stamp, and transaction data. The cryptographic hash is used to generate a fixed-length mathematical representation of a variable amount of data, such as the previous block. For recording financial transactions, the blockchain is typically managed by the decentralized computing system, including the multiple computing nodes, to receive a new financial transaction, generate a new transaction block, validate the new transaction block, and insert the new transaction block into the blockhead. The new financial transaction is recorded in the transaction block typically in the form of “payer X sends Y cryptocurrency to payee Z.” Once recorded, the data in any given transaction block cannot be altered retroactively without alteration of subsequent blocks, which requires consensus of the computing nodes in the decentralized computing system.

### SUMMARY

The inventors have appreciated that current cryptocurrencies are consumer focused. While the cryptocurrencies have been adopted by a number of consumers, they are not acceptable for use by typical financial institutions, such as banks and other government-regulated financial institutions. The financial institutions use fiat currency for facilitating financial transactions. A fiat currency, such as the United States Dollar, is currency that is declared by a government to be legal tender. Unlike cryptocurrencies, a fiat currency typically does not have wide fluctuations in value over short periods of time. The financial institutions, such as banks and other government-regulated financial institutions, use a centralized computing system including a central authority, such as the financial institution, to transparently monitor financial transactions and to receive, validate, and record the financial transactions. Such a centralized computing system may prevent fraudulent financial transactions, such as an authorized attempt by an entity to retrieve currency from one or more account holders at the financial institution.

For example, the centralized computing system may require each attempted transaction to be authorized with a digital signature before the transaction is allowed to proceed. Because such transactions are regulated by the financial institution and/or the centralized computing system, the transactions may be closely monitored and require the involved parties to verify their identities for the transaction to occur. For example, the financial institution and/or the centralized computing system may require one or more of the involved parties to comply with “know your customer” (KYC) procedures to verify their identities and/or assess their suitability and potential risks of illegal activity. Such requirements will reduce illegal activity such as fraudulent transactions or money laundering. In some examples, the financial institution and/or centralized computing system may be anti-money laundering (AML) compliant or employ an anti-money laundering (AML) compliance program. According to some embodiments, rather than a centralized computing system, a decentralized computing system may be used to monitor financial transactions (e.g., any transaction described herein) and receive, validate, and record the financial transactions. The decentralized computing system may be capable of managing the public blockchain. For example, the decentralized computing system may be configured to add each new financial transaction may be added as a transaction block to a blockchain such as the public blockchain described in relation with FIG. 11A. The decentralized computing system may have multiple computing nodes for receiving a new financial transaction, generating a new transaction block, validating the new transaction block, and inserting the new transaction block into a blockhead. As described herein, the public blockchain may be used to facilitate a private transaction, for example, using a digital currency issued by a financial institution.

According to some embodiments, digital currency (e.g., issued by a financial institution, or not) may include tokens such as non-fungible tokens, open blockchain tokens (e.g., as described herein), tokens representing assets (e.g., stocks, gold, commodities, real estate, etc.), and/or other suitable tokens. In some embodiments, digital currency may include stakes in a decentralized autonomous organization (DAO) as described herein and/or other suitable implementations.

According to some embodiments, a public blockchain may be used to monitor financial transactions (e.g., any transaction described herein) and receive, validate, and record private financial transactions. A private company may operate the public blockchain. For example, a private company or entity may be configured to add each new financial transaction may be added as a transaction block to a blockchain such as the public blockchain described in relation with FIG. 11A and may have multiple computing nodes for receiving a new financial transaction, generating a new transaction block, validating the new transaction block, and inserting the new transaction block into a blockhead.

In some aspects, systems and methods are described herein to facilitate financial transactions using a financial institution-specific digital currency that is fixed with respect to a fiat currency, such as the United States Dollar. The financial institution may implement a distributed ledger that is private to the financial institution. The private distributed ledger is a continuously growing list of records, called blocks or transaction blocks, which are linked and secured using cryptography. Unlike a public blockchain, the private distributed ledger is not publicly available for recording transactions. However, the financial institution and/or its agents may record new financial transactions by adding corresponding transaction blocks to the private distributed ledger. For example, the block for a new financial transaction may include a cryptographic hash of the previous block, a time stamp, and transaction data. The cryptographic hash is used to generate a fixed-length mathematical representation of a variable amount of data, such as the previous block. The private distributed ledger may record transactions among the financial institution's customers using the financial institution's digital currency. In some embodiments, other financial institutions may also participate in transactions using the financial institution's digital currency. For example, the other financial institution may send information regarding the transaction to the original financial institution for inclusion in the private distributed ledger. In another example, the other financial institution may be allowed access to the private distributed ledger. The other financial institution may partner with or be approved by the original financial institution and have privileges to record transactions in the private distributed ledger.

In some aspects, the financial institution is able to provide its customers with digital currency transactions while still being able to keep track of the value of the digital currency transactions in its profit-and-loss models. For example, the financial institution may apply its deposits in the digital currency towards its reserve requirement needed to comply with banking regulations. In the United States, the reserve requirement is part of a federal banking regulation that requires the financial institution to keep a minimum amount of its assets in cash, i.e., fiat currency. Because the financial institution's digital currency is backed by the corresponding fiat currency, such as the United States Dollar, the financial institution may rely on the digital currency as being equivalent to the corresponding fiat currency to meet its reserve requirement. In some embodiments, the financial institution may tie the digital currency to the fiat currency where the financial institution resides, where the customer resides, or another fiat currency suitable for this application.

In some embodiments, there may be optionality for the reserve requirements based on different aspects of a financial entity. In some examples, different entities may be required or recommended to have different amounts of assets in fiat, such as less than the total amount of a requirement. In some examples, all or part of the reserve requirement may be met by different assets such as stocks, commodities, and/or the like. The different aspects of a financial entity may include the size, credit, rating of the financial entity and/or the like.

In some examples, the financial institution holding a reserve of fiat currency may be a private bank, and/or the government, and/or any other suitable entity, or a combination thereof, including the Federal Reserve, the Treasury, one or more central banks, one or more regional reserves, etc.

In some embodiments, the financial institution may include a government-regulated institution such as a virtual asset service provider (VASP). The VASP may include exchanges between virtual assets and fiat currencies; exchanges between multiple forms of virtual assets; the transfer of digital assets; the safekeeping and administration of virtual assets; and participating in and providing financial services relating to the offer and sale of a virtual asset. In some embodiments, the VASP may be required to comply with applicable requirements of the jurisdiction in which it does business, which generally includes implementing Anti-Money Laundering (AML) and counter-terrorism programs, be licensed or registered with its local government and be subject to supervision or monitoring by that government.

An advantage of at least some embodiments is the provision of transaction transparency because only the financial institution and/or authorized agents, such as retailers, can approve transactions using the digital currency. Another advantage of at least some embodiments is the elimination of producing proof of work, which is typically needed for a public blockchain, such as the Bitcoin blockchain. Proof of work is an algorithm used in a public blockchain to confirm transactions and record new transaction blocks in the public blockchain. The proof of work algorithm is needed because any entity, individual, or organization can record new transaction blocks in the public blockchain. However, in the private distributed ledger for the financial institution's digital currency, only the financial institution and/or authorized agents can record transaction blocks in the private distributed ledger, thereby eliminating the need to verify the transaction blocks using the proof of work algorithm. According to some embodiments, the blockchain may be implemented as a linked list, wherein each block comprises a pointer. In other embodiments, the blockchain may be implemented as a list, an indexed list, a directed acyclic graph (DAG), a table, tree (e.g., Merkle tree) and/or any data structure.

Another advantage of at least some embodiments is the provision of more security to the financial institution because the digital currency transactions can be stored in a private distributed ledger that is distributed across multiple servers, without need for a central transaction server. There is no longer a single point of failure in case the central transaction server was to be comprised. Another advantage of at least some embodiments is the provision of fast, low-cost transactions from one customer to another customer of the financial institution. In some implementations, merchants may accept the financial institution's digital currency and have the confidence that it is backed by a fiat currency (e.g., the digital currency does not fluctuate in value relative to its assigned fiat currency) and be able to immediately use the funds (e.g., as compared to the delay and expense of credit cards and debit cards). Another advantage of at least some embodiments is that customers, such as merchants and individual consumers, may receive benefits associated with using a digital currency, such as fast speed and low cost of transactions, and banks may receive the benefits associated with a fiat currency, such as being able to include deposits in their profit-and-loss models.

In some embodiments, each customer of the financial institution is given a digital currency account. The digital currency may be fixed with respect to a fiat currency, such as the United States Dollar, and the digital currency may be exchangeable between the user's digital currency account and the user's fiat currency account. Customers may receive benefits of typical fiat currency accounts, such as a checking account, where they can earn interest and receive deposit protection under insurance from the Federal Deposit Insurance Corporation (FDIC). In some embodiments, customers may receive additional promotions, such as interest boosters, for using digital currency accounts. The financial institution issuing the digital currency may attract more deposits by offering such digital currency accounts.

In some embodiments, the customer of the financial institution can request that an amount of fiat currency be exchanged into the financial institution's digital currency. The financial institution may create a new digital currency account for the customer and deposit into the account an amount of digital currency equivalent to the amount of fiat currency. Alternatively, the financial institution may deposit into the customer's existing digital currency account an amount of digital currency equivalent to the amount of fiat currency. In some embodiments, the customer's digital currency account is separate from, but attached to, the customer's fiat currency account at the financial institution. The financial institution may receive or retrieve the fiat currency from the customer's fiat currency account at the financial institution or another financial institution or from the customer in the form of physical fiat currency or cash.

Payments Using Blockchain Applications

In some aspects, the financial institution's customers, including individual consumers and merchants, can use the digital currency without risks associated with cryptocurrencies, such as Bitcoin. For example, a merchant may not want to accept conventional digital currency due to the risk that the value may decrease in a short period of time. From the individual consumer perspective, it is a concern that many individuals view digital currencies as investments. The individual consumer may not want to pay with digital currency due to the risk that the value may increase (and in turn the individual consumer “overpaid” for the item). That is, while individual consumers typically view conventional digital currencies, such as Bitcoin, as investments rather than currency they can spend, merchants typically view conventional digital currencies as risky because their value can fluctuate widely. A digital currency whose value is pegged to a fiat currency may obviate both these issues. Therefore, another advantage of at least some embodiments is that individual consumers as well as merchants may receive benefits of digital currency while avoiding the above-described issues associated with conventional digital currencies.

In some embodiments, a financial institution can choose to limit usage of its digital currency to customers of the financial institution and/or customers at other financial institutions that are approved by the financial institution. For transactions involving entities that are not approved by the financial institution, a conventional inter-bank transfer system, such as Automated Clearing House (ACH), may be used. ACH is an electronic network for fiat currency-based financial transactions in the United States. The use of the financial institution's digital currency may be beneficial even when used over the conventional inter-bank transfer system. Unlike conventional transactions involving credit and debit cards, transactions involving the digital currency may be completed immediately or within the same business day because of faster transaction speeds. In a conventional transaction involving a debit card, for example, the customer's account may be debited immediately but the merchant does not receive an immediate credit.

In some aspects, each financial institution may issue its own digital currency. The financial institutions may opt into a centralized clearing house for transactions involving digital currencies from two or more different financial institutions. Individual accounts may be debited and credited immediately, and the financial institutions may settle inter-bank transactions once a day or at some other frequency. In an example, a store that keeps its funds in a particular bank's digital currency account can still accept digital currency issued from another bank. The transaction may be cleared through a centralized clearing house for a transaction that involving digital currencies from two different financial institutions.

Another advantage of at least some embodiments is to provide digital currency to consumers that provides the same safety as keeping funds in fiat currency at a typical financial institution. In the near term, federal governments are unlikely to issue digital currency. In the United States, by tying the value of the digital currency to the United States Dollar, the digital currency is backed by the corresponding fiat currency, the United States Dollar. Moreover, unlike cryptocurrency exchanges where cryptocurrency funds are typically held and/or traded, financial institutions are regulated by the federal government. Typical cryptocurrency exchanges are unregulated businesses that allow customers to trade cryptocurrencies for other assets, such as fiat currencies, or other cryptocurrencies. In some embodiments, consumers may receive deposit insurance with their digital currency accounts similar to deposit insurance offered with fiat currency accounts. In the United States, the Federal Deposit Insurance Corporation (FDIC) is an independent agency of the United States government that protects deposit consumers against the loss of their insured deposits if an FDIC-insured financial institution fails. Consumers may perform transactions in digital currency using mobile applications, web applications, or a physical digital currency card and receive the same fraud protection as transactions in a fiat currency.

In some embodiments, consumers can perform transactions using any means that can authenticate their identity, such as passwords, biometrics, facial recognition, fingerprints, eye scans, and other suitable authentication means. In some embodiments, consumers can use any suitable payment means, such as text messaging, near field communication-enabled devices, mobile payment services, such as APPLE PAY, VENMO, PAYPAL, and other suitable payment means (APPLE PAY is a registered mark of Apple Inc., Cupertino, Calif., USA; VENMO and PAYPAL are registered marks of Paypal, Inc., San Jose, Calif.).

Another advantage of at least some embodiments is that unlike typical cryptocurrencies where anybody can enter transactions into the blockchain and it is permanent, the financial institution can decide whether it is the only authorized entity or to add other authorized agents to record transactions in the private distributed ledger. In some embodiments, the financial institution may allow an authorized agent, such as another financial institution, access to the private distributed ledger.

Ledger Access

For example, the financial institution may allow governments and/or financial regulators including U.S. agencies and joint international agencies (e.g., Federal Reserve Board (FRB), the Federal Deposit Insurance Corporation (FDIC), and the Securities and Exchange Commission (SEC), Office of the Comptroller of the Currency (OCC), etc.) access to the private distributed ledger. In some examples, the financial institution may use a cloud provider to store or access the private distributed ledger. In one example, the financial institution may partner with another entity and allow the entity access to one or more transactions in the distributed ledger. The entity may be one or more partner companies, for example, any combination of an investment management corporation, a risk management firm, and/or an institutional asset manager.

In some embodiments, the financial institution may allow an authorized agent to transmit transactions for insertion into the private distributed ledger but only the financial institution itself may record the transactions. Because the financial institution maintains control over who has access to the private distributed ledger and as such only the financial institution can approve such access, a heightened level of security may be provided to customers who use the financial institution's digital currency. In some embodiments, the financial institution may comply with a uniform set of rules required by a centralized clearing house, e.g., in order to handle transactions between different financial institutions involving respective digital currencies, as further described herein.

In some aspects, a system for facilitating a transaction between a first entity and a second entity using a digital currency comprises a computing node, wherein the computing node is connected to one or more computing nodes participating in a private distributed ledger for a financial institution, wherein the private distributed ledger stores one or more transaction blocks representing transactions in a digital currency that is issued by the financial institution and is fixed with respect to a fiat currency. The computing node is configured to store and maintain a copy of the private distributed ledger, receive a transaction for transferring an amount of digital currency from a first entity to a second entity, wherein the first entity and the second entity relate to the financial institution, generate a new transaction block representing the transaction for addition to the private distributed ledger, transmit the new transaction block to the one or more computing nodes participating in the private distributed ledger, receive, from the one or more computing nodes, an indication of validity of the new transaction block, and based on the indication of validity, insert the new transaction block into the private distributed ledger to complete the transaction for transferring the amount of digital currency from the first entity to the second entity.

In some embodiments, the transaction includes a digital signature of the first entity, wherein the indication of validity comprises an indication of validity of the digital signature of the first entity, wherein the computing node is further configured to receive, from the one or more computing nodes, an indication of invalidity of the new transaction block, wherein the indication of invalidity comprises an indication of invalidity of the digital signature of the first entity, and based on the indication of invalidity, deny the transaction and prevent insertion of the new transaction block into the private distributed ledger.

In some embodiments, the indication of validity comprises an indication of the first entity having a sufficient amount of digital currency required to complete the transaction, wherein the computing node is further configured to receive, from the one or more computing nodes, an indication of invalidity of the new transaction block, and based on the indication of invalidity comprising an indication of the first entity not having a sufficient amount of digital currency required to complete the transaction, determine that the first entity has access to an available amount of fiat currency equivalent to the sufficient amount of digital currency, exchange the available amount of fiat currency into the sufficient amount of digital currency required to complete the transaction, and retransmit the new transaction block to the one or more computing nodes participating in the private distributed ledger. In some embodiments, the second entity receives the amount of digital currency or an amount of fiat currency equivalent to the amount of digital currency when the transaction is complete.

In some embodiments, the first entity is a consumer, and the second entity is a merchant, and wherein the first entity and the second entity are customers of the financial institution.

In some embodiments, the transaction is initiated from a digital currency card, a mobile application or a web application configured for payment in the digital currency.

In some aspects, a system for facilitating a transaction between a first entity and a second entity using a digital currency comprises a computing node, wherein the computing node is connected to one or more computing nodes participating in a private distributed ledger for a first financial institution, wherein the private distributed ledger stores one or more transaction blocks representing transactions in a digital currency that is fixed with respect to a fiat currency. The computing node is configured to store and maintain a copy of the private distributed ledger, receive a transaction for transferring an amount of digital currency from a first entity to a second entity, wherein the first entity relates to the first financial institution and the second entity relates to a second financial institution, generate a new transaction block representing the transaction for addition to the private distributed ledger, transmit the new transaction block to the one or more computing nodes participating in the private distributed ledger, receive, from the one or more computing nodes, an indication of validity of the new transaction block, and based on the indication of validity, insert the new transaction block into the private distributed ledger to complete withdrawal of the amount of digital currency and exchange the amount of digital currency into an equivalent amount of fiat currency for transferring to the second entity relating to the second financial institution.

In some embodiments, the digital currency is associated with a digital wallet for one or more digital currencies from one or more financial institutions, comprising one or more pairs of public and private keys for a user holding one or more digital currencies from one or more of financial institutions, wherein each pair of public and private keys may be used by the user to receive and/or send a digital currency issued by a financial institution corresponding to the respective pair of public and private keys.

According to some embodiments, the digital wallet may be issued by one or more entities. For example, the one or more entities may include a financial entity, a financial technology company, a government entity (or a government institution or a government-regulated financial institution), a payment processor company, a technology company, a cloud company, a clearing house, a syndicate of banks, an entity with a bank charter and/or any suitable entity.

In some embodiments, no digital currency is stored in the digital wallet, and wherein a digital currency for a financial institution is stored and maintained in a private distributed ledger for the financial institution. In some embodiments, the digital currency may be stored in an exchange, brokerage, bank, online account such as Zelle, and/or the like.

In some embodiments, in order to use a digital currency from the digital wallet, a user authorizes use of the corresponding private key for the digital currency to digitally sign a transaction involving the digital currency.

In some embodiments, the digital wallet includes software in the form of an application installed locally on a computer, a mobile phone, and/or a tablet.

In some embodiments, the digital wallet is connected via an application programming interface (API) to a trusted third party, and wherein the stored pairs of public and private keys are managed by the trusted third party.

In some embodiments, the digital wallet includes hardware for storing the pairs of public and private keys, wherein the hardware includes a button that a user is required to physically press or touch in order to digitally sign a transaction, and wherein the hardware requires that a user enter a personal identification number (PIN) before the user can digitally sign a transaction.

In some embodiments, the digital wallet provides a user with consumer rewards, loyalty points, and/or geo-location rewards for using the digital wallet, and wherein reward levels for a user are determined based on a balance of digital currency maintained in the digital wallet and/or meeting one or more transaction thresholds.

In some aspects, a method for exchanging a first digital currency that is fixed with respect to a first fiat currency into a second digital currency that is fixed with respect to a second fiat currency comprises receiving, from a user, at a financial institution, a request to exchange an amount of a first digital currency that is fixed with respect to a first fiat currency into an equivalent amount of a second digital currency that is fixed with respect to a second fiat currency, storing the received request for currency exchange in a private distributed ledger for the financial institution, and transferring out the amount of the first digital currency from a digital wallet for the user and transferring in the equivalent amount of the second digital currency to the digital wallet for the user.

In some embodiments, in order to complete the received request for currency exchange, the financial institution transfers out a corresponding amount of the first fiat currency from a first omnibus account for the first fiat currency and transfers in a corresponding equivalent amount of the second fiat currency to a second omnibus account for the second fiat currency.

In some embodiments, the received request for currency exchange is performed in real-time, and wherein a current currency exchange rate is applied to the request.

In some embodiments, the user of the digital wallet may set one or more notifications relating to an exchange rate between the first fiat currency and the second fiat currency, and the request for currency exchange is initiated based on receipt of the one or more notifications.

In some aspects, a clearing house for facilitating digital currency transactions comprises a computing node, wherein the computing node is connected to one or more computing nodes participating in a private distributed ledger for the clearing house, wherein the private distributed ledger stores one or more transaction blocks representing transactions in one or more digital currencies. The computing node is configured to store and maintain a copy of the private distributed ledger, receive a transaction for transferring an amount of digital currency from a first digital wallet to a second digital wallet, wherein the digital currency is issued by a first financial institution and is fixed with respect to a fiat currency, wherein the first digital wallet belongs to a user of the first financial institution and the second digital wallet belongs to a user of a second financial institution, and wherein information regarding the transaction is sent to or received from, the first digital wallet at the first financial institution and/or the second digital wallet at the second financial institution, to be recorded on a private distributed ledger for the first financial institution and/or a private distributed ledger for the second financial institution, store a new transaction block representing the transaction in the private distributed ledger for the clearing house, and update the first digital wallet and the second digital wallet, thereby transferring the amount of digital currency from the first digital wallet to the second digital wallet.

In some embodiments, the clearing house is notified by the first financial institution and/or the second financial institution regarding the transaction for transferring the amount of digital currency from the first digital wallet to the second digital wallet.

In some embodiments, the clearing house is notified by the first financial institution regarding another transaction for transferring an amount of digital currency from the first digital wallet to another digital wallet, both digital wallets belonging to users of the first financial institution.

In some embodiments, the clearing house is notified by the second financial institution regarding another transaction for transferring an amount of digital currency from the second digital wallet to another digital wallet, both digital wallets belonging to users of the second financial institution.

In some embodiments, the clearing house incorporates a tiered structure for ranking financial institutions based on asset size, debt rating, and/or financial solvency tests for each financial institution.

In some embodiments, the first financial institution and the second financial institution belong to a highest tier and settle transactions between them periodically or if a balance limit is exceeded, and wherein the first financial institution belongs to a highest tier and the second financial institution belong to a lowest tier and settle transactions between them on an individual transaction basis or when a balance limit is exceeded.

In some embodiments, the clearing house stores a unique transaction number to track the transaction across the private distributed ledgers for the clearing house and the first and second financial institutions, and wherein the unique transaction number is assigned by the clearing house, the first financial institution, the second financial institution, or an independent entity for issuing unique transaction numbers.

In some embodiments, the clearing house is the authority for disputes regarding transactions between the first and second financial institutions.

In some embodiments, the clearing house charges fees for facilitating transactions between the first entity relating to the first financial institution and the second entity relating to the second financial institution, and wherein the clearing house does not hold any digital currency.

In some embodiments, the clearing house charges fees for facilitating transactions between the first entity relating to the first financial institution and a third entity relating to the first financial institution.

In some embodiments, the clearing house notifies the first financial institution and the second financial institution regarding appropriate timing for completing the transaction.

In some embodiments, the clearing house implements one or more “know your customer” policies to standardize a process for issuing digital wallets to users and/or approving third parties to be entrusted with holding digital currencies for users.

In some embodiments, on receiving, directly or from the first financial institution or the second financial institution, information regarding the transaction being fraudulent, being used to purchase illicit goods, and/or illegal in nature, the clearing house blocks the transaction based on the information, and wherein the clearing house freezes and/or revokes the first digital wallet and/or the second digital wallet involved in the transaction to prevent further illegal activity and/or cause for forfeiture of funds.

In some aspects, a method for exchanging a digital currency that is fixed with respect to a fiat currency into a digitized asset representative of a commodity comprises receiving, from a user, at a financial institution, a request to exchange an amount of a digital currency that is fixed with respect to a fiat currency into an equivalent portion of a digitized asset representative of a commodity; storing the received request for commodity exchange in a private distributed ledger for the financial institution, and transferring out the amount of the digital currency from a digital wallet for the user and transferring in the equivalent portion of the digitized asset representative of the commodity to the digital wallet for the user.

In some embodiments, the commodity includes gold, silver, platinum, copper, oil, natural gas, corn, soybeans, wheat, cocoa, coffee, cotton, or sugar. In some examples, the commodity may include stocks and/or options.

In some aspects, a system for facilitating a transaction between a first entity and a second entity using a digital currency comprises a computing node. The computing node is included in a plurality of computing nodes participating in a private distributed ledger for a financial institution. The private distributed ledger for the financial institution stores one or more transaction blocks representing transactions in a digital currency that is issued by the financial institution and is fixed with respect to a fiat currency. Each computing node in the plurality of computing nodes stores and maintains a respective copy of the private distributed ledger for the financial institution. The computing node is configured to store and maintain a copy of the private distributed ledger for the financial institution. The computing node is further configured to receive a transaction for transferring an amount of the digital currency from a first entity to a second entity, wherein the first entity and the second entity relate to the financial institution and at least some digital currency for the first entity is associated with a first omnibus account at the financial institution and at least some digital currency for the second entity is associated with a second omnibus account at the financial institution. According to another embodiment, the financial institution may authorize a clearinghouse to issue digital currency. The financial institution may subsequently and/or concurrently transfer an equivalent and/or appropriate amount of funds in an omnibus account at the financial institution. For example, an equivalent amount of funds may be an amount of fiat currency equivalent to the amount of digital currency issued (e.g., at the time the digital currency is issued). In some examples, an appropriate amount may be more or less than an amount of fiat currency equivalent to the amount of digital currency issued. The computing node is further configured to generate a new transaction block representing the transaction in the digital currency for addition to the private distributed ledger for the financial institution. The computing node is further configured to transmit the new transaction block to the plurality of computing nodes participating in the private distributed ledger for the financial institution. The computing node is further configured to receive, from the plurality of computing nodes, an indication of validity of the new transaction block, wherein the indication of validity comprises an indication of validity of a digital signature of the first entity included in the transaction involving the digital currency. The computing node is further configured to, based on the indication of validity, insert the new transaction block into the copy of the private distributed ledger for the financial institution to complete the transaction for transferring the amount of the digital currency from the first entity to the second entity, wherein each computing node in the plurality of computing nodes includes the new transaction block in a respective copy of the private distributed ledger for the financial institution.

In some embodiments, the new transaction block is generated at the financial institution and transmitted to a clearing house for insertion into a private distributed ledger for the clearing house. In some embodiments, the new transaction block is generated at the clearing house and transmitted to the financial institution for insertion into the private distributed ledger for the financial institution.

In some embodiments, the computing node is further configured to receive, from the one or more computing nodes, an indication of invalidity of the new transaction block, wherein the indication of invalidity comprises an indication of invalidity of the digital signature of the first entity, and based on the indication of invalidity, deny the transaction and prevent insertion of the new transaction block into the private distributed ledger for the financial institution.

In some embodiments, the indication of validity further comprises an indication of the first entity having a sufficient amount of digital currency required to complete the transaction, wherein the computing node is further configured to receive, from the one or more computing nodes, an indication of invalidity of the new transaction block. The computing node is further configured to, based on the indication of invalidity comprising an indication of the first entity not having a sufficient amount of digital currency required to complete the transaction, determine that the first entity has access to an available amount of fiat currency equivalent to the sufficient amount of digital currency, exchange the available amount of fiat currency into the sufficient amount of digital currency required to complete the transaction and transfer the available amount of the fiat currency to an omnibus account at the financial institution, retransmit the new transaction block to the one or more computing nodes participating in the private distributed ledger for the financial institution, receive, from the plurality of computing nodes, the indication of validity of the new transaction block, wherein the indication of validity comprises the indication of validity of the digital signature of the first entity included in the transaction involving the digital currency, and based on the indication of validity, insert the new transaction block into the copy of the private distributed ledger for the financial institution to complete the transaction for transferring the amount of the digital currency from the first entity to the second entity, wherein each computing node in the plurality of computing nodes includes the new transaction block in a respective copy of the private distributed ledger for the financial institution.

In some embodiments, the second entity receives the amount of digital currency or an amount of fiat currency equivalent to the amount of digital currency when the transaction is complete.

In some embodiments, the transaction is initiated from a digital currency card, a mobile application or a web application configured for payment in the digital currency.

In some embodiments, the digital currency card, the mobile application or the web application require a personal identification number (PIN), a password, biometrics, facial recognition, a fingerprint, and/or an eye scan.

In some embodiments, the first omnibus account and the second omnibus account are a same omnibus account or different omnibus accounts.

In some embodiments, the financial institution can have deposit insurance for an amount of the fiat currency that is equivalent in value to the amount of the digital currency, being backed or supported by the fiat currency held by each entity in an omnibus account at the financial institution.

In some embodiments, a relationship for the first entity to the second entity is selected from the group consisting of: individual to individual, individual to individuals, individual to business, individual to businesses, individual to business and individuals, individual to businesses and individual, individual to businesses and individuals, individuals to individual, individuals to individuals, individuals to business, individuals to businesses, individuals to business and individual, individuals to business and individuals, individuals to businesses and individual, individuals to businesses and individuals, business to individual, business to individuals, business to business, business to businesses, business to business and individual, business to business and individuals, business to businesses and individual, business to businesses and individuals, businesses to individual, businesses to individuals, businesses to business, businesses to businesses, businesses to business and individual, businesses to business and individuals, businesses to businesses and individual, businesses to businesses and individuals, government to government, government to business, business to government, government to citizen, and citizen to government.

In some aspects, a clearing house for facilitating digital currency transactions comprises a computing node. The computing node is included in a plurality of computing nodes participating in a private distributed ledger for the clearing house. The private distributed ledger for the clearing house stores one or more transaction blocks representing transactions in one or more digital currencies. Each computing node in the plurality of computing nodes stores and maintains a respective copy of the private distributed ledger for the clearing house. The computing node is configured to store and maintain a copy of the private distributed ledger for the clearing house. The computing node is further configured to receive a transaction for transferring an amount of digital currency from a first entity related to a first financial institution to a second entity related to a second financial institution, wherein the digital currency is issued by the first financial institution and is fixed with respect to a fiat currency, wherein at least some digital currency for the first entity is associated with a first omnibus account at the first financial institution and at least some digital currency for the second entity is associated with a second account at the second financial institution (e.g., a second entity satisfying KYC), and wherein information regarding the transaction is sent to and/or received from the clearing house, the first financial institution and/or the second financial institution to be recorded on the private distributed ledger for the clearing house, a private distributed ledger for the first financial institution and/or a private distributed ledger for the second financial institution. The computing node is further configured to, based on receiving, from the plurality of computing nodes, an indication of validity of a digital signature of the first entity included in the transaction involving the digital currency, store a new transaction block in the private distributed ledger for the clearing house representing the transaction for transferring the amount of the digital currency from the first entity at the first financial institution to the second entity at the second financial institution, wherein each computing node in the plurality of computing nodes includes the new transaction block in a respective copy of the private distributed ledger for the clearing house.

In some embodiments, an amount of the digital currency is transferred to the second entity. In some embodiments, an amount of a second digital currency, issued by the second financial institution and fixed with respect to the fiat currency, equivalent to the amount of the digital currency is transferred to the second entity. In some embodiments, an amount of the fiat currency corresponding to the amount of the digital currency is transferred immediately or at a later time from the first omnibus account at the first financial institution to the second omnibus account at the second financial institution.

In some embodiments, the first financial institution notifies the clearing house on issue of the digital currency, and the clearing house is notified by the first financial institution and/or the second financial institution regarding the transaction for transferring an amount of fiat currency corresponding to the amount of the digital currency from the first omnibus account to the second omnibus account.

In some embodiments, the clearing house incorporates a tiered structure for ranking financial institutions based on asset size, debt rating, and/or financial solvency tests for each financial institution, wherein the first financial institution and the second financial institution belong to a highest tier and settle transactions between them periodically or when a balance limit is exceeded, and wherein the first financial institution belongs to the highest tier and a third financial institution belongs to a lowest tier and settle transactions between them on an individual transaction basis, or periodically, or when the balance limit is exceeded.

In some embodiments, the clearing house notifies the first financial institution and the second financial institution regarding timing for completing the transaction, wherein the timing for completing the transaction includes immediate settlement for the transaction, or once a day, week or month to allow aggregation and/or reduce settlement costs. In some embodiments, the transaction is completed based on an aggregate balance owed between the first financial institution and the second financial institution.

In some aspects, a method for facilitating a transaction between a first entity and a second entity using a digital currency issued by a financial institution and fixed with respect to a fiat currency is implemented on a computing node included in a plurality of computing nodes participating in a private distributed ledger for a financial institution. Each computing node in the plurality of computing nodes storing and maintaining a respective copy of the private distributed ledger for the financial institution. The method comprises storing and maintaining a copy of the private distributed ledger for the financial institution, wherein the private distributed ledger for the financial institution stores one or more transaction blocks representing transactions in the digital currency that is issued by the financial institution and is fixed with respect to the fiat currency. The method further comprises receiving a transaction for transferring an amount of the digital currency from a first entity to a second entity, wherein the first entity and the second entity are associated with a first omnibus account and a second omnibus account at the financial institution. The method further comprises generating a new transaction block representing the transaction in the digital currency for addition to the private distributed ledger for the financial institution. The method further comprises transmitting the new transaction block to the plurality of computing nodes participating in the private distributed ledger for the financial institution. The method further comprises receiving, from the plurality of computing nodes, an indication of validity of the new transaction block, wherein the indication of validity comprises an indication of validity of a digital signature of the first entity. The method further comprises, based on the indication of validity, inserting the new transaction block into the copy of the private distributed ledger for the financial institution to complete the transaction for transferring the amount of the digital currency from the first entity to the second entity, wherein each computing node in the plurality of computing nodes includes the new transaction block in a respective copy of the private distributed ledger for the financial institution.

In some embodiments, the new transaction block is generated at the financial institution and transmitted to a clearing house for insertion into a private distributed ledger for the clearing house. In some embodiments, the new transaction block is generated at the clearing house and transmitted to the financial institution for insertion into the private distributed ledger for the financial institution.

In some embodiments, the method further comprises receiving, from the one or more computing nodes, an indication of invalidity of the new transaction block, wherein the indication of invalidity comprises an indication of invalidity of the digital signature of the first entity, and based on the indication of invalidity, denying the transaction and prevent insertion of the new transaction block into the private distributed ledger for the financial institution.

In some embodiments, the indication of validity further comprises an indication of the first entity having a sufficient amount of digital currency required to complete the transaction, and the method further comprises receiving, from the one or more computing nodes, an indication of invalidity of the new transaction block. The method further comprises, based on the indication of invalidity comprising an indication of the first entity not having a sufficient amount of digital currency required to complete the transaction, determining that the first entity has access to an available amount of fiat currency equivalent to the sufficient amount of digital currency, exchanging the available amount of fiat currency into the sufficient amount of digital currency required to complete the transaction and transferring the available amount of the fiat currency to an omnibus account at the financial institution, retransmitting the new transaction block to the one or more computing nodes participating in the private distributed ledger for the financial institution, receiving, from the plurality of computing nodes, the indication of validity of the new transaction block, wherein the indication of validity comprises the indication of validity of the digital signature of the first entity, and based on the indication of validity, inserting the new transaction block into the copy of the private distributed ledger for the financial institution to complete the transaction for transferring the amount of the digital currency from the first entity to the second entity, wherein each computing node in the plurality of computing nodes includes the new transaction block in a respective copy of the private distributed ledger for the financial institution.

In some embodiments, the second entity receives the amount of digital currency or an amount of fiat currency equivalent to the amount of digital currency when the transaction is complete.

In some embodiments, the transaction is initiated from a digital currency card, a mobile application or a web application configured for payment in the digital currency.

In some embodiments, the digital currency card, the mobile application or the web application require a personal identification number (PIN), a password, biometrics, facial recognition, a fingerprint, and/or an eye scan.

In some embodiments, the first omnibus account and the second omnibus account are a same omnibus account or different omnibus accounts.

In some embodiments, the financial institution has deposit insurance for an amount of the fiat currency that is equivalent in value to the amount of the digital currency, being backed or supported by the fiat currency held by each entity in an omnibus account at the financial institution.

In some embodiments, a relationship for the first entity to the second entity is selected from the group consisting of: individual to individual, individual to individuals, individual to business, individual to businesses, individual to business and individuals, individual to businesses and individual, individual to businesses and individuals, individuals to individual, individuals to individuals, individuals to business, individuals to businesses, individuals to business and individual, individuals to business and individuals, individuals to businesses and individual, individuals to businesses and individuals, business to individual, business to individuals, business to business, business to businesses, business to business and individual, business to business and individuals, business to businesses and individual, business to businesses and individuals, businesses to individual, businesses to individuals, businesses to business, businesses to businesses, businesses to business and individual, businesses to business and individuals, businesses to businesses and individual, and businesses to businesses and individuals.

In some aspects, a method for a clearing house to facilitate digital currency transactions between a first entity related to a first financial institution and a second entity related to a second financial institution is implemented on a computing node included in a plurality of computing nodes participating in a private distributed ledger for the clearing house. Each computing node in the plurality of computing nodes storing and maintaining a respective copy of the private distributed ledger for the clearing house. The method comprises storing and maintaining a copy of the private distributed ledger for the clearing house, wherein the private distributed ledger for the clearing house stores one or more transaction blocks representing transactions in one or more digital currencies. The method further comprises receiving a transaction for transferring an amount of digital currency from a first entity related to a first financial institution to a second entity related to a second financial institution, wherein the digital currency is issued by the first financial institution and is fixed with respect to a fiat currency, wherein the first entity is associated with a first omnibus account at the first financial institution and the second entity is associated with a second omnibus account at the second financial institution, and wherein information regarding the transaction is sent to and/or received from the clearing house, the first financial institution and/or the second financial institution to be recorded on the private distributed ledger for the clearing house, a private distributed ledger for the first financial institution and/or a private distributed ledger for the second financial institution. The method further comprises based on receiving, from the plurality of computing nodes, an indication of validity of a digital signature of the first entity included in the transaction involving the digital currency, storing a new transaction block in in the private distributed ledger for the clearing house representing the transaction for transferring the amount of the digital currency from the first entity at the first financial institution to the second entity at the second financial institution, wherein each computing node in the plurality of computing nodes includes the new transaction block in a respective copy of the private distributed ledger for the clearing house.

In some embodiments, an amount of the digital currency is transferred to the second entity. In some embodiments, an amount of a second digital currency, issued by the second financial institution and fixed with respect to the fiat currency, equivalent to the amount of the digital currency is transferred to the second entity. In some embodiments, an amount of the fiat currency corresponding to the amount of the digital currency is transferred immediately or at a later time from the first omnibus account at the first financial institution to the second omnibus account at the second financial institution.

In some embodiments, the first financial institution notifies the clearing house on issue of the digital currency, and the clearing house is notified by the first financial institution and/or the second financial institution regarding the transaction for transferring an amount of fiat currency corresponding to the amount of the digital currency from the first omnibus account to the second omnibus account.

In some embodiments, the clearing house incorporates a tiered structure for ranking financial institutions based on asset size, debt rating, and/or financial solvency tests for each financial institution, wherein the first financial institution and the second financial institution belong to a highest tier and settle transactions between them periodically or when a balance limit is exceeded, and wherein the first financial institution belongs to the highest tier and a third financial institution belongs to a lowest tier and settle transactions between them on an individual transaction basis, or periodically, or when the balance limit is exceeded.

In some embodiments, the clearing house notifies the first financial institution and the second financial institution regarding timing for completing the transaction, wherein the timing for completing the transaction includes immediate settlement for the transaction, or once a day, week or month to allow aggregation and/or reduce settlement costs. In some embodiments, the transaction is completed based on an aggregate balance owed between the first financial institution and the second financial institution.

In some aspects, a method for facilitating an exchange of a digital currency issued by a financial institution and that is fixed with respect to a fiat currency, comprises receiving, from a user, at a financial institution, a request to exchange an amount of a first digital currency that is fixed with respect to a first fiat currency into an equivalent amount of a second digital currency that is fixed with respect to a second fiat currency, storing the received request for currency exchange in a private distributed ledger for the financial institution, and transferring out the amount of the first digital currency from a digital wallet for the user and transferring in the equivalent amount of the second digital currency to the digital wallet for the user.

In some embodiments, the financial institution maintains an omnibus account or multiple accounts for each digital currency that is fixed with respect to a fiat currency.

In some embodiments, each omnibus account includes an amount of the fiat currency equivalent to an amount of the digital currency issued by the financial institution.

In some embodiments, in order to complete the received request for currency exchange, the financial institution transfers out a corresponding amount of the first fiat currency from a first omnibus account for the first fiat currency and transfers in a corresponding equivalent amount of the second fiat currency to a second omnibus account for the second fiat currency.

In some embodiments, the financial institution tracks ownership of digital currency issued by the financial institution, which has deposit insurance for an amount of fiat currency that is equivalent in value to an amount of the digital currency, being backed or supported by the fiat currency in an omnibus account at the financial institution.

In some embodiments, the digital wallet for the user includes an indication of a country that is insuring the financial institution relating to the digital currency in the digital wallet for the user, and/or wherein the digital wallet includes a color and/or a code indication regarding the country that is insuring the financial institution relating to the digital currency in the digital wallet for the user or that the financial institution is not insured relating to the digital currency in the digital wallet for the user.

In some embodiments, the received request for currency exchange is performed in real-time, and wherein a current currency exchange rate is applied to the request. In some embodiments, the received request for currency exchange is set to happen at an exchange price or based on an exchange price at the time of the transaction. Having the received request for currency exchange based on an exchange price at the time of the transaction may be advantageous to have an exact amount of currency needed to be converted; however, this embodiment may carry a risk of price fluctuation affecting the final exchange price used for the transaction.

In some embodiments, the user can access different exchange prices for one or more foreign currencies from multiple entities providing foreign exchange services. The user may select a particular entity for their foreign currency exchange transaction based on better pricing, reputation, speed of transaction, and/or suitable factors related to the particular entity.

In some embodiments, the user of the digital wallet sets one or more notifications relating to an exchange rate between the first fiat currency and the second fiat currency.

In some embodiments, the request for currency exchange is initiated automatically based on receipt of the one or more notifications.

In some embodiments, the second digital currency is issued by a financial institution different from the financial institution that issued the first digital currency.

In some embodiments, the method further comprises receiving, from the user, at the financial institution, a request to exchange an amount of the first digital currency that is fixed with respect to the first fiat currency into an equivalent portion of a digitized asset representative of a commodity, storing the received request for commodity exchange in the private distributed ledger for the financial institution, and transferring out the amount of the digital currency from the digital wallet for the user and transferring in the equivalent portion of the digitized asset representative of the commodity to the digital wallet for the user.

In some embodiments, the commodity includes gold, silver, platinum, copper, oil, natural gas, corn, soybeans, wheat, cocoa, coffee, cotton, or sugar.

In some embodiments, the financial institution may be responsible for holding cryptocurrency, such as Bitcoin or another suitable cryptocurrency, so that the financial institution is responsible for the security of the cryptocurrency. The financial institution may issue digital currency that is backed by that cryptocurrency. This may safeguard consumer deposits against situations where cryptocurrency exchanges may misplace funds, or the funds may be stolen by bad actors.

In some embodiments, the commodity is represented as the digitized asset in the form of a token to be included in a digital transaction and/or stored in the digital wallet for the user.

In some embodiments, the digitized asset for the commodity is stored in a portion of the digital wallet separate from a portion for the first and second digital currencies.

In some embodiments, the value for the digitized asset fluctuates based on a value of the commodity, and wherein the digital wallet indicates the current value, an amount of the commodity owned, and/or the value at the time of the transaction.

In some embodiments, the digital wallet indicates to the user the value of the digitized asset fluctuates based on the value of the commodity.

In some aspects, a system for facilitating an exchange of a digital currency issued by a financial institution and that is fixed with respect to a fiat currency comprises a computing node. The computing node is included in a plurality of computing nodes participating in a private distributed ledger for a financial institution. The private distributed ledger for the financial institution stores one or more transaction blocks representing transactions in one or more digital currencies issued by the financial institution and fixed with respect to an associated fiat currency. Each computing node in the plurality of computing nodes stores and maintains a respective copy of the private distributed ledger for the financial institution. The computing node is configured to store and maintain a copy of the private distributed ledger for the financial institution. The computing node is further configured to receive a transaction for exchanging an amount of a first digital currency that is fixed with respect to a first fiat currency into an equivalent amount of a second digital currency that is fixed with respect to a second fiat currency, wherein the first digital currency and the second digital currency are issued by the financial institution, wherein the first digital currency is associated with a first omnibus account at the financial institution and the second digital currency is associated with a second omnibus account at the financial institution. The computing node is further configured to generate a new transaction block representing the transaction for addition to the private distributed ledger for the financial institution. The computing node is further configured to transmit the new transaction block to the plurality of computing nodes participating in the private distributed ledger for the financial institution. The computing node is further configured to receive, from the plurality of computing nodes, an indication of validity of the new transaction block. The computing node is further configured to, based on the indication of validity, insert the new transaction block into the copy of the private distributed ledger for the financial institution to complete the transaction for transferring out the amount of the first digital currency from a digital wallet for the user and transferring in the equivalent amount of the second digital currency to the digital wallet for the user, wherein the financial institution transfers out a corresponding amount of the first fiat currency from the first omnibus account for the first fiat currency and transfers in a corresponding equivalent amount of the second fiat currency to the second omnibus account for the second fiat currency, wherein each computing node in the plurality of computing nodes includes the new transaction block in a respective copy of the private distributed ledger for the financial institution.

In some aspects, a digital wallet for one or more digital currencies from one or more financial institutions comprises one or more pairs of public and private keys for a user holding one or more digital currencies from one or more of financial institutions, including a digital currency issued by a financial institution and that is fixed with respect to a fiat currency, wherein a pair of public and private keys is used by the user to receive and/or send the digital currency issued by the financial institution corresponding to the pair of public and private keys and to record a transaction in the digital currency in a private distributed ledger for the financial institution.

In some embodiments, no digital currency is stored in the digital wallet, and wherein the digital currency issued by the financial institution is stored and maintained in the private distributed ledger for the financial institution and/or a clearing house.

In some embodiments, in order to use the digital currency from the digital wallet, a user authorizes use of the corresponding private key for the digital currency to digitally sign the transaction involving the digital currency.

In some embodiments, the digital wallet includes software in the form of an application installed locally on a computer, a mobile phone, and/or a tablet.

In some embodiments, the digital wallet includes a mobile wallet, a desktop wallet, and/or a hardware wallet.

In some embodiments, the mobile wallet, the desktop wallet, and/or the hardware wallet requires a personal identification number (PIN), a password, biometrics, facial recognition, a fingerprint, and/or an eye scan.

In some embodiments, the digital wallet is connected via an application programming interface (API) to a trusted third party, and wherein the one or more pairs of public and private keys are managed by the trusted third party.

In some embodiments, the digital wallet includes hardware for storing the one or more pairs of public and private keys.

In some embodiments, the hardware includes a button that a user is required to physically press or touch in order to digitally sign the transaction.

In some embodiments, the hardware requires that a user submit a personal identification number (PIN), a password, biometrics, facial recognition, a fingerprint, and/or an eye scan before the user can digitally sign the transaction.

In some embodiments, the digital wallet provides a user with consumer rewards, loyalty points, and/or geo-location rewards for using the digital wallet.

In some embodiments, a reward level for a user is determined based on a balance of the digital currency maintained in the digital wallet and/or meeting one or more transaction thresholds.

In some aspects, a digital wallet for one or more digital currencies from one or more financial institutions comprises one or more pairs of public and private keys for a user holding one or more digital currencies from one or more of financial institutions, including a digital currency issued by a financial institution and that is fixed with respect to a fiat currency, wherein a plurality of computing nodes participate in a private distributed ledger for the financial institution, each computing node in the plurality of computing nodes stores and maintains a copy of the private distributed ledger, the private distributed ledger stores one or more transaction blocks representing transactions in the digital currency, a private key of a pair of public and private keys is used to generate a digital signature for the user to record, on the private distributed ledger, a transaction in the digital currency issued by the financial institution and corresponding to the pair of public and private keys, and based on an indication of validity of the digital signature, from the plurality of computing nodes, a new transaction block representing the transaction is inserted into the private distributed ledger to complete the transaction in the digital currency.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various non-limiting embodiments of the technology will be described with reference to the following figures. It should be appreciated that the figures are not necessarily drawn to scale.

FIG. 1 shows block diagrams of illustrative systems for facilitating transactions using a digital currency in accordance with some embodiments of the technology described herein;

FIG. 2 is another block diagram of an illustrative system for facilitating transactions using a digital currency in accordance with some embodiments of the technology described herein;

FIG. 3 shows illustrative diagrams of exemplary transactions using a digital currency in accordance with some embodiments of the technology described herein;

FIG. 4 is a diagram of an exemplary process for facilitating transactions using a digital currency in accordance with some embodiments of the technology described herein;

FIG. 5 is a diagram of an exemplary process that is executed when a transaction block is determined to be invalid in accordance with some embodiments of the technology described herein;

FIG. 6 is a diagram of an exemplary process for creating and/or populating a digital wallet using a digital currency in accordance with some embodiments of the technology described herein;

FIG. 7 shows illustrative diagrams of exemplary transactions in a digital currency using a digital wallet in accordance with some embodiments of the technology described herein;

FIG. 8 shows an example implementation of a computing node for a private distributed ledger in accordance with some embodiments of the technology described herein;

FIG. 9 shows an example computer system for executing one or more functions for a private distributed ledger in accordance with some embodiments of the technology described herein;

FIG. 10A is a diagram of an exemplary process for facilitating an exchange of government issued digital currency to fiat currency in accordance with some embodiments of the technology described herein;

FIG. 10B is a diagram of an exemplary process for facilitating an exchange of government issued digital currency to digital currency issued by another financial institution in accordance with some embodiments of the technology described herein;

FIG. 10C is a diagram of an exemplary process for facilitating an exchange of a first government issued digital currency to a second government issued digital currency in accordance with some embodiments of the technology described herein;

FIG. 11A is a diagram of an exemplary public blockchain on which an application for private and/or public transactions may be run in accordance with some embodiments of the technology described herein;

FIG. 11B shows a block diagram of illustrative systems for facilitating transactions using a public blockchain in accordance with some embodiments of the technology described herein;

FIG. 12A shows a block diagram of an illustrative system for facilitating private transactions on a public blockchain using a digital currency in accordance with some embodiments of the technology described herein;

FIG. 12B shows a block diagram of an illustrative system for facilitating private transactions on a public blockchain using a digital currency in accordance with some embodiments of the technology described herein;

FIG. 13 is a diagram of an exemplary process for facilitating a private transaction on a blockchain using a digital currency issued by a financial institution in accordance with some embodiments of the technology described herein; and

FIG. 14 is a diagram of an exemplary process for facilitating a private transaction on a blockchain using a digital currency issued by a financial institution in accordance with some embodiments of the technology described herein.

### DETAILED DESCRIPTION

In some aspects, systems and methods are described herein to facilitate financial transactions using a financial institution-specific digital currency that is fixed with respect to a fiat currency, such as the United States Dollar. The financial institution may implement a distributed ledger that is private to the financial institution. The private distributed ledger may interact with a public ledger and/or run on a public ledger. For example, functionality to conduct private transactions for the private distributed ledger may be implemented using an application that runs on a public blockchain. This public blockchain may optionally provide support for other financial and/or non-financial applications in addition to the functionality for conducting private transactions for the private distributed ledger. In some embodiments, within a public distributed ledger, a portion can be designated as private and the distribution more limited based on the digital currency, user, and/or other suitable information. Additionally or alternatively, a private distributed ledger may share or receive information and/or transaction blocks from or with/within a public system. The described systems and methods may be implemented using any one or more of the distributed ledgers described herein or another suitable variation thereof. The private distributed ledger is a continuously growing list of records, called blocks or transaction blocks, which are linked and secured using cryptography. Each new financial transaction may be added as a transaction block to the distributed ledger. For example, the block for a new financial transaction may include a cryptographic hash of the previous block, a time stamp, and transaction data. The cryptographic hash is used to generate a fixed-length mathematical representation of a variable amount of data, such as the previous block. The private distributed ledger may record transactions among the financial institution's customers using the financial institution's digital currency.

In some aspects, a purchase transaction is facilitated between two entities, a customer and a store, relating to the same financial institution, such as a bank. The bank may issue a digital currency card for transaction in the bank's digital currency. The bank's customer may visit a store that also keeps funds with the bank. The customer may provide the bank's digital currency card to pay for an item using the bank's digital currency. In some embodiments, the bank provides a device that can accept the bank's digital currency card and notify a server at the bank to complete the transaction (e.g., by recording the transaction in the private distributed ledger). In some embodiments, a machine provided by VISA, MASTERCARD, AMEX, SQUARE, or another payment company, can accept the digital currency card (VISA, MASTERCARD, AMEX, and SQUARE are registered marks of, respectively, Visa Inc., Foster City, Calif., USA; Mastercard Incorporated, Purchase, N.Y., USA; American Express Company, New York, N.Y., USA; and Square, Inc., San Francisco, Calif.). The machine may relay information regarding the transaction to the payment company's processing center, which in turn notifies the bank. Subsequently, a server at the bank may complete the transaction (e.g., by recording the transaction in the private distributed ledger). In some embodiments, a centralized clearing house may record the transaction in a private distributed ledger for the clearing house. In some embodiments, the transaction may be recorded in the financial institution's private distributed ledger and subsequently relayed for recordation in the clearing house's private distributed ledger. In some embodiments, the transaction may be simultaneously recorded in the financial institution's private distributed ledger and the clearing house's private distributed ledger. In some embodiments, the transaction may be recorded in the clearing house's private distributed ledger and once approved by the clearing house, recorded in the financial institution's private distributed ledger.

In some embodiments, the digital currency is transferred from the customer's digital currency account to the store's digital currency account. If the store wishes to complete the transaction in a fiat currency, the bank may exchange the received digital currency into fiat currency, such as the United States Dollar, and deposit the fiat currency into the store's fiat currency account at the bank.

In some aspects, a funds transfer transaction is facilitated between two entities, e.g., two customers, relating to the same financial institution, such as a bank. For example, a customer of the bank may request a digital transfer of an amount of digital currency to another customer of the same bank. In some embodiments, the financial institution has a private distributed ledger stored across multiple computing nodes. The private distributed ledger stores one or more transaction blocks representing transactions in the digital currency that is issued by the financial institution and is fixed with respect to a fiat currency. A computing node receives a transaction for transferring an amount of digital currency from a first customer to a second customer of the financial institution. The computing node generates a new transaction block representing the transaction for addition to the private distributed ledger. The computing node transmits the new transaction block to the one or more computing nodes participating in the private distributed ledger. The computing node receives an indication of validity of the new transaction block. If the indication is valid, the computing node inserts the new transaction block into the private distributed ledger to complete the transaction.

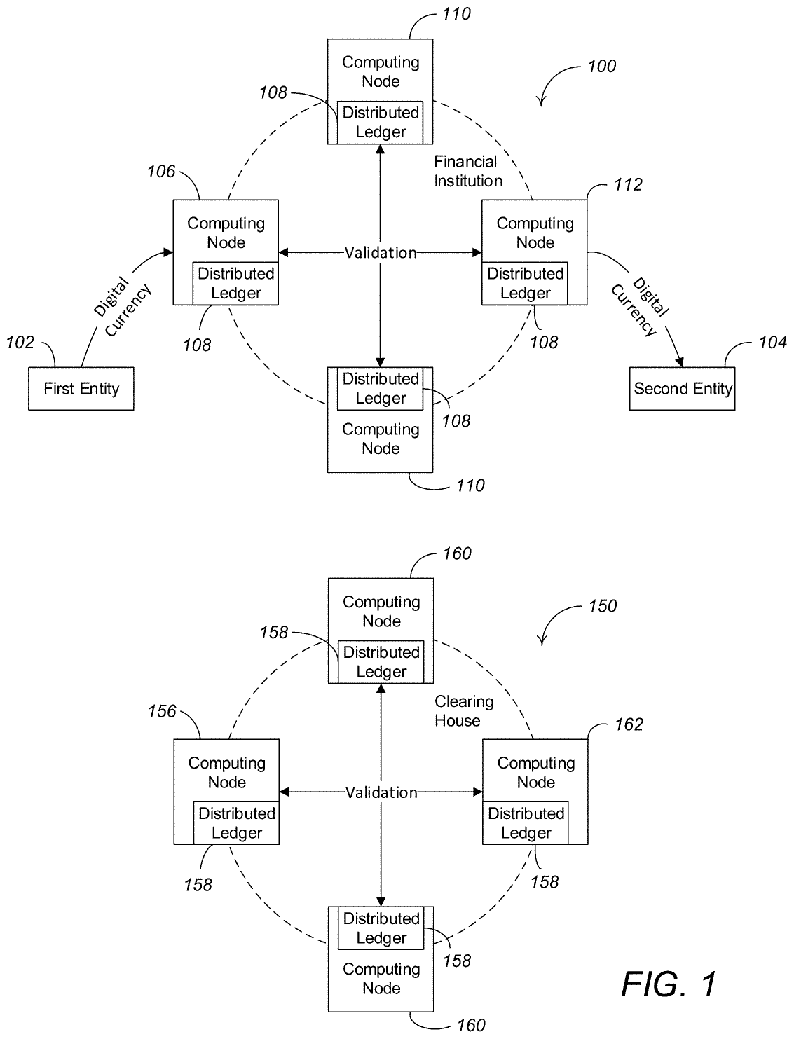

FIG. 1 shows a block diagram of an illustrative system 100 for facilitating transactions using a digital currency between a first entity 102 and a second entity 104 relating to the same financial institution in accordance with some embodiments of the technology described herein. A computing node 106 is connected to other computing nodes 110, 112. The computing nodes 106, 110, 112 store and maintain a copy of a private distributed ledger 108 for a financial institution, such as a bank. The private distributed ledger 108 stores one or more transaction blocks representing transactions in a digital currency. In some embodiments, the digital currency is issued by the financial institution. In some embodiments, the digital currency is fixed with respect to a fiat currency.

The computing node 106 may receive a transaction for transferring an amount of digital currency from the first entity 102 to the second entity 104. For example, the first entity and the second entity may be customers relating to the same financial institution. The first entity may request a transfer of the amount of digital currency from the first entity's digital currency account at the financial institution. The computing node 106 may generate a new transaction block representing the transaction for addition to the private distributed ledger. The computing node 106 may transmit the new transaction block to the computing nodes 110, 112 participating in the private distributed ledger. The computing node 106 may receive an indication of validity of the new transaction block from one or more of computing nodes 110, 112. Based on the indication of validity, the computing node 106 may insert the new transaction block into the private distributed ledger. The computing node 106, the computing node 112, or another suitable computing node may complete the transaction by transferring the amount of digital currency from to the second entity. For example, the digital currency may be transferred to the second entity's digital currency account at the financial institution. In some embodiments, one or more financial institutions may opt into a centralized clearing house. The clearing house may implement its own private distributed ledger for recording all transactions including in digital currencies from one or more financial institutions. The transactions may be recorded in the private distributed ledger of each financial institution involved in the transaction and the private distributed ledger of the clearing house. For example, the private distributed ledger of the clearing house may include transactions between users from different financial institutions (including transactions between users of the same financial institution), but the private distributed ledger of each financial institution may only include transactions between users of the same financial institution or transactions involving a user of the financial institution as a party to the transaction. The clearing house may be implemented using computing nodes (e.g., computing nodes 156, 160 and/or 162 (FIG. 1, illustrative system 150) or other suitable computing nodes) that store and maintain a copy of a private distributed ledger 158 for the clearing house. More details on the clearing house are provided further below.

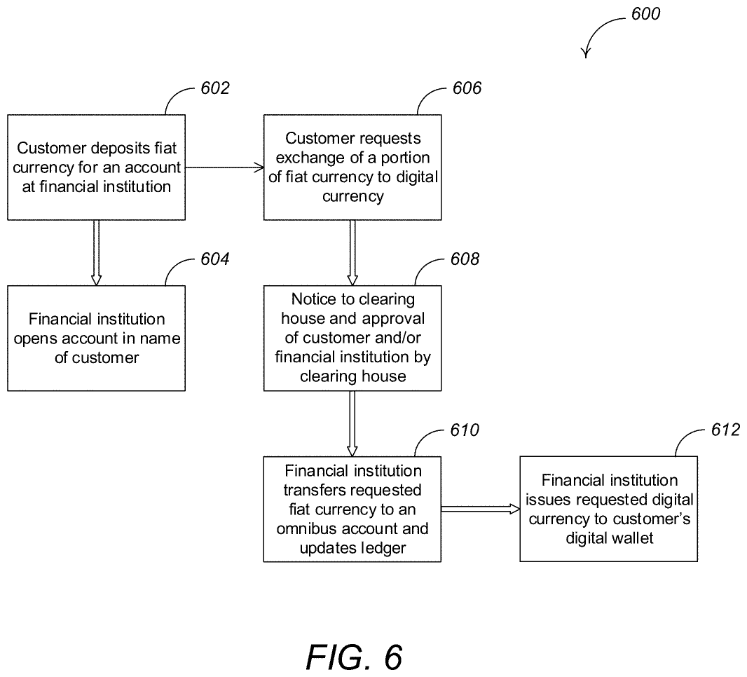

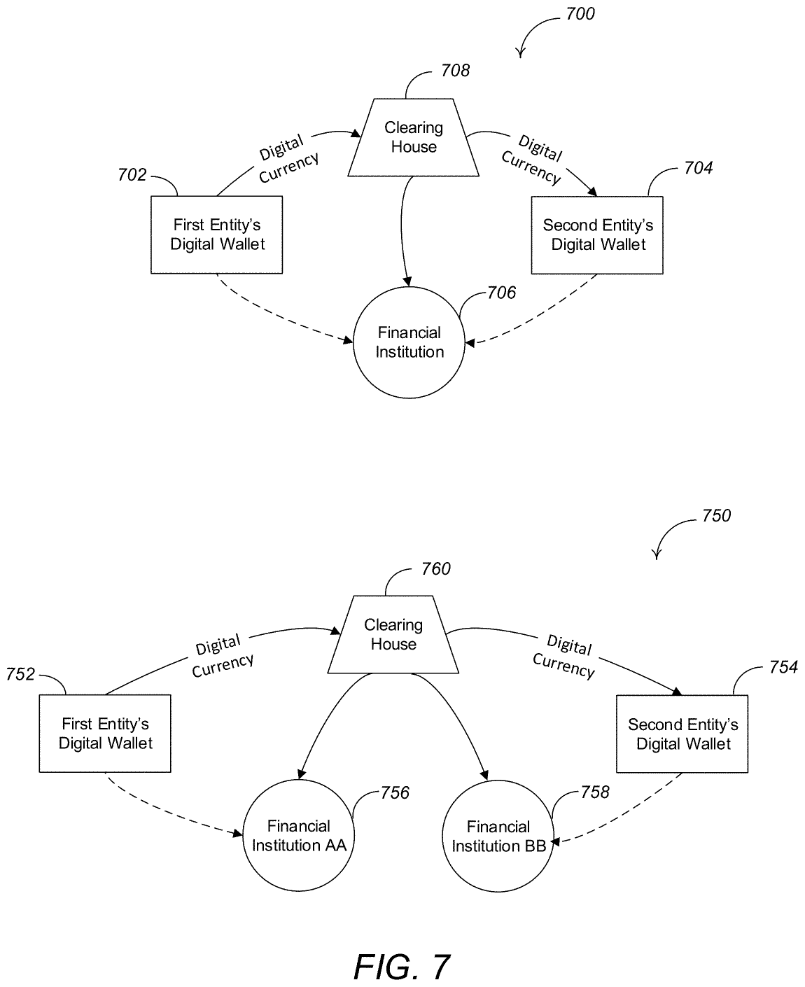

In some aspects, a purchase transaction is facilitated between two entities, a customer and a store, relating to different financial institutions. A financial institution, such as a bank, may issue a digital currency card for transactions in the bank's digital currency. The bank's customer may visit a store that keeps funds with a different bank. The bank's customer may provide the digital currency card to pay for an item using the bank's digital currency. In some embodiments, the bank provides a digital wallet as described herein, e.g., with respect to FIGS. 6 and 7.

According to some embodiments, the digital wallet may be issued by one or more entities. For example, the one or more entities may include a financial entity, a government entity, a payment processor company, a technology company, a cloud company, a clearing house, a syndicate of banks, an entity with a bank charter and/or any suitable entity.

The bank's customer may use the digital wallet to pay for an item using the bank's digital currency. In some embodiments, the bank provides a device that can accept the bank's digital currency card and/or digital wallet and notify a server at the bank to complete the transaction (e.g., by recording the transaction in the private distributed ledger and transmitting payment to the store's account at the other bank). In some embodiments, a machine provided by VISA, MASTERCARD, AMEX, SQUARE, or another payment company, can accept the digital currency card (VISA, MASTERCARD, AMEX, and SQUARE are registered marks of, respectively, Visa Inc., Foster City, Calif., USA; Mastercard Incorporated, Purchase, N.Y., USA; American Express Company, New York, N.Y., USA; and Square, Inc., San Francisco, Calif.). The machine may relay information regarding the transaction to the payment company's processing center, which in turn notifies the bank. Subsequently, a server at the bank may complete the transaction (e.g., by recording the transaction in the private distributed ledger and transmitting payment to the store's account at the other bank).

In some embodiments, the digital currency is exchanged for fiat currency, such as the United States Dollar, which is then transferred to the store's account at the other bank. In some embodiments, if the store wishes to complete the transaction in a digital currency, the store's bank may exchange the received fiat currency into the other bank's digital currency and deposit it into the store's digital currency account. In some implementations, the digital currency received in the store's digital currency account is different from the digital currency transferred from the customer's digital currency account. This is because the digital currencies issued by the two banks may be different and not interchangeable. For example, in some implementations, each financial institution may keep its own private distributed ledger for recording transactions in its own digital currency. However, transfers from one digital currency account at a bank to another digital currency at a different bank may be accomplished via an intermediary conversion to a fiat currency, such as the United States Dollar.

In some aspects, a funds transfer transaction is facilitated between two entities, e.g., two customers, relating to different financial institutions. For example, a customer of a financial institution may initiate a transaction for transferring digital currency to a customer of a different financial institution. In some embodiments, the digital currency transaction is recorded as a withdrawal and exchanged into a fiat currency for delivery to the second customer. In some embodiments, the financial institution has a private distributed ledger stored across multiple computing nodes. The private distributed ledger stores one or more transaction blocks representing transactions in the digital currency that is issued by the financial institution and is fixed with respect to a fiat currency. A computing node receives a transaction for transferring an amount of digital currency from a first customer of the financial institution to a second customer of a different financial institution. The computing node generates a new transaction block representing the transaction for addition to the private distributed ledger. The computing node transmits the new transaction block to the one or more computing nodes participating in the private distributed ledger. The computing node receives an indication of validity of the new transaction block. If the indication is valid, the computing node inserts the new transaction block into the private distributed ledger to complete withdrawal of the amount of digital currency. The computing node exchanges the amount of digital currency into an equivalent amount of fiat currency for transferring to the second customer.

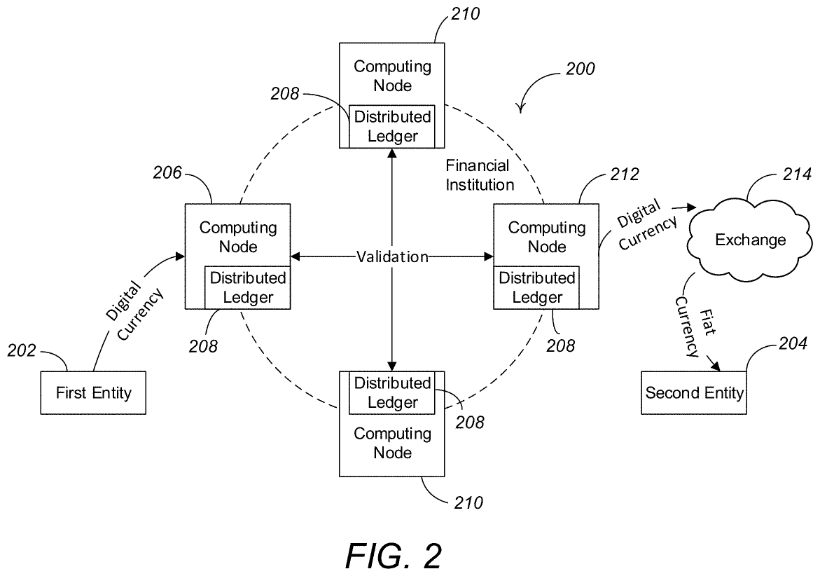

FIG. 2 is another block diagram of an illustrative system 200 for facilitating transactions using a digital currency between a first entity 202 and a second entity 204 relating to different financial institutions in accordance with some embodiments of the technology described herein. A computing node 206 is connected to other computing nodes 210, 212. The computing nodes 206, 210, 212 store and maintain a copy of a private distributed ledger 208 for a financial institution, such as a bank. The private distributed ledger 108 stores one or more transaction blocks representing transactions in a digital currency. In some embodiments, the digital currency is issued by one of the financial institutions. The financial institution issuing the digital currency may partner with the other financial institution and provide the other financial institution with access to the private distributed ledger. Alternatively or additionally, the financial institution issuing the digital currency may limit outside access to the private distributed ledger and complete the transaction using a centralized clearing house described herein or a conventional inter-bank transfer system, such as Automated Clearing House (ACH). ACH is an electronic network for fiat currency-based financial transactions in the United States. In some embodiments, the digital currency is fixed with respect to a fiat currency.

In some embodiments, the financial institution may allow governments and/or financial regulators (e.g., Federal Reserve Board (FRB), the Federal Deposit Insurance Corporation (FDIC), and the Securities and Exchange Commission (SEC), etc.) and/or data companies (e.g., Fiserv) access to the private distributed ledger (FISERV is a registered mark of Fiserv, Inc., Brookfield, Wis., USA). In some examples, the financial institution may use a cloud provider to store or access the private distributed ledger. In one example, the financial institution may partner with another entity and allow the entity access to one or more transactions in the private distributed ledger. The entity may be one or more partner companies, for example, any combination of an investment management corporation, a risk management firm, and/or an institutional asset manager.

The computing node 206 may receive a transaction for transferring an amount of digital currency from the first entity 202 to the second entity 204. For example, the first entity and the second entity may be customers relating to different financial institutions. The first entity may request a transfer of the amount of digital currency from the first entity's digital currency account at the financial institution. The computing node 206 may generate a new transaction block representing the transaction for addition to the private distributed ledger. The computing node 206 may transmit the new transaction block to the computing nodes 210, 212 participating in the private distributed ledger. The computing node 206 may receive an indication of validity of the new transaction block from one or more of computing nodes 210, 212. Based on the indication of validity, the computing node 206 may insert the new transaction block into the private distributed ledger. The computing node 206, the computing node 212, or another suitable computing node may complete withdrawal of the amount of digital currency from the first entity's digital currency account. The computing node 206, the computing node 212, or another suitable computing node may exchange the amount of digital currency into an equivalent amount of fiat currency for transferring to the second entity. The exchange may be requested from an exchange server 214 that is equipped to convert the digital currency into equivalent fiat currency.

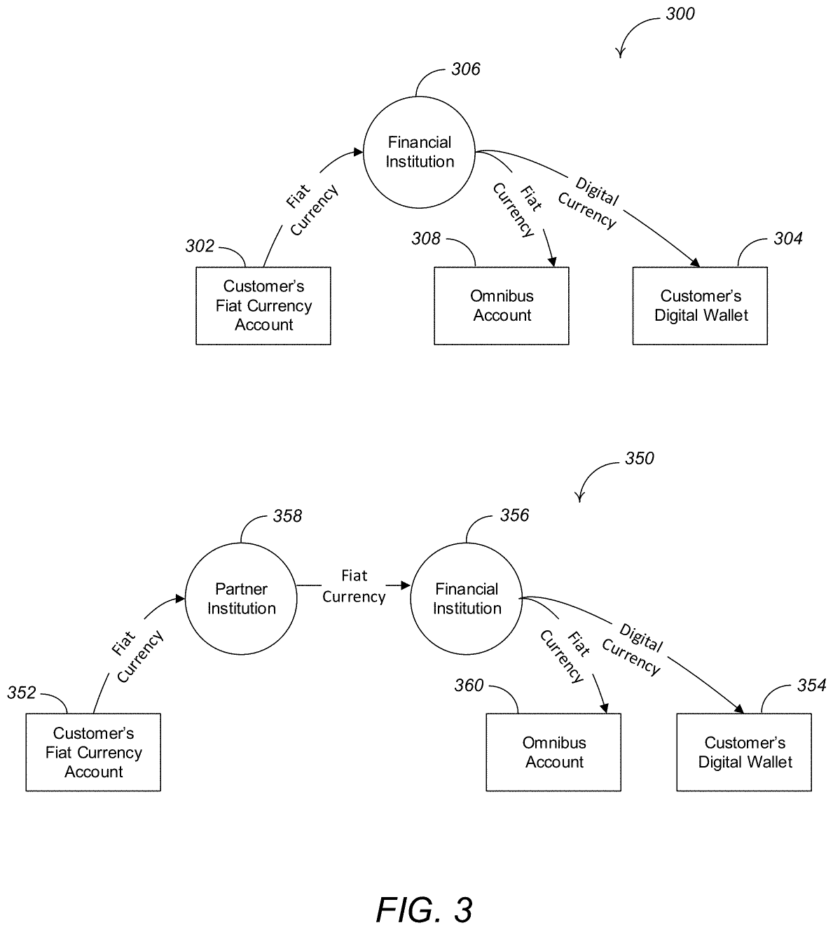

FIG. 3 shows illustrative diagrams of exemplary transactions 300 and 350 using a digital currency in accordance with some embodiments of the technology described herein. In some embodiments of exemplary transactions 300 and 350, the financial institution 306 or 356 issues the digital currency and is the only entity that can create the omnibus account 304 or 354 and/or deposit the digital currency into the omnibus account 304 or 354. In some embodiments, the financial institution may require a customer to comply with “know your customer” (KYC) procedures to verify their identities and/or assess their suitability and potential risks of illegal activity before creating an omnibus account for the customer. Such requirements will reduce illegal activity such as fraudulent transactions or money laundering. While the exemplary transactions 300 and 350 describe transactions for depositing digital currency into a digital wallet or another suitable digital currency account, the described techniques may be equally applicable to transactions for withdrawing digital currency from a digital wallet or another suitable digital currency account.

Assets

Further, a digital wallet may further include other financial assets and/or instruments. The described techniques may be equally applicable to transactions for withdrawing financial assets and/or instruments such as stocks, bonds, derivatives, currencies, equities, commodities or others. The digital wallet may contain assets and/or instruments issued by an entity such as, for example, a government entity, a financial institution, an exchange and/or clearing house.

In some embodiments, open blockchain tokens may be considered intangible personal property, e.g., if the token's predominant purpose is consumptive and the developer or seller did not market the token to the initial buyer as a financial investment, among other factors. “Consumptive” may be defined as a token being exchangeable for services, software, content, or real or tangible personal property. In some embodiments, all digital assets may be classified as property. For example, digital consumer assets may be classified as general intangible property, digital securities as securities, and virtual currency as money. In some embodiments, financial institutions may provide custodial services for digital assets. The financial institution may follow the Securities and Exchange Commission rules regarding custodial services. Perfection of a security interest in digital assets may be obtained by control and would not require physical possession. In some embodiments, such digital assets held in the financial institution's custody may not be depository liabilities or assets of the financial institution. In some embodiments, the financial institution may be prohibited from engaging in any discretionary authority relating to digital assets unless it had the customer's instructions to do so.

In transaction 300, a customer of the financial institution 306 requests an amount of fiat currency from his or her fiat currency account 302 be exchanged into the financial institution's digital currency. The financial institution 306 receives or retrieves the fiat currency from the customer's fiat currency account 302. The financial institution 306 may deposit the received amount of fiat currency into an omnibus account 308 (details for which are provided further below). The financial institution 306 may create a new digital wallet 304 for the customer and deposit into the account an amount of digital currency equivalent to the amount of fiat currency. Alternatively, the financial institution 306 may deposit into the customer's existing digital wallet 304 an amount of digital currency equivalent to the amount of fiat currency. In some embodiments, the customer's digital wallet 304 is separate from, but attached to, the customer's fiat currency account 302 at the financial institution 306.

In transaction 350, while the digital currency is issued by the financial institution 356, the financial institution 356 partners with another financial institution, such as partner institution 358, to provide the other financial institution with access to the financial institution's digital currency. A customer of the partner institution 358 requests an amount of fiat currency from his or her fiat currency account 352 be exchanged into the financial institution's digital currency. The financial institution 356 receives or retrieves the fiat currency from the customer's fiat currency account 352 at the partner institution 358. The financial institution 356 may deposit the received amount of fiat currency into an omnibus account 360 (details for which are provided further below). The financial institution 356 may create a new digital wallet 354 for the customer and deposit into the account an amount of digital currency equivalent to the amount of fiat currency. Alternatively, the financial institution 356 may deposit into the customer's existing digital wallet 354 an amount of digital currency equivalent to the amount of fiat currency. In some embodiments, the customer's digital wallet 354 is separate from, but attached to, the customer's fiat currency account 352 at the partner institution 358 and/or a fiat currency account at the financial institution 356. In some embodiments, the financial institution 356 completes the fiat currency transaction with partner institution 358 using a conventional inter-bank transfer system, such as Automated Clearing House (ACH). ACH is an electronic network for fiat currency-based financial transactions in the United States.

Issuing Digital Currency

According to some embodiments, the financial institution may be a government entity and the issued digital currency may be government issued digital currency. As described herein, the digital currency may be issued by one or more of the U.S. Mint, the Bureau of Engraving & Printing, the Financial Crimes Enforcement Network, the Internal Revenue Service, the Office of the Comptroller of Currency, and/or the Community Development Financial Institution under the Department of the Treasury. In some examples, the digital currency may be issued by a single Federal Reserve Bank, multiple regional Federal Reserve Banks, and/or member banks of the Federal Reserve. According to some embodiments, the financial institution issuing the digital currency may be one or more entities (e.g., technology companies) that have received bank charters or similar rights from the government. According to another embodiment, the financial institution may authorize a clearinghouse to issue digital currency. For example, a first customer at a first financial institution may wish to send an amount of first digital currency to a second customer at a second financial institution having a second digital currency. The clearinghouse may issue an amount of second digital currency equivalent to the value of the amount of first digital currency to the second customer. The first financial institution then subsequently and/or concurrently transfers an equivalent amount of funds in an omnibus account at the financial institution.

According to some embodiments, the government entity may transfer to one or more financial institutions, government issued digital currency. According to some embodiments, the government entity may use the government issued digital currency. According to some embodiments, a financial institution may use the government issued digital currency for conducting one or more transactions in a manner consistent with the systems and methods described herein. Additionally or alternatively, the financial institution may issue its own digital currency based on the government issued digital currency. According to some embodiments, the financial institution may utilize the government issued digital currency to issue its own digital currency for conducting one or more transactions in a manner consistent with the systems and methods described herein. For example, the financial institution may introduce digital currency issued by the financial institution and backed by the fiat currency backing the government issued digital currency and/or the government issued digital currency itself.

Exemplary Transactions

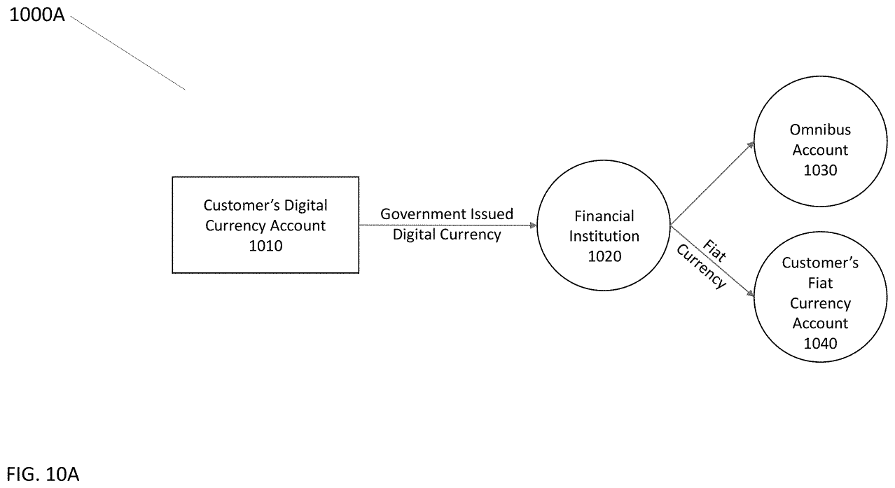

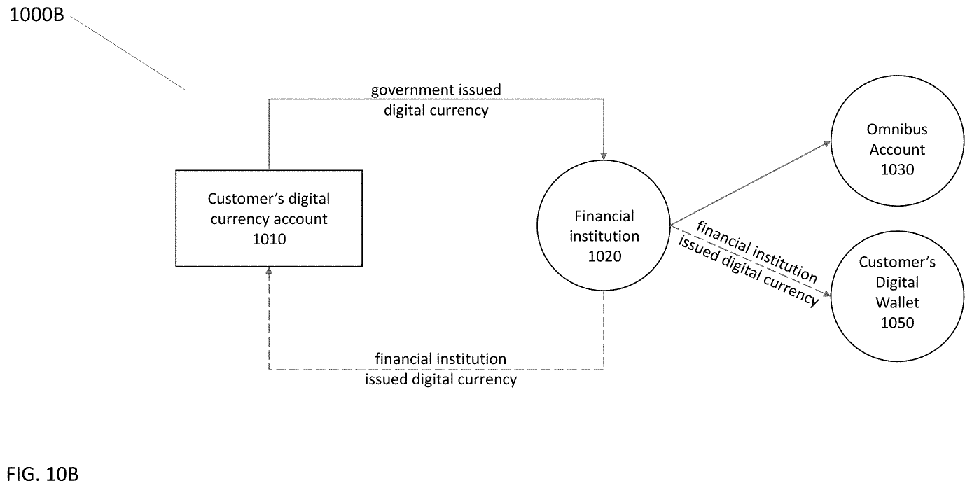

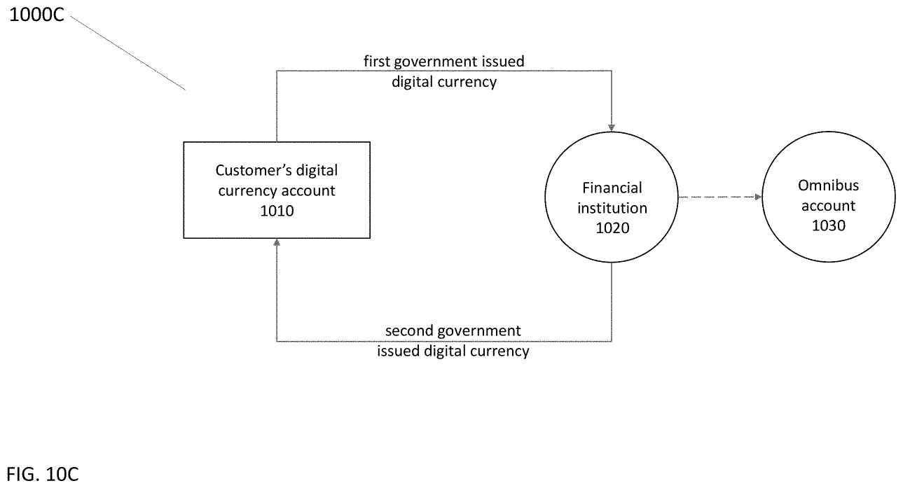

FIG. 10A-C shows illustrative diagrams of exemplary transactions 1000A, 1000B and 1000C using government issued digital currency in accordance with some embodiments of the technology described herein. In some embodiments of exemplary transactions 1000A, 1000B and 1000C, the financial institution 1020 issues a digital currency and is the only entity that can create the omnibus account 1030 and/or deposit the digital currency into the omnibus account 1030. In some embodiments, the financial institution may require a customer to comply with “know your customer” (KYC) procedures to verify their identities and/or assess their suitability and potential risks of illegal activity before creating an omnibus account for the customer. Such requirements will reduce illegal activity such as fraudulent transactions or money laundering. While the exemplary transactions 1000A, 1000B and 1000C describe transactions for depositing digital currency into a digital wallet or another suitable digital currency account, the described techniques may be equally applicable to transactions for withdrawing digital currency from a digital wallet or another suitable digital currency account.

In transaction 1000A, a customer of the financial institution 1020 requests that an amount of a digital currency issued by a government entity from his or her digital currency account 1010 be exchanged into fiat currency. The financial institution receives or retrieves the first government issued digital currency from the digital currency account 1010. The financial institution 1020 may deposit the received amount of government issued digital currency into an omnibus account 1030 (details for which are provided further below). The financial institution may create a new fiat currency account for the customer and deposit into the account an amount of fiat currency equivalent to the amount of government issued digital currency. In some embodiments, the customer's fiat currency account 1040 is separate from, but attached to, the customer's digital currency account 1010 at the financial institution.

In transaction 1000B, a customer of the financial institution 1020 requests that an amount of government issued digital currency from his or her digital currency account 1010 be exchanged into digital currency issued by the financial institution 1020. The financial institution 1020 receives or retrieves the government issued digital currency from the digital currency account 1010. The financial institution 1020 may deposit the received amount of government issued digital currency into an omnibus account 1030. The financial institution 1020 may create a new digital wallet 1050 for the customer and deposit into the account an amount of digital currency issued by the financial institution equivalent to the amount of government issued digital currency. Alternatively, the financial institution 1020 may deposit into the customer's existing digital currency account 1010 an amount of digital currency issued by the financial institution equivalent to the amount of government issued digital currency. In some embodiments, the customer's digital wallet 1050 is separate from, but attached to, the customer's digital currency account 1010 at the financial institution 1020. The financial institution may also provide benefits such as some amount of digital currency issued by the financial institution to be added to the customer's digital currency account in addition to the exchanged amount as a reward. The amount of additional financial institution issued digital currency may be predetermined or determined based on the amount of government issued digital currency exchanged.

In transaction 1000C, a customer of the financial institution 1020 requests that an amount of a first digital currency issued by a first government entity from his or her digital currency account 1010 be exchanged into a second digital currency issued by a second government entity. The financial institution receives or retrieves the first government issued digital currency from the digital currency account 1010. The financial institution 1020 may deposit the received amount of first government issued digital currency into an omnibus account 1030 (details for which are provided further below). The financial institution (e.g., a currency exchange provider, a bank, etc.) may apply digital currency exchange rates (e.g., flexible, fixed, etc.) to determine the amount of the second government issued digital currency to deposit into the customer's digital currency account. The financial institution 1020 may deposit into the customer's existing digital currency account 1010 an amount of second digital currency issued by the second government determined to be equivalent to the amount of government issued digital currency.

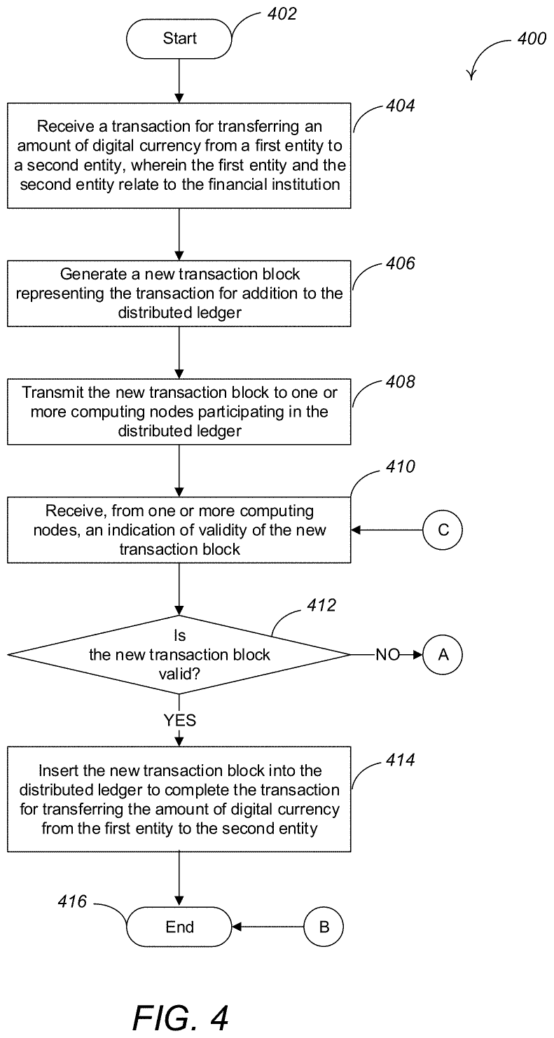

FIG. 4 is a diagram of an exemplary process 400 for facilitating transactions using a digital currency in accordance with some embodiments of the technology described herein. In some embodiments, the process is executed on a computing node connected to one or more computing nodes participating in a private distributed ledger for a financial institution. In some embodiments, the private distributed ledger stores one or more transaction blocks representing transactions in a digital currency. In some embodiments, the digital currency is issued by the financial institution. In some embodiments, the digital currency is fixed with respect to a fiat currency. In some embodiments, the computing node stores and maintains a copy of the private distributed ledger. In some embodiments, the private distributed ledger may interact with a public ledger and/or run on a public ledger. For example, functionality to conduct private transactions for the private distributed ledger may be implemented using an application that runs on a public blockchain. This public blockchain may optionally provide support for other financial and/or non-financial applications in addition to the functionality for conducting private transactions for the private distributed ledger. In some embodiments, within a public distributed ledger, a portion can be designated as private and the distribution more limited based on the digital currency, user, and/or other suitable information. Additionally or alternatively, a private distributed ledger may share or receive information and/or transaction blocks from or with/within a public system. The described systems and methods may be implemented using any one or more of the distributed ledgers described herein or another suitable variation thereof.

At act 402, the process starts.

At act 404, the computing node receives a transaction for transferring an amount of digital currency from a first entity to a second entity.

In some embodiments, the first entity and the second entity relate to the same financial institution. In some embodiments, the first entity relates to a financial institution and the second entity relates to another financial institution. In some embodiments, the first entity is a consumer, and the second entity is a merchant. In some embodiments, the first entity and the second entity are customers of the same financial institution.

In some embodiments, the transaction is initiated from a digital currency card configured for payment in the digital currency. In some embodiments, the transaction is initiated from a mobile application or a web application configured for payment in the digital currency.

In some embodiments, the digital currency card, the mobile application or the web application require a personal identification number (PIN), a password, biometrics, facial recognition, a fingerprint, and/or an eye scan.

Split Payment

In some embodiments, the transaction represents a split payment from a transaction involving the first entity and at least one other entity providing payment to the second entity. For example, multiple people may need to pay a single bill. The payment may be split per item, as a percentage of the bill, or combination thereof. Each person may pay for what they ordered, e.g., at a restaurant, or another suitable location or merchant. Each person may pay an equal percentage instead. In another example, roommates may pay need to pay their apartment rent. Each person may pay based on the size of their room. Each person may pay an equal percentage instead.

In some embodiments, at least the first entity is associated with a pair of public and private keys, and based on authorization from the first entity, at least a portion of a private transaction involving the digital currency is generated using a private key of the pair of public and private keys for the first entity.

At act 406, the computing node generates a new transaction block representing the transaction for addition to the private distributed ledger.

At act 408, the computing node transmits the new transaction block to the one or more computing nodes participating in the private distributed ledger.

In some embodiments, the new transaction block is generated at the financial institution and transmitted to a clearing house for insertion into a distributed ledger for the clearing house. In some embodiments, the new transaction block is generated at the clearing house and transmitted to the financial institution for insertion into the distributed ledger for the financial institution.

At act 410, the computing node receives, from the one or more computing nodes, an indication of validity of the new transaction block. In some embodiments, the indication of validity comprises an indication of validity generated using a public key of the pair of public and private keys for the first entity included in a private transaction involving the digital currency.

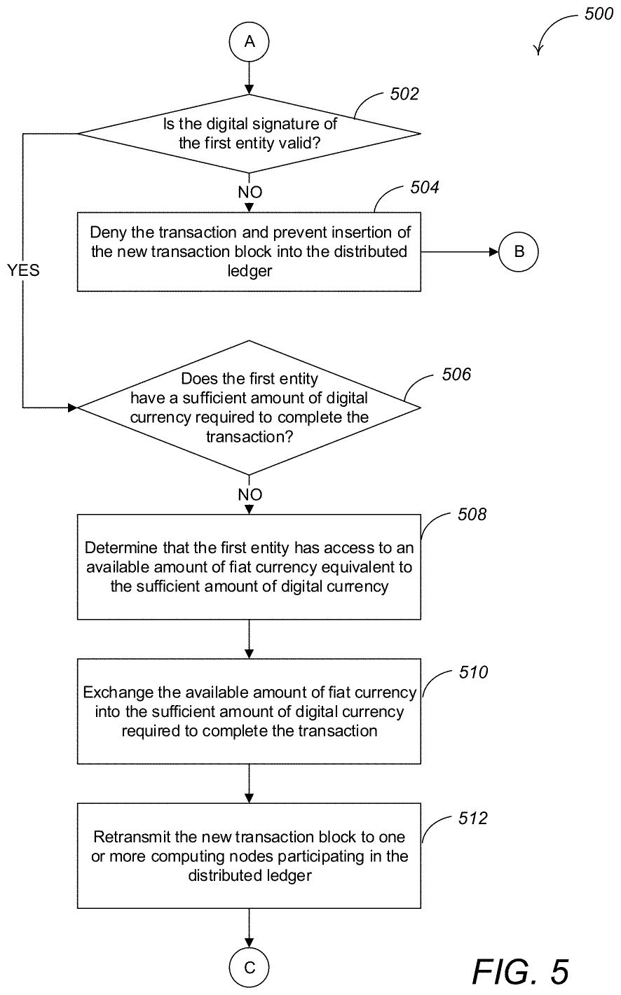

At act 412, the computing node determines whether the block is valid. FIG. 5 and related description provide further details on an exemplary process that is executed when a transaction block is determined to be invalid.

At act 414, based on the transaction block being determined to be valid, the computing node inserts the new transaction block into the private distributed ledger to complete the transaction for transferring the amount of digital currency from the first entity to the second entity. In some embodiments, the second entity receives the amount of digital currency when the transaction is complete. In some embodiments, the second entity receives an amount of fiat currency equivalent to the amount of digital currency when the transaction is complete. In some embodiments, the exchange of the available amount of fiat currency into the sufficient amount of digital currency is authorized by the first entity at a time prior to the private transaction, authorized by the first entity at a time of or subsequent to the private transaction, or denied by the first entity at a time of the private transaction. In some embodiments, the second entity receives an amount of digital currency that is issued by another financial institution, but equivalent to the amount of digital currency issued by the financial institution.

In some embodiments, at act 414, based on the transaction block being determined to be valid, the computing node insert the new transaction block into the private distributed ledger to complete withdrawal of the amount of digital currency from the first entity to the second entity, where the first entity and the second entity relate to different financial institutions. The computing node further exchanges the amount of digital currency into an equivalent amount of fiat currency for transferring to the second entity at the other financial institution. In some embodiments, the exchange of the available amount of fiat currency into the sufficient amount of digital currency is authorized by the first entity at a time prior to the private transaction, authorized by the first entity at a time of or subsequent to the private transaction, or denied by the first entity at a time of the private transaction. In some embodiments, the second entity receives the amount of digital currency issued by the financial institution in a digital wallet. The digital wallet may include one or more rules to spend the digital currency issued by the financial institution before or after spending digital currency issued by another financial institution. For example, the rules may include a rule to automatically convert digital currency issued by a non-approved financial institution into fiat currency. The fiat currency may be deposited into an account for the first entity at the financial institution or another suitable account. In another example, the rules may include a rule to block acceptance of digital currency issued by a non-approved financial institution. For example, one or more financial institutions may be marked as non-approved by the second entity, another financial institution, one or more clearing houses, or another suitable party. In some embodiments, a non-approved financial institution may be a financial institution that a user does not desire to transact with in a digital currency or otherwise. For example, the user may desire to transact with or use digital currency issued by their preferred financial institution (e.g., where they hold an account or another suitable preference), a reputable financial institution (e.g., a Tier 1 bank, etc.), a financial institution in one or more specified countries (e.g., US only, US and Europe only, etc.), and/or other suitable criteria. The user may request any financial institutions not meeting these criteria be marked as non-approved.

In some embodiments, a non-approved financial institution may be a financial institution that a particular financial institution may not desire to conduct business within a digital currency or otherwise. For example, the particular financial institution may desire to transact with reputable financial institutions (e.g., a Tier 1 bank, etc.), financial institutions in one or more specified countries (e.g., US only, US and Europe only, etc.), and/or other suitable criteria. The particular financial institution may mark any financial institutions not meeting these criteria as non-approved.

In some embodiments, a financial institution may not desire an unknown entity, e.g., an entity that has not complied with “know your customer” policies, etc., to accept digital currency issued by the financial institution. For such unknown entities, the financial institution may require they pass a preapproval process before being allowed to obtain the financial institution's digital currency. In some embodiments, the unknown entity may instead receive fiat currency or digital currency for another financial institution to satisfy the transaction at issue. While conducting the transaction in this manner may cause settlement to occur faster, the financial institution may benefit from having only approved entities (e.g., those who complied with “know your customer” policies, passed a preapproval process, etc.) being allowed to receive the financial institution's digital currency. Further, the transaction may still be completed with fiat currency or another financial institution's digital currency, while in conventional systems, such unknown entities may be excluded from such transactions.

In some embodiments, a relationship for the first entity to the second entity is selected from the group consisting of: individual to individual, individual to individuals, individual to business, individual to businesses, individual to business and individuals, individual to businesses and individual, individual to businesses and individuals, individuals to individual, individuals to individuals, individuals to business, individuals to businesses, individuals to business and individual, individuals to business and individuals, individuals to businesses and individual, individuals to businesses and individuals, business to individual, business to individuals, business to business, business to businesses, business to business and individual, business to business and individuals, business to businesses and individual, business to businesses and individuals, businesses to individual, businesses to individuals, businesses to business, businesses to businesses, businesses to business and individual, businesses to business and individuals, businesses to businesses and individual, and businesses to businesses and individuals.

At act 416, the process ends.

FIG. 5 is a diagram of an exemplary process 500 that is executed when a transaction block is determined to be invalid in accordance with some embodiments of the technology described herein. In some embodiments, the process is executed on a computing node connected to one or more computing nodes participating in a private distributed ledger for a financial institution. In some embodiments, the private distributed ledger stores one or more transaction blocks representing transactions in a digital currency that is issued by the financial institution and is fixed with respect to a fiat currency. In some embodiments, the computing node stores and maintains a copy of the private distributed ledger.

At act 502, the computing node determines whether a digital signature of the first entity is valid.

At act 504, based on the digital signature of the first entity being determined to be invalid, the computing node denies the transaction and prevents insertion of the new transaction block into the private distributed ledger.

At act 506, based on the digital signature of the first entity being determined to be valid, the computing node determines whether the first entity has a sufficient amount of digital currency required to complete the transaction.

At act 508, based on determining that the first entity does not have a sufficient amount of digital currency required to complete the transaction, the computing node determines that the first entity has access to an available amount of fiat currency equivalent to the sufficient amount of digital currency.

At act 510, the computing node exchanges the available amount of fiat currency into the sufficient amount of digital currency required to complete the transaction.

In some embodiments, the financial institution allows determination of availability of equivalent fiat currency and/or exchange of the equivalent fiat currency into digital currency based on permission from the first entity, e.g., a user of the financial institution. For example, when the financial institution (or another appropriate party or system) determines that the first entity does not have a sufficient amount of digital currency to complete the transaction, the financial institution may request permission from the user at the time of the transaction to determine availability of equivalent fiat currency and/or exchange of the equivalent fiat currency into digital currency. In another example, the financial institution may request permission from the user at a time prior to the transaction, i.e., the financial institution may receive preauthorization to determine availability of equivalent fiat currency and/or exchange of the equivalent fiat currency into digital currency, such as when the user's omnibus account was opened or updated by the financial institution. In yet another example, when the financial institution (or another appropriate party or system) determines that the first entity does not have a sufficient amount of digital currency to complete the transaction, the financial institution may request permission from the user at the time of the transaction and may receive an indication denying the request. In such cases, the transaction may be terminated and, optionally, the related transaction block may be discarded. In yet another example, the financial institution may receive an indication denying any future requests to determine availability of equivalent fiat currency and/or exchange of the equivalent fiat currency into digital currency, i.e., the user may opt out of the option to determine availability of equivalent fiat currency and/or exchange of the equivalent fiat currency into digital currency when a sufficient amount of digital currency is not available to complete the transaction. In such cases, the user may initiate or request an entirely new transaction after the sufficient amount of digital currency has been added to the user's digital wallet. In some embodiments, not all users of the financial institution may have access to this benefit of automatic determination and exchange of equivalent fiat currency into digital currency. The users who are allowed access may be determined based on the user's credit worthiness, length of relationship between the user and the financial institution, time averaged balances of the user's accounts, and/or other suitable metrics.

At act 512, the computing node retransmits the new transaction block to the one or more computing nodes participating in the private distributed ledger. In some embodiments, the computing node returns to act 410 of process 400 (FIG. 4) and continues to process the retransmitted transaction block.

In some aspects, while each financial institution may issue its own digital currency, the financial institutions may opt into a digital wallet that stores digital currencies from multiple financial institutions. For example, the digital wallet may store the respective public and private keys for digital currencies from one or more of the financial institutions. The public and private keys may be used to receive or send a digital currency issued by a respective institution. For example, in a purchase transaction, both the buyer and the seller may have respective digital wallets. The buyer and the seller may have received their respective digital wallets with their accounts at their preferred financial institutions. The buyer may use the private key for the digital currency issued by a particular institution to send an amount of the digital currency from the buyer's digital wallet to the seller's digital wallet.

In some embodiments, while the digital wallet may include multiple public and private key pairs for different digital currencies, none of the digital currencies themselves may be stored in the digital wallet. Instead, the digital currency for each financial institution may be stored and maintained in the respective financial institution's private distributed ledger. In order to use digital currency from his digital wallet, a user may authorize use of the corresponding private key to digitally sign a transaction and store a block for the transaction in the private distributed ledger, e.g., to spend the associated digital currency. In some embodiments, the digital wallet may include software in the form of an application installed locally on a computer, a mobile phone, a tablet, or another suitable user device. In some embodiments, the digital wallet may be connected via an application programming interface (API) to a trusted third party, such as GOOGLE, APPLE, VISA, MASTERCARD, AMEX, or another suitable entity (GOOGLE, APPLE, VISA, MASTERCARD, and AMEX are registered marks of, respectively, Google LLC, Mountain View, Calif., USA; and Apple Inc., Cupertino, Calif., USA; Visa Inc., Foster City, Calif., USA; Mastercard Incorporated, Purchase, N.Y., USA; and American Express Company, New York, N.Y., USA). The user's private keys may be managed by the trusted third party. In some embodiments, the digital wallet may include hardware for storing the user's private keys. The hardware may include a button that the user is required to physically press or touch in order to digitally sign a transaction. Alternatively or additionally, the hardware may require that the user enter a pin before the user can digitally sign a transaction. According to some embodiments, the private key may comprise one or more private keys. For example, the private key may consist of multiple private keys appended in a given order or may be a function of one or more private keys. For example, the private key may be composed of two private keys, such that the financial institution may store a first private key, and the digital wallet may store a second private key. The financial institution may have multiple private keys, such that each private key may be unique to each user. In order to use a digital currency from the digital wallet, the user may authorize use of the corresponding private key for the digital currency to digitally sign a transaction involving the digital currency. For example, the user may authorize use of the second private key and the financial institution may automatically or manually authorize use of the first private key to digitally sign the transaction. In some embodiments, the digital wallet may provide a user with consumer rewards, loyalty points, or other suitable incentives for using the digital wallet. For example, the digital wallet may provide similar rewards as credit cards in the form of points, hotel stays, miles, cash back, or other suitable rewards. In some embodiments, financial institutions issuing digital currency may create unique relationships for accounts with their digital currency. For example, the financial institution may offer incentives directed to a hotel rewards program, an airline rewards program, or other suitable rewards programs. In some embodiments, reward levels for a user may be determined based on a balance of digital currency maintained in the user's digital wallet, meeting one or more transaction thresholds, or other suitable means. In some embodiments, the digital wallet may provide geo-location rewards to the user. For example, when the user enters a particular store, the digital wallet may offer a two-for-one sale on a product, if purchased from the store using the digital wallet.

Private Transaction on Public Blockchain

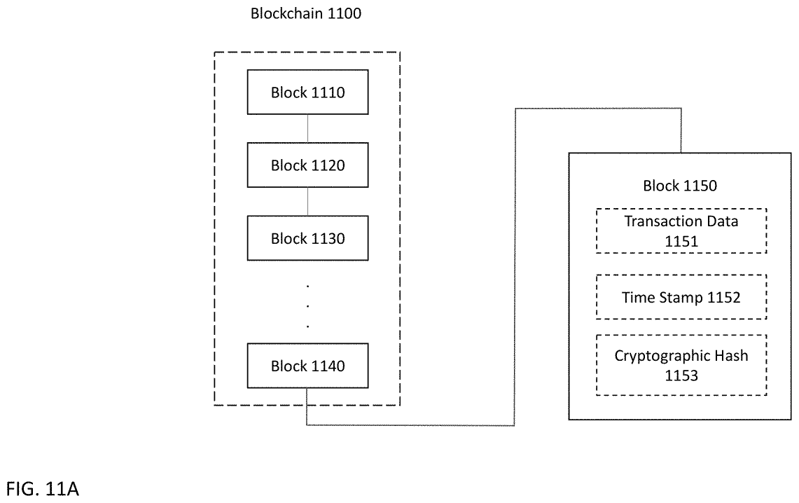

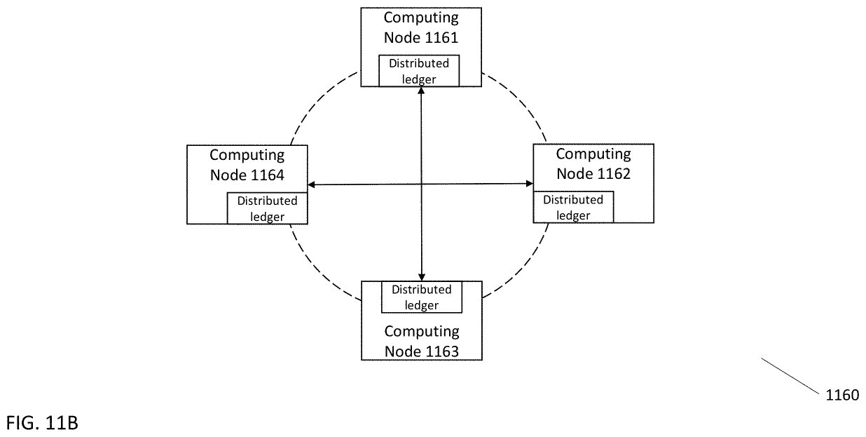

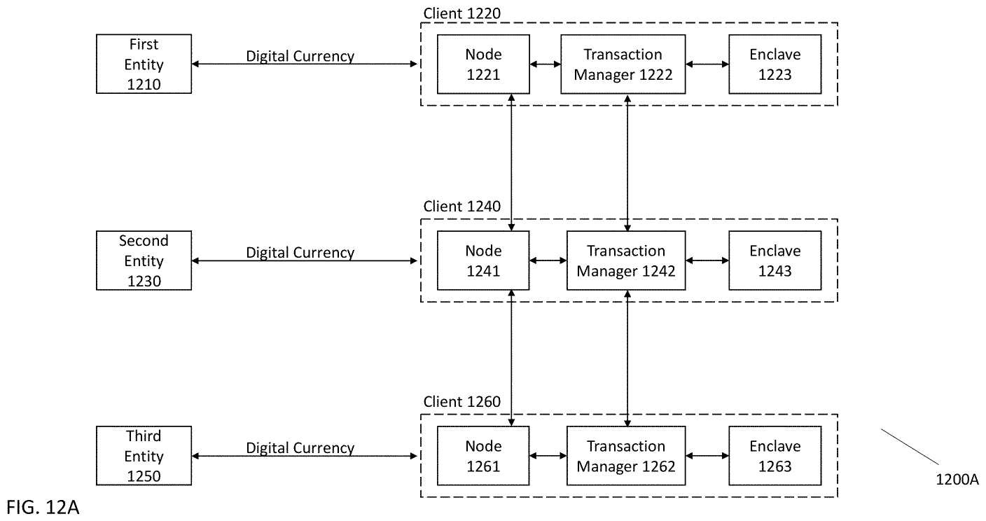

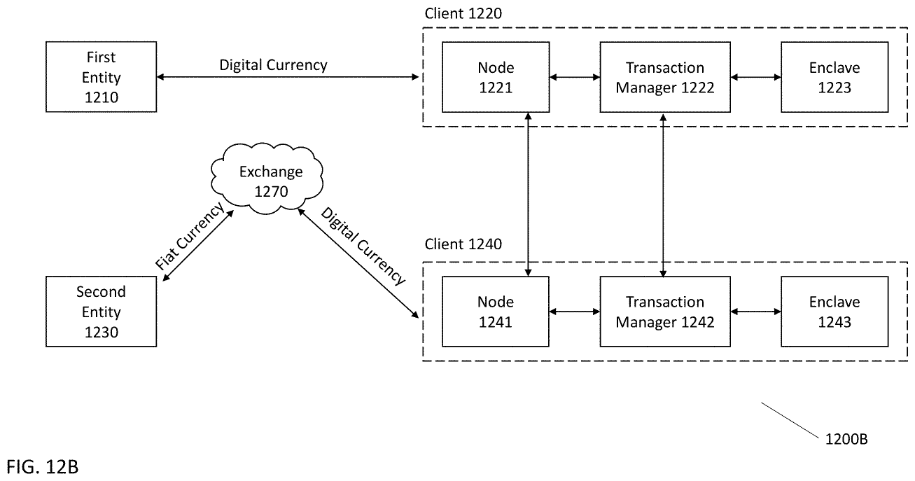

As described herein, functionality to conduct private transactions may be implemented using an application that runs on a public blockchain. This public blockchain may optionally provide support for other financial and/or non-financial applications in addition to the functionality for conducting private transactions. FIG. 11A-B are exemplary diagrams of a public blockchain and a decentralized computing system capable of managing the public blockchain. FIG. 12A-B are block diagrams of illustrative systems for facilitating private and/or public transactions on public blockchains.

FIG. 11A is an exemplary diagram of a public blockchain 1100 on which an application for private and/or public transactions may be run. As described herein, a public blockchain (e.g. blockchain 1100) is a continuously growing list of records, called blocks or transaction blocks, which are linked and secured using cryptography. Exemplary blockchain 1100 may have blocks such as blocks 1110, 1120, 1130, and 1140. Each new financial transaction may be added as a transaction block to the blockchain. For example, the block 1150 for a new financial transaction may include a cryptographic hash 1153 of the previous block, a time stamp 1152 and transaction data 1151. The cryptographic hash 1153 is used to generate a fixed-length mathematical representation of a variable amount of data, such as the previous block 1140. For recording financial transactions, the blockchain is typically managed by the decentralized computing system such as the exemplary decentralized computing system 1160 of FIG. 11B. The decentralized computing system 1160 may have multiple computing nodes 1161, 1162, 1163, and 1164, to receive a new financial transaction, generate a new transaction block 1150, validate the new transaction block 1150, and insert the new transaction block into the blockhead. The new financial transaction is recorded in the transaction block 1150 typically in the form of “payer X sends Y cryptocurrency to payee Z.” Once recorded, the data in any given transaction block cannot be altered retroactively without alteration of subsequent blocks, which requires consensus of the computing nodes in the decentralized computing system 1160.

As described here, a public blockchain may require proof of work to confirm transactions and record new transaction blocks in the public blockchain. For example, the proof of work algorithm is needed because any entity, individual, or organization can record new transaction blocks in the public blockchain. According to some embodiments, rather than proof of work, the public blockchain may require proof of stake. Proof of stake is a consensus mechanism for blockchain networks where a user may validate block transactions as a function of the digital currency held by the user (e.g., proportionate). A consensus mechanism may be a set of rules for all nodes in a blockchain to agree whether transactions are valid.

According to some embodiments, the authentication process may be done in one or more steps, in any sequence. For example, validation may also be done in one or more steps provided in any sequence, where one or multiple entities may perform one or more steps of the authentication and/or validation process (e.g., as described herein in the section ‘Validation’ and/or other suitable implementations).

FIG. 12A is a block diagram of an illustrative system 1200A for facilitating private transactions on a public blockchain using a digital currency between a first entity 1210 and a second entity 1230. The first and second entities, 1210 and 1230 respectively, may relate to the same financial institution in accordance with some embodiments of the technology described herein. For example, the first and second entities may represent different clients of the financial institution. According to some embodiments, the first and second entities of FIG. 12A and FIG. 12B may communicate transactions to the nodes using one or more decentralized digital applications (DAPPs). According to some embodiments, the first and second entities of FIG. 12A and FIG. 12B may communicate transactions to the nodes using one or more wallets.

The entities described may each relate to a specific blockchain client. The first entity 1210 may be associated with a blockchain client 1220, where the blockchain client 1220 includes node 1221, transaction manager 1222 and enclave 1223. The second entity 1230 may be associated with a blockchain client 1240, where the blockchain client 1240 includes node 1241, transaction manager 1242 and enclave 1243. A third entity 1250 is also shown with blockchain client 1260 including node 1261, transaction manager 1262 and enclave 1263. A transaction manager such as transaction manager 1222, 1242 and/or 1262 may facilitate automatic discovery of other transaction managers on a network of nodes and/or clients, exchange payloads with other transaction managers on a network of nodes and/or clients and store transaction data. Enclaves such as 1223, 1243 and 1263 may be isolated regions of memory which are protected from other processes, allowing for security of private keys.

According to some embodiments, a node (e.g. 1221, 1241) may store data regarding the public blockchain (e.g. a public state). In some embodiments, a node may store full blockchain data. In some embodiments, a node may store data on identifiers of blocks (e.g. such as blocks 1110, 1120, 1130, and 1140) of a public blockchain (e.g. blockchain 1100). For example, a block identifier may be a block header. In some examples, the data on identifiers of blocks may be a chain of headers (e.g. header chain). According to some embodiments, a node may also store data regarding private transactions between the blockchain client that the node belongs to and another blockchain client. For example, the node may store data on a private state.

According to some embodiments, the system of FIG. 12A may be used to facilitate private transactions on a public blockchain. The node 1221 may receive a transaction for transferring an amount of digital currency from the first entity 1210 to the second entity 1230. For example, the first entity and the second entity may be customers relating to the same financial institution. The first entity may request a transfer of the amount of digital currency from the first entity's digital currency account at the financial institution. The node 1221 may generate a new transaction block representing the transaction to be distributed to blockchain clients on the network. For example, the node 1221 may transmit the new transaction block to blockchain clients 1220, 1240 and 1260 (e.g., using a peer-to-peer network (P2P)). Each blockchain client on the network may subsequently attempt to process the transaction. According to some embodiments, attempting to process the transaction may include making a call to the transaction manager to determine if the blockchain client holds the transaction. Based on an indication that the blockchain client does hold the transaction, the blockchain client (e.g. blockchain client 1220, 1240) may perform execution of the transaction. The execution of the transaction may update data regarding private transmissions (e.g. private state).

Generating a new transaction block may include the node 1221 sending the transaction to the transaction manager 1222 with a request to store the transaction payload. The transaction manager 1221 may call enclave 1223 to validate the sender and encrypt the payload. The enclave may verify the private key for blockchain client 1220, and if validated, the enclave may process the transaction. The transaction manager 1222 may calculate a hash of the encrypted payload and then store the encrypted payload and encrypted random master keys (RMKs) against the hash in the database. The transaction manager 1222 may send data associated with the transaction to the transaction manager 1242 of blockchain client 1240. For example, the data associated with the transaction may include the encrypted payload, an encrypted RMK, nonces to transaction manager of blockchain client 1240. In response to an indication that data transmission to transaction manager 1242 has been successful, for example, in the form of an ACK response, transaction manager 1242 may change the transaction's value to indicate to other nodes a private transaction with an associated encrypted payload.

According to some embodiments, transactions may be configured to execute under one or more conditions. For example, a user may configure a transaction such that the transaction executes when a threshold is exceeded, at a certain time, based on one or more other transactions, and/or the like. In some examples, a user may configure a transaction such that the transaction executes on delivery of a good (e.g., once a good has been delivered, on confirmation of delivery of a good, etc.) or on completion of a service. A user may configure a transaction through programming. In some examples, the transaction may be implemented as one or more smart contracts deployed on a node. A smart contract may comprise computer code that automatically executes an agreement and may be stored on a blockchain-based platform. In some examples, a public store of a node may comprise public states of contracts that are public (e.g. are synchronized globally). In some examples, a private store of a node may comprise private states of contracts that are private (e.g. are not synchronized globally). In some embodiments, executing the smart contract may complete a transaction between blockchain client 1210 and 1230.

According to some embodiments, the system 1200A of FIG. 12A may be used to facilitate public transactions on a public blockchain. For example, the node 1221 may receive a transaction for transferring an amount of digital currency from the first entity 1210 to the second entity 1230. As described herein, the first entity and the second entity may be customers relating to the same financial institution. The first entity may request a transfer of the amount of digital currency from the first entity's digital currency account at the financial institution. The transaction may be broadcasted to the network (e.g. using a peer to peer (P2P) network) and added to a transaction block representing the transactions to be distributed to blockchain clients on the network. The transaction may subsequently be verified and executed.

Additionally, according to some embodiments, the system 1200A of FIG. 12A may be used to facilitate both private and public transactions on a public blockchain. For example, private and public transactions may be created and executed as described herein. In some embodiments, the first entity 1210 may optionally indicate that a transaction is a private transaction and/or a public transaction when sending a transaction to the node 1221.

FIG. 12B is a block diagram of an illustrative system 1200B for facilitating private transactions on a public blockchain using a digital currency between a first entity 1210 and a second entity 1230. The first and second entities, 1210 and 1230 respectively, may relate to different financial institutions in accordance with some embodiments of the technology described herein. The first entity 1210 may be associated with a blockchain client 1220, where the blockchain client 1220 includes node 1221, transaction manager 1222 and enclave 1223. The second entity 1230 may be associated with a blockchain client 1240, where the blockchain client 1240 includes node 1241, transaction manager 1242 and enclave 1243. According to some embodiments, the first and second entities of FIG. 12A and FIG. 12B may communicate transactions to the nodes using one or more decentralized digital applications (DAPPs). According to some embodiments, the first and second entities of FIG. 12A and FIG. 12B may communicate transactions to the nodes using one or more wallets.

According to some embodiments, the system 1200B of FIG. 12B may be used to facilitate both private and/or public transactions on a public blockchain using the methods and techniques above in relation with FIG. 12A.

As described herein, each node (e.g. 1221, 1241) may comprise a private and/or public store. For example, a node (e.g. 1221, 1241) may store data regarding the public blockchain (e.g. a public state). In some embodiments, a node may store full blockchain data. In some embodiments, a node may store data on identifiers of blocks (e.g. such as blocks 1110, 1120, 1130, and 1140) of a public blockchain (e.g. blockchain 1100). For example, a block identifier may be a block header. In some examples, the data on identifiers of blocks may be a chain of headers (e.g. header chain). According to some embodiments, a node may also store data regarding private transactions between the blockchain client that the node belongs to and another blockchain client. For example, the node may store data on a private state.

On-Chain Payments

According to some embodiments, the transactions may be on-chain transactions such that the transactions occur on a blockchain and are reflected on the distributed, public ledger. In some examples, the on-chain transactions are validated or authenticated and update to the blockchain network.

As described herein, the digital currency issued as a result of the transaction is issued by one of the financial institutions. Alternatively or additionally, the financial institution issuing the digital currency may complete the transaction using a centralized clearing house described herein or a conventional inter-bank transfer system, (e.g. ACH). As described herein, in some aspects, a purchase transaction is facilitated between two entities, a customer and a store, relating to different financial institutions. A financial institution, such as a bank, may issue a digital currency card for transactions in the bank's digital currency. The bank's customer may visit a store that keeps funds with a different bank. The bank's customer may provide the digital currency card to pay for an item using the bank's digital currency. In some embodiments, the bank provides a digital wallet as described herein, e.g., with respect to FIGS. 6 and 7. In some examples, the digital wallet may be facilitated using a DAPP as described herein. The bank's customer may use the digital wallet to pay for an item using the bank's digital currency. In some embodiments, the bank provides a device that can accept the bank's digital currency card and/or digital wallet and notify a server at the bank to complete the transaction. In some embodiments, a machine provided by VISA, MASTERCARD, AMEX, SQUARE, or another payment company, can accept the digital currency card (VISA, MASTERCARD, AMEX, and SQUARE are registered marks of, respectively, Visa Inc., Foster City, Calif., USA; Mastercard Incorporated, Purchase, N.Y., USA; American Express Company, New York, N.Y., USA; and Square, Inc., San Francisco, Calif.). The machine may relay information regarding the transaction to the payment company's processing center, which in turn notifies the bank. Subsequently, a server at the bank may complete the transaction.

In some embodiments, the digital currency is exchanged for fiat currency, such as the United States Dollar, which is then transferred to the store's account at the other bank. In some embodiments, if the store wishes to complete the transaction in a digital currency, the store's bank may exchange the received fiat currency into the other bank's digital currency and deposit it into the store's digital currency account via exchange 1270. In some implementations, the digital currency received in the store's digital currency account is different from the digital currency transferred from the customer's digital currency account. This is because the digital currencies issued by the two banks may be different and not interchangeable. However, transfers from one digital currency account at a bank to another digital currency at a different bank may be accomplished via an intermediary conversion to a fiat currency, such as the United States Dollar.

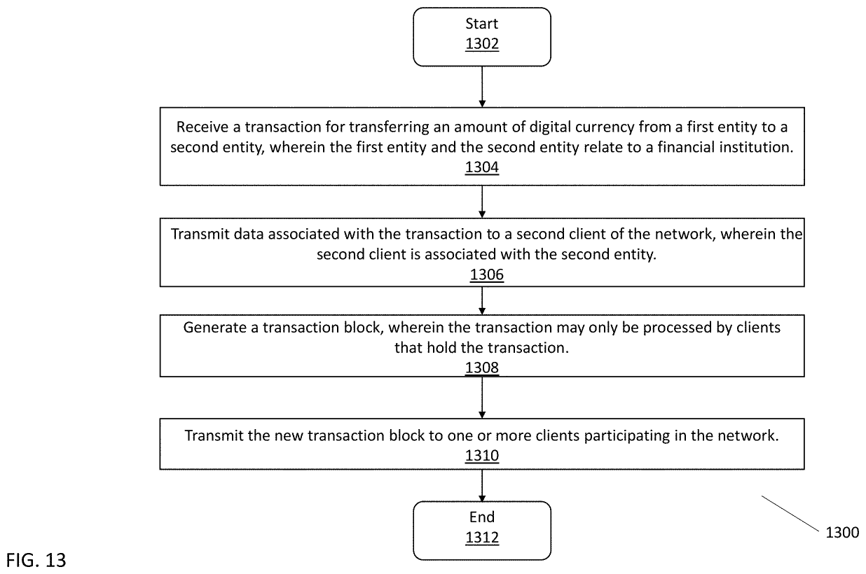

FIG. 13 is a diagram of an exemplary process 1300 for facilitating a private transaction on a blockchain between a first entity and a second entity using a digital currency issued by a financial institution and fixed with respect to a fiat currency. The method may be implemented on a first client of a network of clients.

At Act 1302, the process starts.

At Act 1304, the first client related to the first entity receives a transaction for transferring an amount of digital currency from the first entity to the second entity, wherein the first entity and the second entity relate to the financial institution. The first and second entity may be any entity described herein, including those described in relation with FIG. 3.

At Act 1306, the first client transmits data associated with the transaction to a second client of the network, wherein the second client is associated with the second entity. In some embodiments, the data associated with the transaction to the second client includes the encrypted payload of the transaction. In some embodiments, the data associated with the transaction to the second client includes an encrypted RMK. In some embodiments, the data associated with the transaction to the second client includes nonces to a transaction manager of the second client.

At Act 1308, the first client may generate a transaction block. In some embodiments, the transaction may only be processed by clients that hold the transaction. In some examples, the clients that hold the transaction comprise clients associated with the first and second entity. In some examples, the clients that hold the transaction include the first and second client.

At Act 1310, the first client transmits the new transaction block to one or more clients participating in the network. In some embodiments, the new transaction block transmits to all clients participating in the network. In some embodiments, the transaction block comprises data relating to the transaction.

At Act 1312, the process ends.

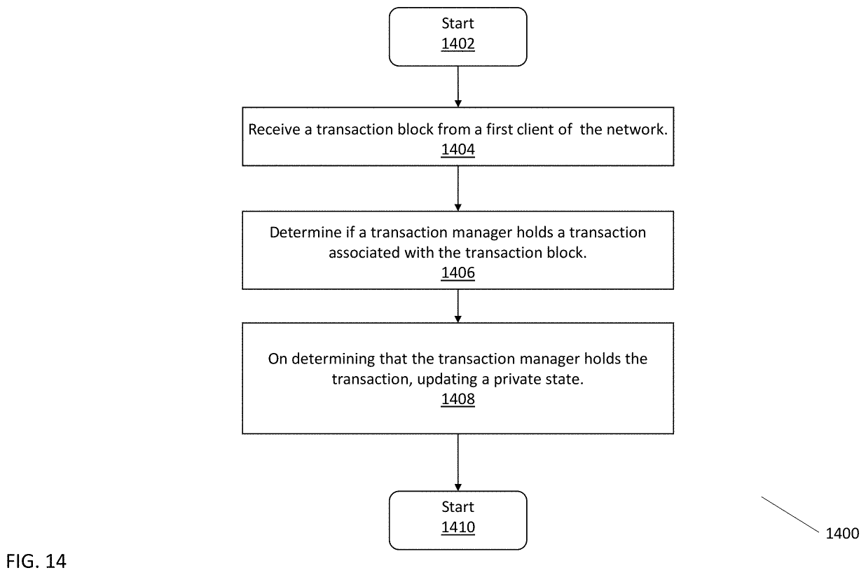

FIG. 14 is a diagram of an exemplary process 1400 for facilitating a private transaction on a blockchain between a first entity and a second entity using a digital currency issued by a financial institution and fixed with respect to a fiat currency. The method may be implemented on a first client of a network of clients. The first and second entity may be any entity described herein, including those described in relation with FIG. 3.

At Act 1402, the process starts.

At Act 1404, the first client may receive a transaction block from a second client related to the first entity of the network of clients. In some embodiments, the new transaction block transmits to all clients participating in the network. In some embodiments, the transaction block comprises data relating to the transaction.

At Act 1406, the first client determines if a transaction manager of the first client holds a transaction associated with the transaction block. In some embodiments, the first client may determine if the transaction manager holds the transaction by making a call to the transaction manager of the first client.

At Act 1408, on determining that the transaction manager holds the transaction, the first client updates a private state of a node of the first client. For example, a private state of a node of a client may include data associated with private transactions between the client and other clients on the network. At Act 1410, the process ends.

FIG. 6 is a diagram of an exemplary process for creating and/or populating a digital wallet using a digital currency in accordance with some embodiments of the technology described herein. At 602, a customer of a financial institution may deposit fiat currency, e.g., United States Dollar (USD), for an account at the financial institution.

At 604, the financial institution may open the account for the customer and deposit the customer's fiat currency into the account. In some embodiments, the financial institution may be pre-certified by the clearing house for opening accounts for some or all users of the financial institution. For example, a financial institution may be ranked based on rules from the clearing house that rate financial institutions. Based on a high rank for the financial institution, the financial institution may be allowed to open accounts for some or all users based on a uniform set of rules received from the clearing house. For example, the financial institution may be allowed to open accounts for users of the financial institution that are credit-worthy, have a threshold number of years of relationship with the financial institution, have a threshold amount of time-averaged balances across their accounts, and/or comply with other suitable metrics. Additionally or alternatively, the financial institution may be pre-certified by the clearing house for authorizing users and performing certain transactions for some or all users of the financial institution. Based on a high rank for the financial institution, the financial institution may be allowed to perform certain transactions for some or all users based on a uniform set of rules received from the clearing house.

According to some embodiments, the transaction may include a user purchasing an aspect of a virtual reality (VR), augmented reality (AR), and/or extended reality (XR) using digital currency. For example, a user may purchase an avatar, one or more virtual objects, virtual real estate, virtual money and/or the like for use in a VR, AR, or XR world or worlds otherwise referred to as metaverse. Aspects of this disclosure may be equally applicable to transactions conducted in such metaverse embodiments and these aspects may be used to conduct transactions using one or more digital currencies in such metaverse embodiments.

Buyer Protection

According to some embodiments, a first amount of digital currency used by the user during a purchase of a good may be refunded to the user in certain cases. For example, the first amount of digital currency may be a purchase price of the good or less than the purchase price of a good. The amount may be refunded if the goods were not delivered, if the delivered goods were different from the purchased goods and/or damaged.

According to some embodiments, a digital currency used by the user during a purchase of a good may only be taken from an account (e.g., digital currency account, digital wallet) of the user when the purchased good is delivered under certain circumstances. For example, the digital currency may not leave the account if the good was not delivered, if the delivered good was different from a purchased good and/or damaged

According to some embodiments, a financial entity may delay the transfer of digital currency out of the digital wallet and or digital currency account if the financial entity does not recognize the seller, if the user has never purchased from the seller previously through the digital wallet, and/or the like. In some embodiments, the seller's account and/or digital wallet may show that the funds (e.g., digital currency) are on hold after the purchase of the good, but before the transaction is executed. In some embodiments, the buyer's account and/or digital wallet may show that the funds (e.g., digital currency) are on hold after the purchase of the good, but before the transaction is executed.

According to some examples, the transaction may be automatically executed and the digital currency removed from the user's digital currency account and/or digital wallet when one or multiple criteria are met. For example, the transaction may execute after a predetermined period of time. In some examples, the transaction may be executed after manual confirmation and/or indication of the buyer that the transaction is authorized by the user.

Credit Rating

In some embodiments, the digital wallet may further comprise information identifying a credit rating of the user. In some examples, the credit rating may be accessed by third parties (e.g., vendors) to make one or more credit decisions.

At 606, the customer may request an exchange of a portion of his fiat currency, e.g., $100, into a digital currency issued by the financial institution, e.g., $AA100SC (i.e., digital currency issued by financial institution AA and fixed with respect to USD), where SC may refer to standard coin, stable coin, or another suitable reference to a digital currency that is fixed with respect to a fiat currency.

At 608, the financial institution may send a notice to a clearing house with information regarding the requested exchange from the customer and receive approval of the customer and/or the transaction by clearing house. For example, the clearing house may implement “know your customer” policies to standardize the process for issuing digital wallets to customers and/or approving third parties to be entrusted with holding digital currencies for customers. In some embodiments, the financial institution may be pre-certified by the clearing house for authorizing users and performing certain transactions for some or all users of the financial institution. Based on a high rank for the financial institution, the financial institution may be allowed to perform certain transactions for some or all users based on a uniform set of rules received from the clearing house. For example, the financial institution may be allowed to perform currency exchange transactions for most or all users but may be allowed to perform commodity exchange transactions for only those users that are credit-worthy, have a threshold number of years of relationship with the financial institution, have a threshold amount of time-averaged balances across their accounts, and/or comply with other suitable metrics.

At 610, the financial institution may record the transaction on a private distributed ledger for the digital currency and transfer the fiat currency from the user's account to an omnibus account (details for which are provided further below).

At 612, the financial institution may issue the equivalent digital currency and transfer the digital currency to the user's digital wallet. In embodiments where a digital wallet does not exist for the user, the financial institution may request creation of the digital wallet prior to transferring the digital currency to the user's digital wallet.

In some embodiments, the digital wallet may hold a digital currency that is issued by a financial institution and fixed with respect to a fiat currency, e.g., United States Dollar (USD), and another digital currency that is issued by another financial institution and fixed with respect to the same fiat currency. For example, the digital wallet may include $AA100SC (i.e., digital currency issued by financial institution AA and fixed with respect to USD) and $BB100SC (i.e., digital currency issued by financial institution BB and fixed with respect to USD). The customer's digital wallet may hold multiple types of digital currencies from financial institutions that have opted into the digital wallet.

In some embodiments, when the customer's digital wallet receives a digital currency issued by a particular financial institution, the customer may be presented with one or more options to store the digital currency in the customer's digital wallet, exchange the digital currency issued by the particular financial institution into digital currency issued by another financial institution, and/or exchange the digital currency into equivalent fiat currency.

For example, the customer's digital wallet may receive $AA100SC (i.e., digital currency issued by financial institution AA and fixed with respect to USD), and the customer may decide to store this digital currency in the customer's digital wallet. Additionally or alternatively, the customer may select an option at a prior time to preauthorize storage of any received digital currency issued by a particular financial institution, e.g., financial institution AA or another financial institution, into the customer's digital wallet.

In another example, the customer's digital wallet may receive $BB100SC (i.e., digital currency issued by financial institution BB and fixed with respect to USD), and the customer may decide to exchange this digital currency into digital currency issued by another financial institution, e.g., financial institution AA. The digital currency issued by financial institution BB, $BB100SC, may be converted into digital currency issued by financial institution AA, $AA100SC, and stored in the customer's digital wallet. Additionally or alternatively, the customer may select an option at a prior time to preauthorize exchange of any digital currency not issued by a particular financial institution into digital currency issued by the particular financial institution, e.g., financial institution AA or another financial institution. For example, the customer may prefer financial institution AA because the customer holds an account with that financial institution, the customer trusts that financial institution more than other financial institutions (e.g., due to superior reputation, large holdings, favorable location, and/or another suitable criteria), the customer receives reward points and/or another benefit for storing digital currency issued by that financial institution, and/or another suitable reason for preferring that financial institution. Additionally or alternatively, the customer may select an option that digital currency issued by financial institution BB should be exchanged into digital currency issued by another financial institution before being stored in the digital wallet. The customer may be presented with options for other digital currencies for the exchange at the time of receiving digital currency issued by financial institution BB. Additionally or alternatively, the customer may specify at a prior time a preferred digital currency for exchanging any received digital currency issued by financial institution BB. The customer may not want to store digital currency issued by financial institution BB because of lack of trust or preference for financial institution BB (e.g., due to inferior reputation, small holdings, unfavorable location, or another suitable criteria) and/or another suitable reason.

In yet another example, the customer's digital wallet may receive digital currency issued by a financial institution, e.g., $AA100SC (i.e., digital currency issued by financial institution AA and fixed with respect to USD), and the customer may decide to exchange this digital currency into equivalent fiat currency, i.e., $100 USD. Additionally or alternatively, the customer may select an option at a prior time to preauthorize exchange of any digital currency issued by a financial institution into equivalent fiat currency. Additionally or alternatively, the customer may select an option that digital currency issued by a particular financial institution, e.g., financial institution BB, should be exchanged into equivalent fiat currency. The customer may be presented with the option to exchange into the fiat currency at the time of receiving digital currency issued by financial institution BB. Additionally or alternatively, the customer may specify at a prior time that any received digital currency issued by financial institution BB should be exchanged into equivalent fiat currency. The customer may not want to store digital currency issued by financial institution BB because of lack of trust or preference for financial institution BB (e.g., due to inferior reputation, small holdings, unfavorable location, or another suitable criteria) and/or another suitable reason.

In some embodiments, the digital wallet may hold a digital currency that is fixed with respect to a fiat currency, e.g., United States Dollar (USD), and another digital currency that is fixed with respect to a different fiat currency, e.g., Euro (EUR). These digital currencies may be issued by the same financial institution or different financial institutions. For example, the digital wallet may include $AA100SC (i.e., digital currency issued by financial institution AA and fixed with respect to USD) and €AA100SC (i.e., digital currency issued by financial institution AA and fixed with respect to EUR). In another example, the digital wallet may include $AA100SC (i.e., digital currency issued by financial institution AA and fixed with respect to USD) and €BB100SC (i.e., digital currency issued by financial institution BB and fixed with respect to EUR).

In some embodiments, a user's digital wallet may include one or more rules, e.g., to implement a tiered or ranking system, for accepting and sending out digital currency. The rules may be received from one or more financial institutions, one or more users, a clearing house for processing digital currency transactions using the digital wallet (details for which are provided further below), or another authorized source. For example, the user's primary financial institution may be assigned “Tier 1-A” status, signifying that the user may prefer to accept and/or store digital currency issued by the user's primary financial institution. In another example, the tiered or ranking system may be implemented based on rules received from a clearing house that rates financial institutions. The clearing house may include one or more financial institutions issuing digital currency and/or other entities suited to ranking such financial institutions. In some embodiments, the digital wallet may send out digital currency in reverse tier order. For example, if the user wishes to send digital currency equivalent to $100, the digital wallet may select, from the available digital currencies in the digital wallet, the digital currency issued by the lowest tier financial institution. In some embodiments, the user of the digital wallet may specify one or more financial institutions whose digital currencies the user may wish to accept and/or reject. Alternatively or additionally, the user may specify one or more financial institutions whose digital currencies that are acceptable but need to be converted to fiat currency on receipt.

In some embodiments, a user of the digital wallet may request conversion of digital currency in their digital wallet into fiat currency or another digital currency. In some embodiments, a user of the digital wallet may request a financial institution to exchange the financial institution's digital currency into fiat currency. For example, a customer of a financial institution may request that digital currency issued by the financial institution, e.g., $AA100SC, be converted into equivalent fiat currency, e.g., $100. The financial institution may record the transaction on its private distributed ledger and issue the equivalent fiat currency to the customer.

In some embodiments, a user of the digital wallet may request a financial institution to exchange another financial institution's digital currency into fiat currency. For example, a customer of a financial institution AA may request that digital currency issued by another financial institution BB, e.g., $BB100SC, be converted into equivalent fiat currency, e.g., $100. The financial institution AA may record the transaction on its private distributed ledger, send the transaction to a clearing house (details for which are provided further below), and/or send the transaction to the financial institution BB, in order to issue the equivalent fiat currency to the consumer. In some embodiments, based on the tier of the financial institution BB, the financial institution AA may issue the equivalent fiat currency to the customer from its own reserves (e.g., if the financial institution BB is high ranked) and receive the fiat currency from the financial institution BB when the two financial institutions settle their accounts on a periodic basis. Alternatively, the financial institution AA may wait for the fiat currency to be received from the financial institution BB before issuing the equivalent fiat currency to the customer (e.g., if the financial institution BB is low ranked).

Fiat Reserves

In some examples, the financial institution holding a reserve of fiat currency may be a private bank, and/or the government, including the Federal Reserve (e.g. Central bank, regional reserves, etc.). In some embodiments, a financial institution receiving digital currency issued by another financial institution may apply a tiered or ranking system for determining appropriate timing for completing the transaction (e.g., Tier 1-Tier 5). For example, financial institutions in the highest tier, e.g., Tier 1, may settle all transactions between them once a month or when a certain limit is reached. In another example, a financial institution in the highest tier, e.g., Tier 1, entering a transaction with a financial institution in the lowest tier, e.g., Tier 5, may require the lowest tier financial institution to immediately complete the transaction and transfer the digital currency and/or fiat currency.

In some embodiments, a user of the digital wallet may request a financial institution to exchange the financial institution's digital currency that is fixed with respect to a fiat currency into digital currency that is fixed with respect to a different fiat currency. For example, the user may request the financial institution to exchange $AA100SC (i.e., digital currency issued by the financial institution and fixed with respect to USD) into €AA86.33SC (i.e., digital currency issued by the financial institution and fixed with respect to EUR, based on the current exchange rate). The financial institution may record the currency exchange on its private distributed ledger and transfer the requested digital currency to the user's digital wallet. In some embodiments, the financial institution may maintain an omnibus account, or multiple accounts, for each fiat currency that supports a corresponding digital currency issued to all its customers. In order to complete the currency exchange transaction, the financial institution may transfer out an amount of fiat currency, e.g., USD, from the omnibus account for the fiat currency and transfer in an equivalent amount of the exchanged currency, e.g., EUR, to the omnibus account for the exchanged currency.

In some embodiments, a user of the digital wallet may request conversion of government issued digital currency in their digital wallet into fiat currency or another digital currency, such as a financial institution issued digital currency or a digital currency issued by another government. In some embodiments, a user of the digital currency account may request a financial institution to exchange the government issued digital currency into fiat currency. For example, a customer of a financial institution may request that digital currency issued by the government be converted into equivalent fiat currency. The financial institution may record the transaction on its private distributed ledger and issue the equivalent fiat currency to the customer.

In some embodiments, a user of the digital currency account may request a financial institution to exchange government issued digital currency into digital currency issued by another government. For example, a customer of a financial institution AA may request that digital currency issued by government GA, e.g., $GA100SC, be converted into equivalent digital currency issued by a second government, e.g., $GB 100SC. The financial institution AA may first determine using digital currency exchange rates, the correct equivalent amount of digital currency issued by the second government. In some examples, the government issued digital currency is based on the fiat of the same government. The digital currency exchange rates may then be based on the currency rates between fiat of the two governments and may be fixed and/or flexible. The financial institution may record the transaction on its private distributed ledger.

According to some embodiments, a user of the digital currency account may request a financial institution to exchange government issued digital currency into digital currency issued by the financial institution. For example, a customer of a financial institution AA may request that digital currency issued by government GA, e.g., $GA100SC, be converted into equivalent digital currency, e.g., $AA100SC. The financial institution may record the transaction on its private distributed ledger and issue the equivalent financial institution issued digital currency to the customer.

The digital currency account may be held by each individual or may be held by the financial institution. In some embodiments, when the government entity issues the digital currency, the users may have an account with the government entity and the government entity may hold the digital currency. In some examples, the government also holds fiat for a fiat-based government issued digital currency.

In some embodiments, the financial institution tracks ownership of digital currency issued by the financial institution, which has deposit insurance for an amount of fiat currency that is equivalent in value to an amount of the digital currency, being backed or supported by the fiat currency in an omnibus account at the financial institution.

In some embodiments, the financial institution may maintain in the omnibus account an amount of fiat currency equivalent to an amount of digital currency issued thus far by the financial institution. The omnibus account may be used to back the issued digital currency. Deposit insurance may be available for such a fiat currency account. For example, in the United States, the Federal Deposit Insurance Corporation (FDIC) is an independent agency of the United States government that protects deposit consumers against the loss of their insured deposits if an FDIC-insured financial institution fails. The financial institution may track ownership of the issued digital currency and obtain insurance for the equivalent fiat currency for each account holder. In some embodiments, the digital wallet may include an indication of which country is insuring the financial institution relating to the digital currency in the digital wallet or that the financial institution is not insured relating to the digital currency in the digital wallet for the user. For example, the digital wallet may include color and/or code indications regarding which country is insuring the financial institution relating to the digital currency in the digital wallet. In some embodiments, the omnibus account may be used to satisfy government regulations relating to currency exchange transactions (and, optionally, in addition to the KYC procedures described above). For example, in the United States, the Office of the Comptroller of the Currency (OCC) enforces regulations relating to currency exchange. Accordingly, the financial institution may maintain an omnibus account for each fiat currency that is used to back a digital currency issued by the financial institution, where ownership of the omnibus account is tied to each holder of digital currency.

In some embodiments, the received request for currency exchange is performed in real-time, and a current currency exchange rate is applied to the request. In some embodiments, the received request for currency exchange is set to happen at an exchange price or based on an exchange price at the time of the transaction. Having the received request for currency exchange based on an exchange price at the time of the transaction may be advantageous to have an exact amount of currency needed being converted; however, this embodiment may carry a risk of price fluctuation affecting the final exchange price used for the transaction.

In some embodiments, the user of the digital wallet may set one or more notifications relating to fiat currency exchange rates in order to decide a suitable time to execute the currency exchange transaction. Typically, foreign exchange settlement can have significant transaction cost, particularly for traveling consumers or non-enterprise entities. The described systems and methods may allow the user to exchange foreign currency and/or access foreign currency prices in real time or near real time. This process may be more efficient than conventional foreign exchange markets and provide time and/or cost benefits to individual consumers and enterprises alike. This system may be a viable alternative to conventional foreign exchange markets and handle all related transactions or be complementary to conventional foreign exchange markets and handle transactions that need to be real time and/or cost effective compared to the conventionally available options for currency exchange. In some embodiments, the user can access different exchange prices for one or more foreign currencies from multiple entities providing foreign exchange services. The user may select a particular entity for their foreign currency exchange transaction based on better pricing, reputation, speed of transaction, and/or suitable factors related to the particular entity.

For example, the user may be interested in exchanging a USD-backed digital currency into a EUR-backed digital currency. In another example, the user may be interested in exchanging a USD-backed digital currency into a commodity, such as gold, silver, platinum, copper, oil, natural gas, corn, soybeans, wheat, cocoa, coffee, cotton, sugar, or another suitable commodity. The commodity may either be owned by a financial institution, or the financial institution may own rights to the commodity. The commodity may be represented as a digitized asset, e.g., in the form of a token, that can be included in a digital transaction and/or stored in the user's digital wallet. The commodity may include assets such as real estate, where the digitized asset may show what percentage or interest is owned in an asset or a group of assets. In some embodiments, one or more rules may be established (e.g., a smart contract of a limited liability company), e.g., for raising future capital if needed, for sale and financial of the asset or the group of assets, for transfer of the digitized assets, and/or another suitable rule. For example, one or more rules may be provided to automatically allocate digital currency to different entities, such as shareholders or another suitable entity. For example, the digitized asset for the commodity may be stored in a separate area of the user's digital wallet. Because the value for the digitized asset can fluctuate based on the commodity's value, the user's digital wallet may indicate the current value, an amount of the commodity owned, the value at the time of the transaction, and/or indicate to the user that the value of the digitized asset may fluctuate based on the commodity's value. In some embodiments, one or more rules for price fluctuation may be established, e.g., quarterly, annually, or another suitable appraisal period. In some embodiments, the entity holding the asset may be responsible for taxes, the holder of the interest may be responsible for taxes (e.g., similar to a real estate investment trust, a limited liability company, etc.), and/or another suitable party, or a combination thereof. In some embodiments, foreign holders of interest may receive a tax advantage where the foreign holder, e.g., outside the United States, selling their interest may not owe taxes to the United States. In some embodiments, the transfer taxes on sale of a foreign holder's interest may be different depending on the foreign holder's location, the asset's location, the type of asset, and/or another suitable constraint, or a combination thereof.

According to some embodiments, the token may be non-fungible. In some examples, the non-fungible token may be a form of digital currency. The non-fungible token may be unique and non-interchangeable for any other token. The non-fungible token may be a unique digital artwork and/or music, domain names, a digital collectible (e.g., CryptoKitties, memes), an artificial intelligence (AI) character, a ticket, a part of a virtual world, a part of a game such as a digital object used in games, item having utility (e.g., a specific function), providing owners with voting rights and/or the like. In some examples, the non-fungible token may be associated with stocks, options, and/or other suitable financial instruments and/or commodities, real estate, and/or other suitable non-financial instruments (e.g., the NFT may represent at least a portion of a stock, an option, and/or another suitable financial instrument and/or at least a portion of a commodity, real estate, and/or another suitable non-financial instrument). According to some embodiments, the token may be fungible. For example, a fungible token may be a token that is replaceable with another identical token. According to some embodiments, a combined value of one or more non-fungible tokens may be proportionally allocated as individual fungible tokens representing stakes in the combined value. According to some embodiments, the NFT may be a collective NFT and a creator of the NFT may sell the NFT to a decentralized autonomous organization (DAO) in exchange for tokens issued by the DAO. In some embodiments, the NFTs may back the issued tokens. The issued tokens may provide a user with voting rights on projects related to the DAO.

According to some embodiments, the token may be a digital representation of a digital currency. For example, the digital asset may be a wrapped digital currency. In some embodiments, the digital currency may be tokenized by requiring a user to lock an amount of digital currency in order to receive tokens fixed with respect to the value of the digital currency. According to some embodiments, the digital currency may be tokenized using an entity (e.g., any entity described herein). For example, the user may transfer a first amount of digital currency to the entity. The transferred digital currency may be locked using a smart contract by the entity, and the entity may send an equivalent amount of tokenized digital currency to the user's digital wallet and/or to an associated account. In some embodiments, the user may directly transmit digital currency to a smart contract and receive an equivalent amount of tokenized digital currency.

According to some embodiments, the digital currency may be a digital currency on a first public or private blockchain as described herein and the tokenized digital currency may be a digital currency on a second public or private blockchain as described herein. In some examples, a digital wallet of a user may be configured to tokenize the digital currency as described. As described herein, an owner of tokens issued by a decentralized autonomous organization (DAO) may be provided with voting rights on projects related to the DAO. The DAO may operate using smart contracts which define how assets associated with the DAO (e.g., digital currency, tokens, stocks, commodities, fiat, etc.) are used. Those with a stake in a DAO (e.g., owning one or multiple tokens of a DAO) may use their voting rights to influence operations of the DAO. For example, the DAO may change rules set by smart contracts through a governance system of the DAO (e.g., majority vote may lead to change).

The user may set a notification for a favorable exchange rate and/or a range of favorable exchange rates. On receiving the notification, the user may initiate the currency exchange or commodity exchange transaction. Alternatively or additionally, the user may allow the digital wallet to automatically initiate the currency exchange or commodity exchange transaction on receipt of the notification. In some embodiments, the financial institution may regulate and approve or deny the ability for the user to receive and/or initiate currency exchange or commodity exchange transactions. For example, the financial institution may require the user to indicate whether the transaction(s) are related to personal use or investment purposes. The financial institution may take into account this information when approving or denying the ability for the user to receive and/or initiate currency exchange or commodity exchange transactions. In some embodiments, the financial institution may provide currency exchange or commodity exchange transaction facilities to all its customers. In some embodiments, the financial institution may provide currency exchange or commodity exchange transaction facilities to customers after approving each customer on an individual basis. In some embodiments, as a control mechanism, recipients of digital currency (e.g., retailers, business users, friends, etc.) may be required to receive only digital currency that is backed by the country of their financial institution. However, a recipient user may opt to accept payments in a digital currency backed by another fiat currency or a commodity. The recipient's financial institution may allow the recipient to convert another financial institution's digital currency into their digital currency, fiat currency, or another suitable conversion. In some embodiments, the financial institution may allow an accredited investor access to trade or hold certain assets. For example, the recipient may be allowed to receive or purchase an asset or a pool of assets if the recipient is recognized as an accredited investor by the financial institution.

In some embodiments, the digital currency held by the recipient in their digital wallet, or another suitable location, may be presented to the recipient as general fiat digital currency (e.g., a US Dollar backed stable coin). From the recipient's perspective, the financial institution specific digital currencies may be exposed or hidden. For example, the recipient may request to see details of their digital currency holdings and get a breakdown of digital currencies from different financial institutions. For example, the recipient holding USD backed digital currencies may see that out of $10,000 in digital currency, $5000 are held in a digital currency issued by a first financial institution, $3000 are held in a digital currency issued by a second financial institution, and $2000 are held in a digital currency issued by a third financial institution.

In some aspects, the financial institutions issuing their respective digital currencies may opt into a centralized clearing house. The clearing house may implement its own private distributed ledger for recording all transactions including in digital currencies from two different financial institutions. The clearing house may include one or more clearing houses having one or more private distributed ledgers to implement the systems and methods described herein. In some embodiments, the private distributed ledger may interact with a public ledger and/or run on a public ledger. For example, functionality to conduct private transactions for the private distributed ledger may be implemented using an application that runs on a public blockchain. This public blockchain may optionally provide support for other financial and/or non-financial applications in addition to the functionality for conducting private transactions for the private distributed ledger. In some embodiments, within a public distributed ledger, a portion can be designated as private and the distribution more limited based on the digital currency, user, and/or other suitable information. Additionally or alternatively, a private distributed ledger may share or receive information and/or transaction blocks from or with/within a public system. The described systems and methods may be implemented using any one or more of the distributed ledgers described herein or another suitable variation thereof. In some embodiments, the transactions may be recorded in the private distributed ledger of each financial institution involved in the transaction and the private distributed ledger of the clearing house. For example, the private distributed ledger of the clearing house may include transactions between users from different financial institutions (including transactions between users of the same financial institution), but the private distributed ledger of each financial institution may only include transactions between users of the same financial institution or transactions involving a user of the financial institution as a party to the transaction. In some embodiments, the transaction may be recorded in the financial institution's private distributed ledger and subsequently relayed for recordation in the clearing house's private distributed ledger. In some embodiments, the transaction may be simultaneously recorded in the financial institution's private distributed ledger and the clearing house's private distributed ledger. In some embodiments, the transaction may be recorded in the clearing house's private distributed ledger and once approved by the clearing house, recorded in the financial institution's private distributed ledger. In some embodiments, the clearing house, like the financial institutions' private distributed ledgers, may be implemented using computing nodes (e.g., computing nodes 156, 160 and/or 162 (FIG. 1, illustrative system 150)) that store and maintain a copy of a private distributed ledger 158 for the clearing house. The private distributed ledger may store one or more transaction blocks representing transactions in digital currencies and involving two or more different financial institutions. In an example, a store that keeps its funds in a particular bank's digital currency account can accept digital currency issued from another bank because the transaction may be cleared through the clearing house as a transaction that involves a different financial institution from that of the store.

In some embodiments, the clearing house may record a transaction and optionally notify one or both the financial institutions regarding appropriate timing for completing the transaction. The clearing house may incorporate a tiered structure for ranking financial institutions based on asset size, debt rating, financial solvency tests and/or other suitable criteria for each financial institution. In some embodiments, there are two steps for completing the transaction, clearing and settlement. Clearing is the transfer and confirmation of information between the payer (sending financial institution) and payee (receiving financial institution). Settlement is the actual transfer of digital currency between the payer's financial institution and the payee's financial institution. Settlement discharges the obligation of the payer financial institution to the payee financial institution with respect to the transaction. For example, financial institutions in the highest tier may settle all transactions between them only once a month or if a balance limit is exceeded. In another example, a transaction between a financial institution in the highest tier and a financial institution in the lowest tier may settle on an individual transaction basis or when a balance limit is exceeded.

In some embodiments, for a transaction between two differential financial institutions, the clearing house may record the transaction between a customer of a first financial institution, e.g., a buyer, and a customer of a second financial institution, e.g., a merchant. The buyer may make a purchase with digital currency issued by the first financial institution. The merchant may receive payment in digital currency issued by the first financial institution. The merchant may keep some or all the received digital currency issued by the financial institution, transfer to digital currency issued by the second financial institution, transfer to fiat currency, or a combination thereof. The merchant may specify an order or preference for keeping and/or transferring received digital currency prior to the transaction, at the time of the transaction, or another suitable means of specifying the order or preference. The respective financial institutions may move equivalent fiat currency in or out of their respective omnibus accounts and settle the transaction at a later time, e.g., based on appropriate timing for completing the transaction as notified by the clearing house. The funds may be marked as red/yellow, or another suitable indicator(s), in the digital wallet of the recipient and/or the private distributed ledgers to represent a pending status until the financial institutions settle the transaction. In some embodiments, the pending status may be beneficial for payment on delivery or cash on delivery transactions where the buyer may inspect a purchased product on receipt and approve immediate payment.

In some embodiments, each individual transaction may receive a unique transaction number that may be used to track the transaction across the private distributed ledgers for the clearing house and the involved financial institutions. For example, in a transaction involving transfer of digital currency from one financial institution to another, the transaction may be independently recorded in the private distributed ledger of each financial institution and the private distributed ledger of the clearing house. The independent recordations of the transactions may be tracked using the unique transaction number assigned to the transaction. The unique transaction number may be assigned by either financial institution, the clearing house, or another entity suitable for issuing such unique transaction numbers. In some embodiments, the clearing house may be the authority for disputes regarding transactions between financial institutions. To help resolve the dispute, the clearing house may retrieve the transaction from its private distributed ledger using the assigned unique transaction number.

In some embodiments, while the clearing house may charge fees for facilitating transactions between customers from different financial institutions and/or between customers within a financial institution, the clearing house itself may not hold any digital currency. The clearing house may instead notify the financial institutions regarding appropriate timing for completing the transaction. In some embodiments, the clearing house may implement “know your customer” policies to standardize the process for issuing digital wallets to customers and/or approving third parties to be entrusted with holding digital currencies for customers. In some embodiments, on instruction from one of the financial institutions involved in the transaction, the clearing house may block a certain transaction. For example, the financial institution may have received information regarding the transaction being fraudulent, being used to purchase illicit goods, or other illegal activity. Similarly, the clearing house itself may receive such information and block a certain transaction based on the information. In another example, the financial institution and/or the clearing house may freeze and/or revoke one or both digital wallets involved in the transaction to prevent further illegal activity and cause for forfeiture of funds.

FIG. 7 shows illustrative diagrams of exemplary transactions 700 and 750 in a digital currency using a digital wallet in accordance with some embodiments of the technology described herein. In transaction 700, a customer of the financial institution 706 requests an amount of digital currency from his digital wallet 702, e.g., $AA100SC, be transferred to the digital wallet 704 for another customer of the financial institution 706. The transaction may be recorded on the private distributed ledger of the clearing house 708 and the digital wallets 702 and 704 may be updated and the digital currency, e.g., $AA100SC, may be transferred from the digital wallet 702 to the digital wallet 704. In some embodiments, the clearing house 708 may send the transaction to be recorded on the private distributed ledger for the financial institution 706. In some embodiments, one or both digital wallets 702, 704 may send the transaction to be recorded on the private distributed ledger for the financial institution 706. The financial institution may update the holder of the equivalent fiat currency in the financial institution's omnibus account. This may update the ownership information or other suitable information for protecting the new owner of the transferred digital currency with FDIC insurance or other suitable insurance based on region. In some embodiments, the clearing house 708 is notified by the financial institution 706 regarding the requested transaction to transfer digital currency from the digital wallet 702 to the digital wallet 704. In this case, the private distributed ledger for the clearing house 708 and/or the private distributed ledger for the financial institution 706 may be updated to reflect the transaction according to the techniques described herein. In some embodiments, for a transaction between digital wallets of two users at different financial institutions, one or both financial institutions may notify the clearing house 708 regarding the transaction. In this case, the private distributed ledger for the clearing house 708 and/or the private distributed ledgers for both financial institutions may be updated to reflect the transaction according to the techniques described herein.

In transaction 750, a customer of the financial institution 756 requests an amount of digital currency from his digital wallet 752, e.g., $AA100SC, be transferred to the digital wallet 754 for a customer of another financial institution 758. The transaction may be recorded on the private distributed ledger of the clearing house 760 and the digital wallets 752 and 754 may be updated and the digital currency, e.g., $AA100SC, may be transferred from the digital wallet 752 to the digital wallet 754. In some embodiments, because this transaction is across two financial institutions, the clearing house 760 acts as an intermediary between the two financial institutions. In some embodiments, the clearing house 760 may send the transaction to be recorded on the private distributed ledgers for the financial institutions 756, 758. In some embodiments, one or both digital wallets 752, 754 may send the transaction to be recorded on the private distributed ledgers for the financial institutions 756, 758. In some embodiments, the transaction may be recorded in a private distributed ledger in one or both digital wallets 752, 754. This step may serve as a safeguard for verifying the transaction, e.g., in absence of the clearing house 760. In some embodiments, the clearing house 760 may record the transaction in its private distributed ledger and subsequently notify one or both financial institutions 756, 758 to record the transaction in their respective private distributed ledgers. In some embodiments, the financial institution 756 may update the holder of the equivalent fiat currency in the financial institution's omnibus account. This may update the FDIC insurance information or other suitable insurance information for protecting the new owner of the transferred digital currency.

In some embodiments, the customer of the financial institution 758 may request the digital currency of the financial institution 756, e.g., $AA100SC, be converted into fiat currency, e.g., $100, and deposited into the customer's account at the financial institution 758. The clearing house 760 may act as an intermediary between the two financial institutions in order to facilitate the transaction. The clearing house 760 may verify for the financial institution 756 that the digital currency is held by the customer and notify the financial institution 756 (that issued the digital currency) regarding the transaction. In some embodiments, the digital currency for the financial institution 756, e.g., $AA100SC, may be exchanged directly into the requested fiat currency, e.g., $100. In some embodiments, the digital currency for the financial institution 756, e.g., $AA100SC, may first be converted to equivalent digital currency for the financial institution 758, e.g., $BB100SC, and subsequently exchanged into the requested fiat currency, e.g., $100.

In some embodiments, the clearing house 760 may generally act as a gateway for financial institutions, such as the financial institution 758, to track balances of the digital currency issued by the financial institution 756 that are held by customers of the respective financial institutions. In some embodiments, the clearing house 760 may apply a tiered or ranking system for determining appropriate timing for completing the transaction (e.g., Tier 1-Tier 5). The clearing house 760 may incorporate a tiered structure for ranking financial institutions based on asset size, debt rating, financial solvency tests and/or other suitable criteria for each financial institution. For example, financial institutions in the highest tier, e.g., Tier 1, may settle all transactions between them once a month or when a certain limit is reached. In another example, a financial institution in the highest tier, e.g., Tier 1, entering a transaction with a financial institution in the lowest tier, e.g., Tier 5, may require the lowest tier financial institution to immediately complete the transaction and transfer the fiat currency backing the digital currency. In another example, the clearing house 760 may request immediate payment of fees for facilitating transactions involving a lower tier financial institution, while the clearing house 760 may extend credit and collect fees on a periodic basis for facilitating transactions involving a higher tier financial institution.

Conventionally, fiat currency transfers between financial institutions may be conducted using the Clearing House Interbank Payments System (CHIPS) or Fedwire. CHIPS is a United States private clearing house for large-value transactions. Fedwire is a real-time gross settlement funds transfer system operated by the United States Federal Reserve Banks that allows financial institutions to electronically transfer funds between its participants. While CHIPS and Fedwire differ in their speed and minimum transaction amounts, both systems directly handle fiat currency and send fiat currency payments from one party to another. However, the only currency the clearing house 760 handles is relating to the clearing house's fees for facilitating transactions between the financial institutions. Unlike the conventional CHIPS-type or Fedwire-type systems, the clearing house 760 does not hold or handle any digital or fiat currency while facilitating transactions between the financial institutions. The clearing house as described may provide greater efficiency among the financial institutions, as compared to the conventional systems, in order to limit third party interactions, thereby saving time and money.

In some embodiments, a customer, C1, may have an account with a financial institution, FI1. For example, the customer C1 may have a savings account, SA1, at the financial institution FI1 with deposits in a fiat currency, $s. The customer C1 may also hold digital currency issued by the financial institution FI1 and fixed with respect to the fiat currency $s. The digital currency may be backed by deposits in the fiat currency $s in an omnibus account, OA1, at the financial institution FI1.

Further, a customer, C2, may have an account with a financial institution, FI2. For example, the customer C2 may have a savings account, SA2, at the financial institution FI2 with deposits in the fiat currency $s. The customer C2 may also hold digital currency issued by the financial institution FI2 and fixed with respect to the fiat currency $s. The digital currency may be backed by deposits in the fiat currency $s in an omnibus account, OA2, at the financial institution FI2.

Validation

The customers C1 and C2 may enter into a transaction where the customer C1 pays the customer C2 with XDC$s of the digital currency issued by the financial institution FI1. In some embodiments, the digital wallet of the customer C1 may hold a transaction block, or another suitable data structure, which may be used to validate the funds for the transaction. As part of processing the transaction, a clearing house, e.g., clearing house 708 or 760 or another suitable clearing house or clearing houses, and the financial institution FI1 may be notified of the transaction. Upon notification, the clearing house and the financial institution FI1 may enter the transaction block, or another suitable data structure, into their respective private distributed ledgers as described with respect to the embodiments discussed herein. This transaction block may indicate transfer of XDC$s of digital currency issued by the financial institution FI1 from the customer C1 to the customer C2. The customer C2 may now hold XDC$s of digital currency issued by the financial institution FI1, which is backed by X$s in the omnibus account OA1.

In some embodiments, the clearing house may verify availability of funds to complete the transaction. XDC$s in digital currency issued by the financial institution FI1 may be transferred from the customer C1 to the customer C2. As part of processing the transaction, the clearing house may be notified of the transaction. Upon notification, the clearing house may send an update regarding the transaction to the financial institution FI1. Both the clearing house and the financial institution FI1 may enter a transaction block, or another suitable data structure, into their respective private distributed ledgers as described with respect to the embodiments discussed herein. This transaction block may indicate transfer of XDC$s of digital currency issued by the financial institution FI1 from the customer C1 to the customer C2. The customer C2 may now hold XDC$s of digital currency issued by the financial institution FI1, which is backed by X$s in the omnibus account OA1.

In some embodiments, the financial institution, the clearing house, and/or another suitable validating entity may validate transactions based on one or more digital signatures, e.g., a digital signature of the payer (e.g., customer C1), a digital signature of the payee (e.g., customer C2), and/or another suitable digital signature. However, in some embodiments, the digital signature authorization may be performed prior to or independent from the transaction validation. For example, the validating entity may require each attempted transaction to be authorized with a digital signature before the transaction is allowed to proceed to validation. In some embodiments, transaction validation may include determining availability of digital currency to complete the transaction, sufficiency of funds to exchange into digital currency, and/or another suitable condition. For example, the transaction may be denied if the payer does not have a sufficient amount of digital currency required to complete the transaction. In another example, the transaction may proceed if the payer has access to an available amount of fiat currency equivalent to the sufficient amount of digital currency and the payer authorizes (or has previously authorized, such as when the payer's account was opened or updated) an exchange of the available amount of fiat currency into the sufficient amount of digital currency required to complete the transaction. In some embodiments, not all payers may have access to this benefit of automatic determination and exchange of equivalent fiat currency into digital currency. The payers who are allowed access may be determined based on the payer's credit worthiness, length of relationship between the payer and the payer's financial institution, time averaged balances of the payer's accounts, and/or other suitable metrics. In embodiments where the payer does not have access to this benefit, based on results of the validation indicating insufficient digital currency, the transaction may be denied and transaction information for the transaction may be prevented from being recorded. The validation embodiments described herein and in other aspects of this disclosure may be implemented on private distributed ledgers, public distributed ledgers, or a combination thereof.

According to some embodiments, the steps of validation described herein may be performed in any sequence, in any order.

Simultaneous Exchange

In some embodiments, both the clearing house and the financial institution FI1 may simultaneously or near simultaneously verify availability of funds to complete the transaction. XDC$s in digital currency issued by the financial institution FI1 may be transferred from the customer C1 to the customer C2. As part of processing the transaction, the clearing house and the financial institution FI1 may be notified of the transaction. Upon notification, both the clearing house and the financial institution FI1 may enter a transaction block, or another suitable data structure, into their respective private distributed ledgers as described with respect to the embodiments discussed herein. This transaction block may indicate transfer of XDC$s of digital currency issued by the financial institution FI1 from the customer C1 to the customer C2. The customer C2 may now hold XDC$s of digital currency issued by the financial institution FI1, which is backed by X$s in the omnibus account OA1.

In some embodiments, the clearing house may verify that funds are not available to complete the transaction. The clearing house may query the financial institution FI1 to determine whether the customer C1 has funds in fiat currency $s to cover the transaction. If the customer C1 does not have sufficient funds in its savings account SA1 at the financial institution FI1, the financial institution FI1 may terminate or request termination of the transaction. Additionally or alternatively, the financial institution FI1 may notify the clearing house which may terminate or request termination of the transaction.

If the customer C1 has sufficient funds in its savings account SA1 to cover the transaction, and the customer C1 has preauthorized transfer of funds from its savings account SA1 to digital currency issued by the financial institution FI1, the financial institution may transfer funds from the savings account SA1 to the omnibus account OA1 so the customer C1 has a digital currency balance of XDC$s, equivalent to X$s. The financial institution FI1 may enter a transaction block, or another suitable data structure, into its private distributed ledger as described with respect to the embodiments discussed herein. The financial institution FI1 may notify the clearing house which may enter a suitable transaction block in its private distributed ledger in order to complete the transaction.

If the customer C1 has sufficient funds in its savings account SA1 to cover the transaction, and the customer C1 has not preauthorized transfer of funds from its savings account SA1 to digital currency issued by the financial institution FI1, the financial institution may contact the customer C1 to obtain approval to transfer funds from the savings account SA1 to the omnibus account OA1. if the customer C1 approves the transfer, the financial institution FI1 may transfer funds so that the customer C1 has a digital currency balance of XDC$s, equivalent to X$s, and enter a transaction block, or another suitable data structure, into its private distributed ledger as described with respect to the embodiments discussed herein. The financial institution FI1 may notify the clearing house which may enter a suitable transaction block in its private distributed ledger in order to complete the transaction. If the customer C1 denies the request to transfer funds or cannot be reached, the financial institution FI1 may terminate or request termination of the transaction. Additionally or alternatively, the financial institution FI1 may notify the clearing house which may terminate or request termination of the transaction.

In some embodiments, both the clearing house and the financial institution FI1 may simultaneously or near simultaneously verify that funds are not available to complete the transaction. The clearing house may query the financial institution FI1. The financial institution FI1 may determine whether the customer C1 has funds in fiat currency $s to cover the transaction and attempt to complete the transaction as described above. If the funds are not available and/or approval from the customer C1 cannot be obtained, the financial institution FI1 may terminate or request termination of the transaction. Additionally or alternatively, the financial institution FI1 may notify the clearing house which may terminate or request termination of the transaction.

Processing Transactions

In some examples, the transactions may be processed by clearing houses such as the Depository Trust & Clearing Corporation (DTCC) or the National Securities Clearing Corporation (NSCC).

In some examples, the transactions may be processed by entities including government entities such as the Treasury or Federal Reserve, payment processors (e.g., Visa, Mastercard, Amex, Paypal, Square, Zelle etc.), technology companies (e.g. Microsoft, IBM, Amazon, etc.) and/or a syndicate of banks (VISA, MASTERCARD, AMEX, PAYPAL, ZELLE and SQUARE are registered marks of, respectively, Visa Inc., Foster City, Calif., USA; Mastercard Incorporated, Purchase, N.Y., USA; American Express Company, New York, N.Y., USA; Paypal, Inc., San Jose, Calif.; Early Warning Services, LLC, Scottsdale, Ariz.; and Square, Inc., San Francisco, Calif.).

In some embodiments, upon completion of the transaction, the customer C2 holds in its digital wallet XDC$s in digital currency issued by the financial institution FI1, which is backed by X$s in the omnibus account OA1. The customer C2 may continue to hold XDC$ from the financial institution FI1. In some embodiments, if the customer C2 does not specify an order for handling the digital currency, an order may be established by the clearing house or their financial institution. For example, the order may be established to first spend digital currency from a financial institution different from the customer's financial institution, first spend digital currency from a lowest rated financial institution, another suitable constraint, or a combination thereof.

The customer C2 may specify an order of spending from the digital wallet. For example, the customer C2 may specify that digital currencies from other financial institutions should be spent before spending digital currency issued by the financial institution FI2, which is the customer C2's financial institution. Additionally or alternatively, the customer C2 may specify that the digital currencies be spent in reverse order depending on the financial institution's strength or another suitable metric. For example, digital currencies issued by smaller or less trustworthy financial institutions may be spent first to avoid any risk of their digital currencies not being accepted at a later date. Additionally or alternatively, the customer C2 may specify a custom order in which digital currency should be spent and/or the order in which they should be transferred out of the digital wallet of the customer C2.

Additionally or alternatively, the customer C2 may request transfer of XDC$s in digital currency issued by the financial institution FI1 into digital currency issued by the financial institution FI2, which is the customer C2's financial institution. The financial institution FI2 may transfer an equivalent amount of fiat currency into the omnibus account OA2 and issue XDC$s in digital currency issued by the financial institution FI2 to the customer C2.

Additionally or alternatively, the customer C2 may request transfer of XDC$s in digital currency issued by the financial institution FI1 into an equivalent amount of the fiat currency $s. The financial institution FI2 may transfer an equivalent amount of the fiat currency $s into the savings account SA2 of the customer C2.

In some embodiments, when the customer C2 requests transfer of XDC$s in digital currency issued by the financial institution FI1 into digital currency issued by the financial institution FI2, the financial institution FI2 may transfer an equivalent amount of fiat currency into the omnibus account OA2 and issue XDC$s in digital currency issued by the financial institution FI2 to the customer C2. In this instance, the financial institution FI2 may obtain holding rights to X$s in the omnibus account OA1 at the financial institution FI1 (which was backing the XDC$s in digital currency issued by the financial institution FI1). The financial institution FI2 may continue hold these rights until settlement with the financial institution FI1. Additionally or alternatively, the clearing house may close the transaction block such that the financial institution FI1 releases X$s from the omnibus account OA1 to bank funds for the financial institution FI2. Additionally or alternatively, the clearing house may establish a running balance between FI1 and FI2. Until a settlement is triggered by time or amount of balance, the clearing house may follow settlement rules based on timing and/or balance limits for transactions between the financial institutions.

In some embodiments, when the customer C2 requests transfer of XDC$s in digital currency issued by the financial institution FI1 into an equivalent amount of the fiat currency $s, the financial institution FI2 may transfer an equivalent amount of the fiat currency $s into the savings account SA2 of the customer C2. In this instance, the financial institution FI2 may obtain holding rights to X$s in the omnibus account OA1 at the financial institution FI1 (which was backing the XDC$s in digital currency issued by the financial institution FI1). The financial institution FI2 may continue hold these rights until settlement with the financial institution FI1. Additionally or alternatively, the clearing house may close the transaction block such that the financial institution FI1 releases X$s from the omnibus account OA1 to bank funds for the financial institution FI2. Additionally or alternatively, the clearing house may follow settlement rules based on timing and/or balance limits for transactions between the financial institutions.

In some embodiments, the financial institutions do not transfer digital currencies between each other. Instead, the financial institutions transfer fiat currency between each other to settle transactions involving their digital currencies. One financial institution may hold digital currency issued by another financial institution, e.g., when received as part of transaction, or for another suitable reason for a financial institution to receive another financial institution's digital currency. The clearing house and the financial institutions may close transaction blocks and use their respective private distributed ledgers to track balances between the financial institutions. There may be one or more rules for when a particular financial institution needs to settle with another financial institution. In some or most cases, settlement may not occur each time a customer transaction happens. The balances owed between financial institutions may go up and down based on customer transactions. However, settlement between the financial institutions may occur based on time and/or size of balance triggers. For example, the settlement may include the actual transfer of fiat currency from one financial institution to another financial institution in order to bring the balances owed to each other down to zero or another suitable threshold.

Digital Currency Check

In some embodiments, a digital currency check for a specified amount of digital currency can be issued by a first customer of a financial institution for transferring the amount of digital currency from the first customer to a second customer of the same or different financial institution. The second customer may deposit the digital currency check to their financial institution, and the financial institution may credit the second customer with the amount of digital currency specified on the digital currency check. In some examples, the financial institution of the second customer may credit the second customer by depositing the amount of digital currency into a digital wallet of the second customer. In some embodiments, the second institution may process the digital check. As part of processing the transaction, the financial institution of the first customer and/or a check processing firm of the financial institution of the first customer may be notified of the transaction. In some embodiments, the financial institution and/or their check processing firm may verify that funds are not available to complete the transaction. The financial institution of the first customer may be queried to determine whether the first customer has funds in digital currency to cover the transaction. If the first customer does not have sufficient funds in their account and/or digital wallet at their financial institution, the financial institution of the first customer may terminate or request termination of the transaction. Additionally or alternatively, the financial institution of the first customer may notify the check processing firm which may terminate or request termination of the transaction. The digital currency check could be delivered via one or more of a text message, email, QR code, barcode, and/or the like.

If the first customer has sufficient digital currency in their account (e.g., digital currency account, digital wallet, etc.) to cover the transaction, the financial institution of the first customer may transfer the digital currency from an account associated with the first customer to an omnibus account. The financial institution of the first customer may enter a transaction block, or another suitable data structure, into a private distributed ledger, as a private transaction on a public blockchain as described with respect to the embodiments discussed herein, and/or the like. The financial institution of the first customer may notify the clearing house which may enter a suitable transaction block in its private distributed ledger in order to complete the transaction.

In some embodiments, the financial institution of the second customer may require successful processing of the transaction prior to crediting the digital currency account of the second customer.

According to some embodiments, the public and private keys of a digital wallet may be used to receive or send a digital currency check issued by a customer of a financial institution. For example, both the first and second customers may have respective digital wallets. The first and second customers may have received their respective digital wallets with their accounts at their preferred financial institutions. The first customer may use the private key for the digital currency issued by a particular institution to send a digital currency check of a specified amount of digital currency from the first customer's digital wallet to the second customer's digital wallet.

In order to issue a digital currency check from his digital wallet, a user may authorize use of the private key corresponding to their digital wallet to digitally sign the check, which can be used in the transaction and storing a block for the transaction in the private distributed ledger, e.g., to deposit the associated digital currency from the digital wallet of the first customer to the digital wallet of the second customer.

Savings

According to some embodiments, the digital wallet may include a digital currency savings account. In some embodiments, the digital wallet may be linked to a digital currency savings account. For example, a user may deposit an amount of digital currency into a digital currency savings account. Over time, the digital currency savings account may accumulate additional amount of digital currency based on a savings interest rate. According to some examples, the digital currency savings interest rate may be less than an interest users pay for loaned digital currency.

In some embodiments, a financial entity may offer incentives such as digital currency and/assets in return for liquidity provided by users. For example, the user may by lock up digital assets in a certificate of deposit (CD) and/or a savings account (e.g., staking) and/or the user may lend them out to those seeking credit, as described herein. In return, the user may receive at least a part of the interest accumulated by lending digital currency and/or assets out to others.

In another example, the digital currency may be backed by fiat currency. For example, the financial institution may maintain in the omnibus account an amount of fiat currency equivalent to an amount of digital currency issued thus far by the financial institution. The omnibus account may be used to back the issued digital currency. When the user deposits digital currency into the digital currency savings account or into a CD, the financial institution may loan out the fiat backing the deposited digital currency and provide interest based on fiat accumulated from interest on the loans. Alternatively, the financial entity may convert the fiat accumulated from interest on the loans into an equivalent amount of digital currency and transfer the amount to the digital currency savings account or CD.

In some embodiments, the financial entity may set limitations on how frequently a user may withdraw digital currency from the digital currency savings account. In some embodiments the financial entity may set limitations on an amount of digital currency a user may withdraw from the digital currency savings account during a period of time. In some embodiments, the financial entity may provide options or set limitations on how long a user may not use the deposited money for a CD.

Automatic Refill

According to some embodiments, the digital wallet may be connected to a financial entity, connected to a financial account, and/or connected to another digital wallet such that the digital wallet may automatically receive funds from the connected entity, account, and/or another wallet. For example, the digital wallet may have a recurrent automatic refill setting. The setting may be time based (e.g., a time set by a user) or balance based (e.g., when a balance of the digital wallet falls under a threshold value) such that when a period of time has elapsed or when the digital wallet has a balance lesser than a threshold value, funds from the entity, account, and/or wallet may be automatically transferred to the digital wallet.

In some examples, the digital wallet may be configured to hold a currency different from the currency of the digital wallet. In some examples, the funds may be converted to a currency of the digital wallet. For example, if the digital wallet comprises a first digital currency and is linked to a second wallet having funds in a second digital currency, during the automatic transfer, the second digital currency may be converted and/or exchanged for an equivalent value of the first digital currency before being deposited into the digital wallet. In another example, if the digital wallet is linked to a financial account having funds in fiat, during the automatic transfer, the fiat may be converted and/or exchanged for an equivalent value of the digital currency of the digital wallet before being deposited into the digital wallet.

For example, the transfer may be initiated on a computing node participating in a distributed ledger and storing one or more transaction blocks representing private transactions of the digital currency of the corporation and/or corporations using the digital currency. The computing node may be configured to receive a private transaction for transferring an amount of digital currency from the first wallet, generate a new transaction block representing the private transaction, transmit the new transaction block to other computing nodes participating in the distributed ledger, receive an indication of validity of the new transaction block, and insert the new transaction block into the distributed ledger of the financial entity.

In other examples, the purchase may be initiated on a computing node participating in a public blockchain for a digital currency of the corporation and/or corporations using the digital currency. The computing node may be configured to receive a private transaction for transferring an amount of digital currency from the customer and generate a new transaction block that can only be processed by clients that hold the transaction.

Advances

According to some embodiments, the digital wallet may be configured to allow early deposits. For example, a deposit, such as from an employer, may be available prior to processing of the payment (e.g., by the ACH). In some examples, one or more entities may advance the funds. For example, the entity may be a financial institution as described herein such as a financial entity, a financial technology company, a government entity (or a government institution or a government-regulated financial institution), a payment processor company, a technology company, a cloud company, a clearing house, a syndicate of banks, an entity with a bank charter and/or any suitable entity.

Investing

According to some embodiments, a customer can invest using the digital wallet. For example, a user may connect their digital wallet or financial account comprising the digital wallet to a brokerage and/or public market. When a customer invests by purchasing stock, digital currency is transferred from the digital wallet of the customer to the digital wallet of the brokerage and/or public market.

In the transaction, the brokerage and/or public market requests an amount of digital currency from the digital wallet of the customer be transferred to the digital wallet for the brokerage and/or public market of the same, or different, financial institution. The transaction may be recorded on the private distributed ledger of the clearing house and the digital wallets may be updated. The digital currency may be transferred from the digital wallet of the customer purchasing the investment (e.g., stock) to the digital wallet of the brokerage and/or public market. The transaction may additionally be recorded on the private distributed ledger for the financial institution. In some embodiments, one or both digital wallets may send the transaction to be recorded on the private distributed ledger for the financial institution. The investment (e.g., stock, options, crypto currency, commodities, etc.) may then be updated to reflect the user's ownership.

In some aspects, the described systems and methods provide for a means of control to one or more entities, e.g., parental control, corporate control, governmental control, etc. For example, a government may administer programs such as unemployment, welfare, health programs, food stamps, etc. using the described systems and methods. In some embodiments, a recipient may use a digital currency card, a mobile application, and/or a web application configured for payment in a digital currency to receive funds allocated to them.

Government Benefits Deposits

These funds may be automatically allocated to the recipient based on information regarding one or more government programs in which the recipient may be eligible to participate. In some embodiments, the recipient may receive funds for food assistance, such as the special supplemental nutrition program for Women, Infants, and Children (WIC), related electronic benefit transfer (EBT), and/or other suitable benefits. According to some embodiments, there may be spending limitations set on the funds, such that a user may only use an amount specified by the limitation. In some examples, a spending limitation may be set on the funds such that the user may only use the funds in certain stores and/or on certain items (e.g., foods, seeds and plants, etc.). In some examples, preapproval may be required for using the funds and/or receiving the funds.

In some embodiments, the recipient may receive funds for a health savings account (HSA), a flexible spending account (FSA), and/or other suitable tax-advantaged programs. Additionally or alternatively, the recipient's health insurance payments, deductibles, appeals, and/or other health-related payment actions may be implemented using the systems and methods described herein.

In some embodiments, an entity (e.g., corporation, financial entity, bank etc.) may issue gift cards using the systems and methods described herein. The entity may be a financial institution, clearing house, payment processor, digital wallet, government, and/or the like. The recipient may receive a gift card in the form of a digital currency card, a mobile application, and/or a web application configured for payment in a digital currency issued by the entity and/or can only be spent for goods and services provided by the entity. For example, the recipient may receive a NIKE® company gift card with digital currency that is issued by that company and/or can only be spent for goods and services provided by the company. Additionally or alternatively, the recipient may receive a universal gift card with one or more digital currencies issued by certain corporations and/or can only be spent for goods and services provided by specified corporations. According to some embodiments, the type of good or service may be limited (e.g., clothing).

In some examples, the digital currency card may be a physical digital currency card and, in some examples, the digital currency card may be an eGift card. In some examples, the digital currency card may be included in the digital wallet. The gift card may include a unique identifier (e.g., barcode, QR code, etc.) configured to identify a balance of digital currency on the gift card. For example, a customer of a corporation having a gift card may purchase a good and/or service using the card and/or the unique identifier. The corporation may then update the balance of the gift card to represent the remaining balance of digital currency after the purchase. In some examples, the unique identifier of the card may associate the card to a digital currency account, and a balance of the digital currency account may be updated as described.

In some examples, a customer of a corporation may credit the digital currency of the gift card to their digital currency account with the corporation and/or a partnering organization. During purchase of a good and/or service, the corporation may transfer out from the digital currency account the amount of digital currency for the purchased good and/or service. The corporation may additionally record the transaction using a private distributed ledger, wherein the corporation may have access to the private distributed ledger. In some examples, the transaction may be recorded on a public blockchain as a private transaction such that only the corporation may access the transaction.

For example, the purchase may be initiated on a computing node participating in a distributed ledger and storing one or more transaction blocks representing private transactions of the digital currency of the corporation and/or corporations using the digital currency. The computing node may be configured to receive a private transaction for transferring an amount of digital currency from the customer, generate a new transaction block representing the private transaction, transmit the new transaction block to other computing nodes participating in the distributed ledger, receive an indication of validity of the new transaction block, and insert the new transaction block into the distributed ledger.

In other examples, the purchase may be initiated on a computing node participating in a public blockchain for a digital currency of the corporation and/or corporations using the digital currency. The computing node may be configured to receive a private transaction fir transferring an amount of digital currency from the customer and generate a new transaction block that can only be processed by clients that hold the transaction.

Allowance

According to some embodiments, the digital wallet may be connected to a third party other than the user (e.g., a parent or guardian of the user, a spouse of the user, etc.) where the third party, such as a monitoring user, may be configured to control some aspects and access certain information regarding the digital wallet. For example, a third entity may receive notifications and/or access information regarding a balance of the digital wallet. In some examples, a third entity may place restrictions on the digital wallet. For example, a third entity may set a threshold of an amount of currency of the digital wallet that can be spent.

According to some embodiments, the digital wallet may be connected to a financial entity, connected to a financial account, and/or connected to another digital wallet of the third party, and the third party may transfer funds based on set parameters of the digital wallet. For example, if the digital wallet has a balance lower than a threshold set by the third party, the financial account and/or digital wallet of the user may automatically transfer a predetermined amount of funds as described herein.

Automated Savings and Investing

According to some embodiments, the digital wallet may be configured to allow automatic payments using currency from the digital wallet. In some examples, a user of the digital wallet may automate savings or investments. For example, the user may automate savings or investments of a designated percentage or a designated amount of the currency of the digital wallet to a savings or investment account of the user. In some examples, a user of the digital wallet may automate forced withdrawals such as taxes, alimony, child support, mortgage, rent, utilities, bills and/or the like. The designated amount may be automatically withdrawn from the digital wallet.

In some embodiments, when a user makes a purchase with the digital wallet and/or digital currency card, the transaction may be rounded to the nearest dollar and the change may be automatically transferred into an investment account of the user (e.g., Round Ups).

Reloadable Accounts

According to some embodiments, the digital wallet may be refilled by loading an amount of currency onto the digital wallet and/or a digital currency card. In some embodiments, the digital wallet and/or digital currency card may act as a prepaid digital wallet and/or digital currency card. In some embodiments, the wallet and/or card may not be linked or connected to another financial account.

In some embodiments, a corporation may track expenses using the systems and methods described herein. For example, tracked expenses may include travel, dining, etc. and authorization may be tracked or pre-approved for certain categories, vendors, amounts, etc.

In some embodiments, an individual such as a parent may use the systems and methods described herein to track and/or control spending of their child, themselves (e.g., for budgeting purposes), or another suitable person. The individual may provide their child with a digital currency card, a mobile application, and/or a web application configured for payment in a digital currency. The individual may specify certain vendors (e.g., movie theaters, restaurants, stores, etc.), categories (e.g., food, clothing, etc.), and/or other suitable criteria. The individual may exclude or limit spending on specific products and/or vendors. For example, the individual may limit the child's spending at STARBUCKS® to a suitable amount, e.g., $25 per month or another suitable amount and/or period.

For example, an individual may specify at a store, and/or on a mobile or web application suitable criteria. In some examples, when the child attempts a transaction that does meet the specified criteria, the digital currency card, mobile and/or web application provided to the child may transfer the digital currency from the digital currency card, mobile and/or web application to the vendor.

In some examples, the transaction may be recorded using a private distributed ledger. For example, the transaction may be initiated on a computing node participating in a distributed ledger and storing one or more transaction blocks representing private transactions of the digital currency of the corporation and/or corporations using the digital currency. The computing node may be configured to receive a private transaction for transferring an amount of digital currency from the customer, generate a new transaction block representing the private transaction, transmit the new transaction block to other computing nodes participating in the distributed ledger, receive an indication of validity of the new transaction block, and insert the new transaction block into the distributed ledger.

In some examples, the transaction may be recorded on a public blockchain as a private or public transaction. For example, the purchase may be initiated on a computing node participating in a public blockchain for a digital currency of the corporation and/or corporations using the digital currency. The computing node may be configured to receive a private transaction for transferring an amount of digital currency from the customer and generate a new transaction block that can only be processed by clients that hold the transaction.

According to some embodiments, a child may attempt a transaction that does not meet the specified criteria. The digital currency card, mobile and/or web application provided to the child may determine that the transaction does not meet the criteria and reject the transaction. The child and/or individual may be notified of the rejected transaction. For example, the digital currency card, mobile and/or web application may prevent the transaction from being recorded on a blockchain. In some examples, the computing node may prevent generation of a new transaction block if the transaction is determined to fail to meet the specified criteria.

View

According to some embodiments, the mobile and/or web application may be configured to show the user information regarding one or more transactions. For example, using the mobile and/or web application, the user may access one or more monthly statements and transaction information. In some examples, the transaction information can be filtered based on a time period, by category, by payee and/or payor, by credits, by debits, and/or by benefits received. For example, benefits may include interest accrued, miles, and/or points.

Coupons

According to some embodiments, the customer may receive coupons, credit card benefits such as cash back, and/or promotional codes after a purchase (e.g., as a result of the purchase), or before a purchase. These coupons may be applied to a purchase before the purchase. In some examples, before a purchase, a customer may use a coupon aggregator (e.g., Rakuten, Honey, etc.) (RAKUTEN and HONEY are registered marks of, respectively Rakuten Group, Inc., San Mateo, Calif.; and Paypal, Inc., San Jose, Calif.). The customer may receive such coupons or promotional codes through email, based on the customers location (e.g., geolocation), by searching online, through a coupon aggregator, and/or the like. The customer may accept the coupon and/or code to be stored in their digital wallet for a next purchase related to the coupon and/or code. When the customer makes a related purchase, the coupon and/or code may be automatically applied to the purchase. Coupons and/or codes may also be viewed.

According to some embodiments, the customer may receive digital currency and/or cash back after a purchase. In some examples, the user may scan or upload a receipt of a purchase to the digital wallet, application of a financial institution and/or third-party application linked to the digital wallet and receive cash back and/or digital currency on eligible purchases. In some examples, the user may make an eligible purchase through the digital wallet, third party application, and/or an application of a financial institution. The eligible purchase may be a purchase from a participating store. For example, the user may receive commission or part of a commission from a store for purchasing from the store.

Displaying Balance

According to some embodiments, the mobile and/or web application may display a balance of the digital wallet. In examples where the digital wallet may comprise more than one type of digital currency or fiat, the mobile and/or web application may display the balance of each type of digital currency and each type of fiat in the digital wallet. In examples where the digital wallet comprises financial assets and/or instruments, the mobile and/or web application may display the assets and/or instruments.

Identification

According to some embodiments, the digital wallet may be used as a form of personal identification and/or may contain personal identification.

In some embodiments, the pair of public and private keys can be used to identify a user at a financial entity. The financial entity may use the private and public keys of the user to perform challenge response authentication. For example, the financial entity may query the user for a public key to initially identify the user. The financial entity may then transmit a value (e.g., a hash output) with an encrypted message, encrypted with the public key of the user. The user may use the value and the private key of the user to decrypt the message and transmit the decrypted message to the financial entity. The financial entity may verify and identify the user by comparing the decrypted message of the user and the message sent from the financial entity.

In some examples, the digital wallet may store unique values identifying the user. For example, in response to a challenge, the digital wallet may transmit one or more of the unique values. The financial entity may compare the unique values to stored values associated with the user to authenticate the user at the financial entity. According to some embodiments, the unique value may be a government issued value used in identification (e.g., used to identify a user for travel, etc.). The identification value may be linked to information about the user (e.g., stored in a secure database accessible to a group of users). For example, the government issued value may be used as part of a driver's license and others (e.g., law enforcement) may use the government issued value to identify information such as height, weight, photo, and/or the like of the owner of the digital wallet. According to some embodiments, the unique value may identify a user at a health care entity, such as at a hospital, and/or for insurance (e.g., Medicare, Medicaid, driver's insurance, private insurance, etc.).

Transference of Benefits

As described herein, a financial institution may also provide benefits such as some amount of digital currency issued by the financial institution, interest accrued, miles, and/or points. If the benefit is of digital currency or fiat, the user can credit their digital wallet with the equivalent amount of digital currency or fiat. If the benefit includes points, the user can credit their digital wallet with an amount of digital currency and/or fiat determined to be equivalent to the number of points earned (e.g., the determination may be based on a predetermined conversion rate between points and digital currency or points and fiat). In some examples, benefits may be transferred from one digital wallet to another using methods and techniques described herein.

Credit

In some embodiments, the financial institution (e.g., bank) provides credit (e.g., of digital currency). In some examples, the credit may be provided through a digital wallet (e.g., a line of credit), through a credit card, or through an application (e.g., Zelle) (ZELLE is a registered mark of Early Warning Services, LLC, Scottsdale, Ariz.) or through the bank or another entity through an account of the user. For example, this can be used in advancing funding of digital currency. For example, this may be used to advance funds sent to other digital wallets, for store cards, for medical purposes (e.g. CareCredit), and/or loans (e.g., Mortgage, Cars, Personal, Cap Ex, Inventory, Invoice, Equipment, Merchant “cash advance”, SBA). The institution's customer (e.g., corporation, individual, etc.) may use their credit account (e.g., of their digital wallet) to pay for an item at a merchant (e.g., store) using a bank's digital currency, such that the customer is borrowing money from the issuing financial institution. There may be a limit to the credit amount (e.g., credit limit), for example, the customer may only be able to borrow a set amount of digital currency or fiat. The amount the customer has to borrow may be an available credit of the digital wallet and exceeding this limit may result in a fee.

According to some embodiments, a user may make a purchase using a buy now pay later (BNPL) option (e.g., Affirm). For example, the institution's customer (e.g., corporation, individual, etc.) may make a purchase by using their credit account to pay for an item or service at a merchant (e.g., store) using a bank's digital currency, such that the customer is borrowing an amount of money equivalent to the value of the full purchase from the issuing financial institution. The customer may pay the purchase over one or more installments. For example, each of the installments may be of a value a fraction of the value of the purchase. In some examples, the installments may be automatically withdrawn from the customer's account after a period of time has passed (e.g., such that installments are paid monthly).

For example, the transaction is recorded in the private distributed ledger and the issuing financial institution may transmit payment to the merchant's (e.g., store's) account at the other bank. In some examples, the private distributed ledger stores one or more transaction blocks representing issued credit in the digital currency that is issued by the financial institution for transferring to the customer. A computing node receives a transaction for transferring an amount of digital currency from the financial institution to the merchant of another financial institution. The computing node generates a new transaction block representing the transaction for addition to the private distributed ledger. The computing node transmits the new transaction block to the one or more computing nodes participating in the private distributed ledger. The computing node receives an indication of validity of the new transaction block. If the indication is valid, the computing node inserts the new transaction block into the private distributed ledger to complete transferal of the amount of digital currency.

In some examples, the financial institution may use the recorded transaction to maintain a record of digital currency owed by the customer. In some examples, the financial institution may initiate or record a new transaction from the customer to the issuing financial institution to indicate the amount owed. The customer can pay the issuing financial institution by transferring an equivalent amount of fiat or digital currency to the institution using techniques described herein. In some examples, the customer may also owe additional fees such as interest accrued over time, late fees, etc.

According to some embodiments, the financial institution may transfer digital assets and/or fiat of the financial institution into an omnibus account and may issue digital currency. The digital currency may subsequently be credited to the user who is borrowing money from the issuing financial institution.

For example, a financial institution's customer (e.g., corporation, individual, etc.) may make a purchase by using their credit account of their digital wallet to pay for an item or service at a merchant (e.g., store) and/or enterprise (e.g., supplier, manufacturer, etc.) using a bank's digital currency, such that the customer is borrowing an amount of money equivalent to the value of the full purchase from the issuing financial institution. The financial institution may transfer fiat of the financial institution of an amount equivalent to amount of digital currency credited (e.g., price of the good or service). The financial institution may then issue into the customer's account (e.g., digital wallet) the digital currency of the amount that is borrowed. Subsequently, when a user pays the financial institution for any portion of the borrowed amount, the financial institution may transfer an equivalent amount of fiat out of the omnibus account.

Building Up Credit

In some embodiments, the systems and methods described herein are used to setup one or more programs to assist consumers with improving their credit scores. The consumer may be provided a digital currency card, a mobile application, and/or a web application configured for payment in a digital currency. The consumer's financial activity may be used to consider an increase in their credit score, e.g., on-time payments, rent payments, utility payments, etc.

In some embodiments, the systems and methods described herein are used to setup one or more programs to assist consumers with charitable giving. The consumer may send digital currency to make charitable donations. The program may track taxable deductions for the consumer accordingly. For example, the program may coordinate with company match programs to enable matching the consumer's donation with a corresponding match to maximize charitable giving.

In some embodiments, the systems and methods described herein track not just the owner of the digital currency but also each user, including the digital currency received/converted, where it originated from (e.g., credits), the digital currency spent/sent/exchanged, and/or what the user did with the digital currency (e.g., debits). The system may provide reporting, real time access, monthly statements, tax statements, earnings/returns, and/or other suitable information to the user or another party with permissions to access such information. This user information and other suitable information described herein may be sorted and monetized as appropriate, e.g., under the laws of the jurisdiction where the information is being collected or sold or other suitable criteria. For example, the systems and methods described herein may setup a unique ability of a clearing house, a financial institution, or another suitable entity, to track spending of customers using digital currency of multiple financial institutions so customers can get a statement or access reporting or other suitable information.

In some embodiments, the systems and methods described herein track loans and payments for lending institutions and/or borrowers. In some embodiments, the loans or other embodiments described herein are implemented using smart contracts where a self-executing contract with the terms of the agreement between buyer and seller, lender and borrower, etc., is directly written into lines of code. The code and the agreements contained therein may exist across the distributed ledger(s) discussed herein.

In some embodiments, some of the benefits that the described systems and methods provide may be described as follows, but the benefits are not so limited and other or different benefits may be achieved by use of the described systems and methods.

With respect to government, in the United States, the Federal Reserve has a committee evaluating methods to digitize the US Dollar. The Federal Reserve believes it to be critical for the US Dollar to continue to be viewed as a primary reserve currency and, by using digital currency, the Federal Reserve may achieve significant savings involved in not printing and destroying cash. By having banks issue the digital currency, the Federal Reserve may have full regulatory authority without the expense of developing and maintaining the system. The Federal Reserve can issue current regulations and new specific regulations for digital currency on financial institutions. Further, a transparent (e.g., the user is known) distributed ledger may dramatically restrict the ability to use the funds for illegal purposes. This may also empower government to impose restrictions on unregulated cryptocurrency.

With respect to financial institutions such as banks, they may not need for cash to move every time a transaction takes place and settlement costs may be significantly reduced. The described system may provide for sticky cash with consumers and attract new customers (such as Gen Z and millennials). This may also limit Herstatt risk and reduce risk of future competition from above and below. For example, stablecoin companies may no longer have the power of selecting one financial institution. Further, government may not need to issue digital currency as the financial institutions would be handling that aspect.

With respect to consumers, the described system provides security, insurance, acceptance at businesses, speed to receive and pay, and/or ability to control choice of which bank's digital currency or whether to choose fiat currency instead. For example, security may be improved by limiting identity theft as digital currency works on a “push” system while conventional credit works on a “pull” system. In another example, the consumer's digital currency deposits may be insured as the digital currency may be backed by FDIC insurance via the funds held in the omnibus accounts at the financial institutions.

With respect to enterprise, the described systems and methods may provide for lower costs for payments compared to wires or credit or debit, eliminate wire transfers to help with speed of closing and associated costs, and/or limit fraud as digital currency may not be counterfeited or reversed arbitrarily (e.g., credit charge backs).

With respect to the clearing house, the described systems and methods may provide for charging banks and enterprises for establishing transaction rules, creating a tiered ranking system of financial institutions for digital currency, keeping a ledger of issuance and transfer of digital currency and back to fiat currency, and/or facilitating settlement calls between financial institutions.

In some embodiments, the financial institution may be responsible for holding cryptocurrency, such as Bitcoin or another suitable cryptocurrency, so that the financial institution is responsible for the security of the cryptocurrency. The financial institution may issue digital currency that is backed by that cryptocurrency. This may safeguard consumer deposits against situations where cryptocurrency exchanges may misplace funds, or the funds may be stolen by bad actors.

Custodians of Digital Currency

In some embodiments, for example, when the digital currency is government issued, the government entity that issued the digital currency may be responsible for holding cryptocurrency or fiat, so that the government entity is responsible for the security of the cryptocurrency or fiat. The government issued digital currency may be backed by fiat or cryptocurrency to safeguard consumer deposits against situations where cryptocurrency exchanges may misplace funds, or the funds may be stolen by bad actors. As described herein, the government entity may include the US Mint, the Bureau of Engraving & Printing, the Financial Crimes Enforcement Network, the Internal Revenue Service, the Office of the Comptroller of Currency, the Community Development Financial Institution and/or the like.

In some embodiments, a corporation may work with a financial institution that may be responsible for holding cryptocurrency, such as Bitcoin or another suitable cryptocurrency, so that the financial institution is responsible for the security of the cryptocurrency. The corporation may issue digital currency that is backed by that cryptocurrency. This may safeguard consumer deposits against situations where cryptocurrency exchanges may misplace funds, or the funds may be stolen by bad actors.

In other examples, the digital currency may not be held responsible by any financial institution (e.g. a government entity, bank, etc.), but may instead be held solely in the digital wallet. For example, the digital currency may be stored in a self-hosted and/or unhosted wallet that is not provided by a financial institution or service. For example, the digital currency may be stored in a self-hosted/unhosted wallet residing on a computer of the customer or offline. According to some embodiments, the digital wallet may be hosted by an entity such as a financial entity, a financial technology company, a government entity (or a government institution or a government-regulated financial institution), a payment processor company, a technology company, a cloud company, a clearing house, a syndicate of banks, an entity with a bank charter and/or any suitable entity.

Non-Limiting Aspects of Described Embodiments

Various aspects are described in this disclosure, which include, but are not limited to, the following aspects:

(1) A system for facilitating a private transaction between a first entity and a second entity using a digital currency, comprising:

a computing node, wherein the computing node is included in a plurality of computing nodes participating in a distributed ledger, wherein the distributed ledger stores one or more transaction blocks representing private transactions in a digital currency that is issued by the financial institution and is fixed with respect to a fiat currency, wherein each computing node in the plurality of computing nodes stores and maintains a respective copy of the distributed ledger, and wherein the computing node is configured to:
store and maintain a copy of the distributed ledger;
receive a private transaction for transferring an amount of the digital currency from the first entity to the second entity,
   wherein the first entity and the second entity relate to the financial institution,
   wherein at least the first entity is associated with one or more public and/or private keys, and
   wherein, based on authorization from the first entity, at least a portion of the private transaction involving the digital currency is generated using a key of the one or more public and/or private keys for the first entity;
generate a new transaction block representing the private transaction in the digital currency for addition to the distributed ledger;
transmit the new transaction block to the plurality of computing nodes participating in the distributed ledger;
receive, from at least one of the plurality of computing nodes, an indication of validity of the new transaction block,
   wherein the indication of validity comprises an indication of validity generated using a key of the one or more public and/or private keys for the first entity included in the private transaction involving the digital currency; and
based on the indication of validity, insert the new transaction block into the copy of the distributed ledger to complete the private transaction for transferring the amount of the digital currency from the first entity to the second entity.

### Issuing Digital Currency

(2) The system of (1), wherein the financial institution is a government institution and the digital currency is government issued digital currency.
(3) The system of (1), wherein the computing node is further configured to exchange an amount of digital currency issued by the financial institution with an amount of government issued digital currency.
(4) The system of (1), wherein the computing node is further configured to exchange an amount of fiat currency with an amount of government issued digital currency.
(5) The system of (1), wherein the computing node is further configured to exchange an amount of second government issued digital currency with the amount of the government issued digital currency.
(6) The system of (1), wherein the computing node is further configured to exchange an amount of second government issued digital currency with an amount of fiat currency.
(7) The system of (1), wherein the computing node is further configured to exchange an amount of second government issued digital currency with an amount of digital currency issued by the financial institution.

### Ledger Access

(8) The system of (1), wherein one or more transactions of the distributed ledger are configured to be accessed by a third entity.
(9) The system of (8), wherein the third entity is a government entity.
(10) The system of (8), wherein the third entity is a bank.
(11) The system of (8), wherein the third entity is a cloud provider and wherein the cloud provider is configured to store the one or more transactions of the distributed ledger.

### Issuing Digital Currency

(12) The system of (1), wherein the digital currency is issued by a bank.
(13) The system of (1), wherein the digital currency is issued by an entity having a bank charter.

### Payments Using Blockchain Applications

(14) The system of (1), wherein a reserve of the financial institution comprises an at least an amount of fiat currency equivalent to the amount of digital currency of the first entity and the second entity.
(15) The system of (8), wherein the third entity is a partner company.

### Fiat Reserves

(16) The system of (14), wherein the financial institution is a private bank.
(17) The system of (14), wherein the financial institution is a government entity.

### Digital Currency Check

(18) The system of (1), wherein the private transaction is represented by a digital check.

### On-Chain Payments

(19) The system of (1), wherein the transaction is an on-chain transaction.
(20) The system of (1), wherein:

the new transaction block is generated at the financial institution and transmitted to a clearing house for insertion into a distributed ledger for the clearing house, or

the new transaction block is generated at the clearing house and transmitted to the financial institution for insertion into the distributed ledger.

### Simultaneous Exchange

(21) The system of (20), wherein the transaction is simultaneously inserted into the distributed ledger for the financial institution and the distributed ledger for the clearing house.

### Processing Transactions

(22) The system of (1), wherein:
the new transaction block is generated at the financial institution and transmitted to a fifth entity for insertion into a distributed ledger for the fifth entity, or

the new transaction block is generated at the fifth and transmitted to the financial institution for insertion into the distributed ledger.

(23) The system of (22), wherein the fifth entity is a government entity.
(24) The system of (22), wherein the fifth entity is a payment processor company.
(25) The system of (22), wherein the fifth entity is a technology company.
(26) The system of (22), wherein the fifth entity is a cloud company.
(27) The system of (22), wherein the fifth entity is a syndicate of banks.
(28) The system of (1), wherein the indication of validity further comprises an indication of the first entity having a sufficient amount of digital currency required to complete the private transaction, wherein the computing node is further configured to:

receive, from the one or more computing nodes, an indication of invalidity of the new transaction block; and

based on the indication of invalidity comprising an indication of the first entity not having a sufficient amount of digital currency required to complete the private transaction:
determine that the first entity has access to an available amount of fiat currency equivalent to the sufficient amount of digital currency;
exchange the available amount of fiat currency into the sufficient amount of digital currency required to complete the private transaction and transfer the available amount of the fiat currency to an omnibus account at the financial institution;
retransmit the new transaction block to the one or more computing nodes participating in the distributed ledger;
receive, from at least one of the plurality of computing nodes, the indication of validity of the new transaction block; and
based on the indication of validity, insert the new transaction block into the copy of the distributed ledger to complete the private transaction for transferring the amount of the digital currency from the first entity to the second entity.
   (29) The system of (28), wherein the exchange of the available amount of fiat currency into the sufficient amount of digital currency is authorized by the first entity at a time prior to the private transaction, authorized by the first entity at a time of or subsequent to the private transaction, or denied by the first entity at a time of the private transaction.

### Validation

(30) The system of (29), wherein the exchange of the available amount of fiat currency into the sufficient amount of digital currency is further authorized by one or more other entities.
(31) The system of (1), wherein the second entity receives the amount of digital currency issued by the financial institution, an amount of digital currency that is issued by another financial institution, or an amount of fiat currency equivalent to the amount of digital currency when the transaction is complete.
(32) The system of (31), wherein the second entity receives the amount of digital currency issued by the financial institution in a digital wallet.

### Custodians of Digital Currency

(33) The system of (32), wherein the digital wallet is a self-hosted digital wallet.
(34) The system of (1), wherein a government entity is the custodian of the digital currency.
(35) The system of (32), wherein the digital wallet includes one or more rules to spend the digital currency issued by the financial institution before or after spending digital currency issued by another financial institution.
(36) The system of (35), wherein the one or more rules include a rule to automatically convert digital currency issued by a non-approved financial institution into fiat currency.
(37) The system of (1), wherein the private transaction represents a split payment from a transaction involving the first entity and at least one other entity providing payment to the second entity.
(38) The system of (1), wherein the first entity is a gift giver, the second entity is a goods or services provider, wherein the private transaction between the gift giver and the goods or services provider is for a gift card, issued by the goods or services provider, to be given to a third entity.
(39) The system of (38), wherein the third entity is a gift recipient, and wherein the third entity receives the gift card in a digital wallet for the gift recipient.
(40) An institution for facilitating digital currency transactions, the institution comprising:

a computing node, wherein the computing node is included in a plurality of computing nodes participating in a distributed ledger, wherein the distributed ledger stores one or more transaction blocks representing private transactions in one or more digital currencies, wherein each computing node in the plurality of computing nodes stores and maintains a respective copy of the distributed ledger, and wherein the computing node is configured to:
store and maintain a copy of the distributed ledger;
receive a private transaction for transferring an amount of digital currency from a first entity related to a first financial institution to a second entity related to a second financial institution,
   wherein the digital currency is issued by the first financial institution and is fixed with respect to a fiat currency,
   wherein at least the first entity is associated with one or more public and/or private keys, and
   wherein, based on authorization from the first entity, at least a portion of the private transaction involving the digital currency is generated using a key of the one or more public and/or private keys for the first entity, and
   wherein information regarding the transaction is sent to and/or received from the clearing house, the first financial institution and/or the second financial institution to be recorded on the distributed ledger, a distributed ledger for the first financial institution and/or a distributed ledger for the second financial institution; and
based on receiving, from at least one of the plurality of computing nodes, an indication of validity generated using a key of the one or more public and/or private keys for the first entity included in the private transaction involving the digital currency, store a new transaction block in the distributed ledger representing the private transaction for transferring the amount of the digital currency from the first entity at the first financial institution to the second entity at the second financial institution.
   (41) A method for facilitating a private transaction between a first entity and a second entity using a digital currency issued by a financial institution and fixed with respect to a fiat currency, the method being implemented on a computing node included in a plurality of computing nodes participating in a distributed ledger, each computing node in the plurality of computing nodes storing and maintaining a respective copy of the distributed ledger, the method comprising acts of:
storing and maintaining a copy of the distributed ledger,
   wherein the distributed ledger stores one or more transaction blocks representing private transactions in the digital currency that is issued by the financial institution and is fixed with respect to the fiat currency;
receiving a private transaction for transferring an amount of the digital currency from the first entity to the second entity,
   wherein at least the first entity is associated with one or more public and/or private keys, and
   wherein, based on authorization from the first entity, at least a portion of the private transaction involving the digital currency is generated using a key of the one or more public and/or private keys for the first entity;
generating a new transaction block representing the private transaction in the digital currency for addition to the distributed ledger;
transmitting the new transaction block to the plurality of computing nodes participating in the distributed ledger;
receiving, from at least one of the plurality of computing nodes, an indication of validity of the new transaction block, wherein the indication of validity comprises an indication of validity of generated using a key of the one or more public and/or private keys for the first entity; and
based on the indication of validity, inserting the new transaction block into the copy of the distributed ledger to complete the transaction for transferring the amount of the digital currency from the first entity to the second entity.
   (42) The method of (41), wherein:

the new transaction block is generated at the financial institution and transmitted to a clearing house for insertion into a distributed ledger for the institution, or

the new transaction block is generated at the institution and transmitted to the financial institution for insertion into the distributed ledger.

(43) The method of (41), wherein the indication of validity further comprises an indication of the first entity having a sufficient amount of digital currency required to complete the private transaction, the method further comprising:

receiving, from the one or more computing nodes, an indication of invalidity of the new transaction block; and

based on the indication of invalidity comprising an indication of the first entity not having a sufficient amount of digital currency required to complete the private transaction:
determining that the first entity has access to an available amount of fiat currency equivalent to the sufficient amount of digital currency;
exchanging the available amount of fiat currency into the sufficient amount of digital currency required to complete the private transaction and transferring the available amount of the fiat currency to an omnibus account at the financial institution;
retransmitting the new transaction block to the one or more computing nodes participating in the distributed ledger;
receiving, from at least one of the plurality of computing nodes, the indication of validity of the new transaction block; and
based on the indication of validity, inserting the new transaction block into the copy of the distributed ledger to complete the private transaction for transferring the amount of the digital currency from the first entity to the second entity.
   (44) The method of (43), wherein the exchange of the available amount of fiat currency into the sufficient amount of digital currency is authorized by the first entity at a time prior to the private transaction, authorized by the first entity at a time of or subsequent to the private transaction, or denied by the first entity at a time of the private transaction.
   (45) The method of (41), wherein the second entity receives the amount of digital currency issued by the financial institution, an amount of digital currency that is issued by another financial institution, or an amount of fiat currency equivalent to the amount of digital currency when the transaction is complete.
   (46) The method of (45), wherein the second entity receives the amount of digital currency issued by the financial institution in a digital wallet.
   (47) The method of (46), wherein the digital wallet includes one or more rules to spend the digital currency issued by the financial institution before or after spending digital currency issued by another financial institution.
   (48) The method of (47), wherein the one or more rules include a rule to automatically convert digital currency issued by a non-approved financial institution into fiat currency.
   (49) The method of (41), wherein the private transaction represents a split payment from a transaction involving the first entity and at least one other entity providing payment to the second entity.
   (50) A method for a clearing house to facilitate digital currency transactions between a first entity related to a first financial institution and a second entity related to a second financial institution, the method being implemented on a computing node included in a plurality of computing nodes participating in a distributed ledger, each computing node in the plurality of computing nodes storing and maintaining a respective copy of the distributed ledger, the method comprising acts of:

storing and maintaining a copy of the distributed ledger,
wherein the distributed ledger stores one or more transaction blocks representing private transactions in one or more digital currencies;
receiving a private transaction for transferring an amount of digital currency from a first entity related to a first financial institution to a second entity related to a second financial institution,
wherein the digital currency is issued by the first financial institution and is fixed with respect to a fiat currency,
wherein at least the first entity is associated with one or more public and/or private keys, and
wherein, based on authorization from the first entity, at least a portion of the private transaction involving the digital currency is generated using a key of the one or more public and/or private keys for the first entity, and
wherein information regarding the transaction is sent to and/or received from the clearing house, the first financial institution and/or the second financial institution to be recorded on the distributed ledger, a distributed ledger for the first financial institution and/or a distributed ledger for the second financial institution; and
based on receiving, from at least one of the plurality of computing nodes, an indication of validity generated using a key of the one or more public and/or private keys for the first entity included in the private transaction involving the digital currency, storing a new transaction block in in the distributed ledger representing the private transaction for transferring the amount of the digital currency from the first entity at the first financial institution to the second entity at the second financial institution.

Digital Wallet

(51) A digital wallet for one or more digital currencies from one or more financial institutions, comprising:
one or more pairs of public and private keys for a user holding one or more digital currencies from one or more of financial institutions, including a digital currency issued by a financial institution and that is fixed with respect to a fiat currency,
wherein a pair of public and private keys is used by the user to receive and/or send the digital currency issued by the financial institution corresponding to the pair of public and private keys and to record a transaction in the digital currency in a private distributed ledger for the financial institution.

### Coupons

(52) The digital wallet of (51), wherein the digital wallet is configured to provide the user with coupons and/or promotional codes.

### View

(53) The digital wallet of (51), wherein the digital wallet is configured to provide transaction information for the one or more digital currencies including a monthly statement of transactions.
(54) The digital wallet of (51), wherein the digital wallet is configured to provide transaction information for the one or more digital currencies and wherein the transaction information is filtered based on one or more parameters.
(55) The digital wallet of (54), wherein the one or more parameters include a period of time, credits, debits, benefits received, and/or category.

### Automatic Refill

(56) The digital wallet of (51), wherein the pair of public and private keys is used by the user to receive digital currency automatically in response to an indication a balance for the one or more digital currencies is less than a threshold amount.
(57) The digital wallet of (51), wherein the pair of public and private keys is used by the user to receive digital currency automatically after a predetermined amount of time has elapsed.

### Transference of Benefits

(58) The digital wallet of (51), wherein the digital wallet provides the user with consumer rewards, loyalty points, geo-location rewards, and/or interest for using the digital wallet.
(59) The digital wallet of (58), wherein the provided consumer rewards, loyalty points, geo-location rewards, and/or interest is transferred from the digital wallet of the user to a digital wallet of another user.
(60) The digital wallet of (58), wherein the user uses one or more of the provided consumer rewards, loyalty points, geo-location rewards, and/or interest and receives an amount of digital currency equivalent in value to the one or more provided consumer rewards, loyalty points, geo-location rewards, and/or interest.

### Automated Savings and Investing

(61) The digital wallet of (51), wherein the pair of public and private keys is used to automatically send digital currency to a savings account of the user.
(62) The digital wallet of (51), wherein the pair of public and private keys is used to automatically send digital currency to a digital wallet of another user.

### Government Deposit Benefits

(63) The digital wallet of (51), wherein the pair of public and private keys is used by the user to automatically receive digital currency from a government entity, wherein the digital currency is a government benefit.

### Allowance

(64) The digital wallet of (51), wherein the digital wallet is configured to allow a monitoring user to change one or more controls corresponding to the digital wallet.
(65) The digital wallet of (51), wherein the digital wallet is configured to allow a monitoring user to access information corresponding to the digital wallet.
(66) The digital wallet of (65), wherein the information comprises a balance of the digital wallet and/or transaction history of the digital wallet.
(67) The digital wallet of (66), wherein the one or more controls comprises notification settings, refill frequency, and/or a digital currency limit.

### Reloadable Accounts

(68) The digital wallet of (51), wherein the digital wallet is not linked to another financial account, and wherein only digital currency received by the user can be used to send.

### Advance Paychecks

(69) The digital wallet of (51), wherein the pair of public and private keys is used by the user to receive digital currency using early deposit.

### Ability to Build Credit

(70) The digital wallet of (51), wherein receiving and/or sending the digital currency is used to determine a credit score of the user.

### Investing

(71) The digital wallet of (51), wherein the digital wallet is connected to a brokerage and/or public market, and wherein the pair of public and private keys is used by the user to send digital currency in exchange for an investment asset.

### Credit

(72) The digital wallet of (51), wherein the private distributed ledger is used to manage a line of credit for the user.

### Issuing Digital Currency (Government)

(73) A system for facilitating a private transaction between a first entity and a second entity using a government issued digital currency issued by a government institution, comprising:

a computing node, wherein the computing node is included in a plurality of computing nodes participating in a distributed ledger, wherein the distributed ledger stores transaction information representing transactions in a government issued digital currency that is issued by a government institution and is fixed with respect to a fiat currency, wherein at least one computing node in the plurality of computing nodes stores and maintains a respective copy of the distributed ledger, and wherein the computing node is configured to:
receive a transaction for transferring an amount of the government issued digital currency from the first entity to the second entity;
determine that the transaction is authorized by the first entity based on a digital signature or identifier for the first entity;
generate new transaction information representing the transaction in the government issued digital currency for addition to the distributed ledger;
transmit the new transaction information to at least one of the plurality of computing nodes participating in the distributed ledger;
receive, from the at least one of the plurality of computing nodes, an indication of validity of the new transaction information; and
based on the indication of validity, insert the new transaction information into the distributed ledger to complete the transaction for transferring the amount of the government issued digital currency from the first entity to the second entity.
   (74) The system of (73), wherein the first entity is the government institution and wherein the second entity is a financial entity, and wherein the financial entity issues a digital currency based on the government issued digital currency.

### Ledger Access

(75) The system of (73), wherein one or more transactions of the distributed ledger are configured to be accessed by a third entity.
(76) The system of (75), wherein the third entity is a government entity.
(77) The system of (75), wherein the third entity is a bank.
(78) The system of (75), wherein the third entity is a cloud provider and wherein the cloud provider is configured to store the one or more transactions of the distributed ledger.
(79) The system of (75), wherein the third entity is a clearing house.
(80) The system of (73), wherein:

the new transaction information is generated at the government institution and transmitted to an other entity for insertion into a distributed ledger for the other entity, or

the new transaction information is generated at the other entity and transmitted to the government institution for insertion into the distributed ledger.

(81) The system of (80), wherein the other entity is a government entity.
(82) The system of (80), wherein the other entity is a payment processor company.
(83) The system of (80), wherein the other entity is a technology company.
(84) The system of (80), wherein the other entity is a cloud company.
(85) The system of (80), wherein the other entity is a syndicate of banks.

### Issuing Digital Currency (Bank+Bank Charter)

(86) A system for facilitating a transaction between a first entity and a second entity using a digital currency issued by a bank or an entity with a bank charter, comprising:

a computing node, wherein the computing node is included in a plurality of computing nodes participating in a distributed ledger, wherein the distributed ledger stores transaction information representing transactions in a digital currency that is issued by a bank or an entity with a bank charter and is fixed with respect to a fiat currency, wherein at least one computing node in the plurality of computing nodes stores and maintains a respective copy of the distributed ledger, and wherein the computing node is configured to:
receive a transaction for transferring an amount of the digital currency from the first entity to the second entity;
determine that the transaction is authorized by the first entity based on a digital signature or identifier for the first entity;
generate new transaction information representing the transaction in the digital currency for addition to the distributed ledger;
transmit the new transaction information to at least one of the plurality of computing nodes participating in the distributed ledger;
receive, from the at least one of the plurality of computing nodes, an indication of validity of the new transaction information; and
based on the indication of validity, insert the new transaction information into the copy of the distributed ledger to complete the transaction for transferring the amount of the digital currency from the first entity to the second entity.

### Processing Transactions

(87) The system of (86), wherein:

the new transaction information is generated at the bank or the entity with the bank charter and transmitted to an other entity for insertion into a distributed ledger for the other entity, or

the new transaction information is generated at the other entity and transmitted to the bank or the entity with the bank charter for insertion into the distributed ledger.

(88) The system of (87), wherein the other entity is a government entity.
(89) The system of (87), wherein the other entity is a payment processor company.
(90) The system of (87), wherein the other entity is a technology company.
(91) The system of (87), wherein the other entity is a cloud company.
(92) The system of (87), wherein the other entity is a syndicate of banks.
(93) The system of (87), wherein the other entity is a clearing house.

### Custodians of Digital Currency

(94) A digital wallet for one or more digital currencies from one or more financial institutions, comprising:

one or more pairs of public and private keys for a user holding one or more digital currencies from one or more of financial institutions, including a digital currency issued by a financial institution and that is fixed with respect to a fiat currency, wherein:

the digital wallet is a self-hosted digital wallet,

a plurality of computing nodes participate in a distributed ledger for the financial institution and/or a clearing house,

the distributed ledger stores transaction information representing one or more transactions in the digital currency,

at least one computing node in the plurality of computing nodes:
receives a transaction for the user to receive from and/or send to the user or another user an amount of the digital currency,
generates new transaction information representing the transaction for addition to the distributed ledger,
transmits the new transaction information to at least one of the plurality of computing nodes,
receives, from the at least one of the plurality of computing nodes, an indication of validity of the new transaction information, and
based on the indication of validity, inserts the new transaction information into the distributed ledger to complete the transaction, and

one of a pair of public and private keys for the digital currency is used for the user to receive from and/or send to the user or the another user the digital currency and to record the transaction in the distributed ledger for the financial institution and/or the clearing house.

(95) The system of (94), wherein the one or more financial institutions comprise a government entity.
(96) The system of (94), wherein the one or more financial institutions comprise a technology company.
(97) The system of (94), wherein the one or more financial institutions comprise a syndicate of banks.
(98) The system of (94), wherein the one or more financial institutions comprise a clearing house.
(99) The system of (94), wherein the government institution is the custodian of the digital currency.

### Credit

(100) A digital wallet for one or more digital currencies from one or more financial institutions, comprising:

one or more pairs of public and private keys for a user holding one or more digital currencies from one or more of financial institutions, including a line of credit based on a digital currency issued by a financial institution and that is fixed with respect to a fiat currency, wherein:

a plurality of computing nodes participate in a distributed ledger for the financial institution,

the distributed ledger stores transaction information representing one or more transactions in the digital currency,

at least one computing node in the plurality of computing nodes:
receives a transaction for the user to draw on the line of credit for an amount of the digital currency,
generates new transaction information representing the transaction for addition to the distributed ledger,
transmits the new transaction information to at least one of the plurality of computing nodes,
receives, from the at least one of the plurality of computing nodes, an indication of validity of the new transaction information, and
based on the indication of validity, inserts the new transaction information into the distributed ledger to complete the transaction, and
   one of a pair of public and private keys for the line of credit based on the digital currency is used for the user to draw on the line of credit based on the digital currency and to record the transaction in the distributed ledger for the financial institution.

Example Computer Architecture

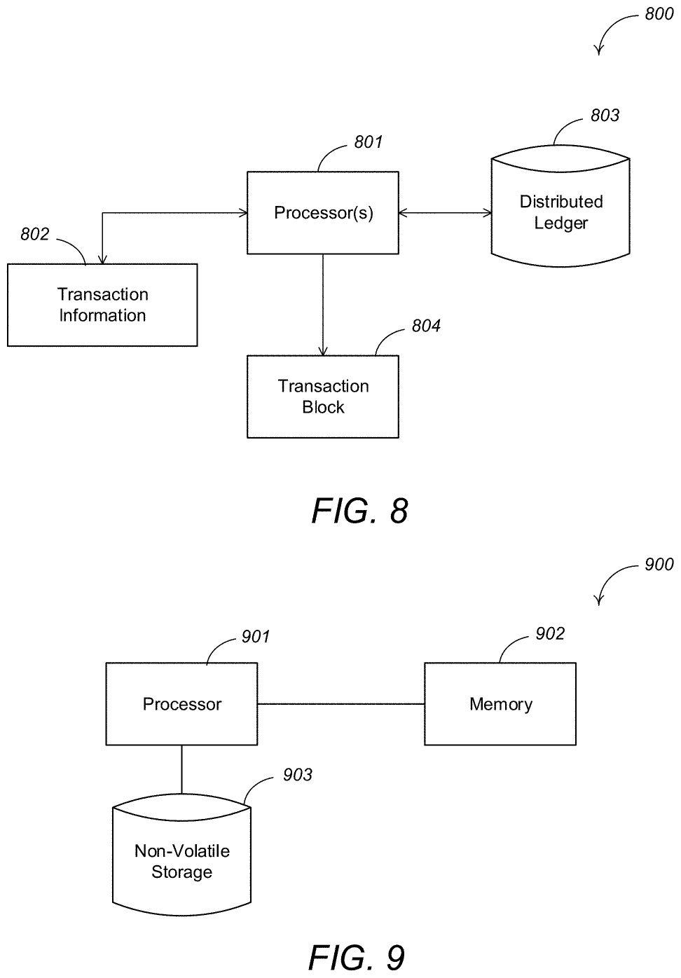

One example implementation of the described systems and methods is shown in FIG. 8. In particular, FIG. 8 shows an example implementation of a computing node for a private distributed ledger, a public distributed ledger, or a combination thereof, in accordance with some embodiments of the technology described herein. In particular, system 800 may include one or more processors 801 that are operable to generate a transaction block for a new financial transaction (e.g., element 804). Such information may be stored within memory or persisted to storage media. In some embodiments, processors 801 may receive transaction information 802 including one or more entities involved in the transaction, an amount for the transaction, a time stamp for the transaction, and other suitable transaction information. In some embodiments, processors 801 may receive and/or generate related transaction information, such as one or more transactions blocks, from the distributed ledger 803 for each new financial transaction executed according to at least some of the described systems and methods. Processors 801 may be configured to execute at least some of the described systems and methods to generate the transaction block 804 based on the transaction information 802 and/or the distributed ledger 803.

An illustrative implementation of a computing device 900 that may be used in connection with any of the embodiments of the disclosure provided herein is shown in FIG. 9. In particular, FIG. 9 shows an example computer system for executing one or more functions for a computing node participating in a private distributed ledger, a public distributed ledger, or a combination thereof, in accordance with some embodiments of the technology described herein. The computing device 900 may include one or more processors 901 and one or more articles of manufacture that comprise non-transitory computer-readable storage media (e.g., memory 902 and one or more non-volatile storage media 903). The processor 901 may control writing data to and reading data from the memory 902 and the non-volatile storage device 903 in any suitable manner. To perform any of the functionality described herein, the processor 901 may execute one or more processor-executable instructions stored in one or more non-transitory computer-readable storage media (e.g., the memory 903), which may serve as non-transitory computer-readable storage media storing processor-executable instructions for execution by the processor 901.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

All definitions, as defined and used herein, should be understood to control over dictionary definitions, and/or ordinary meanings of the defined terms.

As referred to herein, the term “in response to” may refer to initiated as a result of or caused by. In a first example, a first action being performed in response to a second action may include interstitial steps between the first action and the second action. In a second example, a first action being performed in response to a second action may not include interstitial steps between the first action and the second action.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system for facilitating a private transaction between a first entity and a second entity using a government issued digital currency issued by a government institution, comprising:
a computing node, wherein the computing node is included in a plurality of computing nodes participating in a distributed ledger, wherein the distributed ledger stores transaction information representing transactions in a government issued digital currency that is issued by a government institution and is fixed with respect to a fiat currency, wherein at least one computing node in the plurality of computing nodes stores and maintains a respective copy of the distributed ledger, and wherein the computing node is configured to:
receive a transaction for transferring an amount of the government issued digital currency from the first entity to the second entity;
determine that the transaction is authorized by the first entity based on a digital signature or identifier for the first entity;
generate new transaction information representing the transaction in the government issued digital currency for addition to the distributed ledger;
transmit the new transaction information to at least one of the plurality of computing nodes participating in the distributed ledger;
receive, from the at least one of the plurality of computing nodes, an indication of validity of the new transaction information; and
based on the indication of validity, insert the new transaction information into the distributed ledger to complete the transaction for transferring the amount of the government issued digital currency from the first entity to the second entity.

2. The system of claim 1, wherein the first entity is the government institution and wherein the second entity is a financial entity, and wherein the financial entity issues a digital currency based on the government issued digital currency.

3. The system of claim 1, wherein one or more transactions of the distributed ledger are configured to be accessed by a third entity.

4. The system of claim 3, wherein the third entity is a government entity.

5. The system of claim 3, wherein the third entity is a bank.

6. The system of claim 3, wherein the third entity is a cloud provider and wherein the cloud provider is configured to store the one or more transactions of the distributed ledger.

7. The system of claim 3, wherein the third entity is a clearing house.

8. The system of claim 1, wherein:
the new transaction information is generated at the government institution and transmitted to an other entity for insertion into a distributed ledger for the other entity, or
the new transaction information is generated at the other entity and transmitted to the government institution for insertion into the distributed ledger.

9. The system of claim 8, wherein the other entity is a government entity.

10. The system of claim 8, wherein the other entity is a payment processor company.

11. The system of claim 8, wherein the other entity is a technology company.

12. The system of claim 8, wherein the other entity is a cloud company.

13. The system of claim 8, wherein the other entity is a syndicate of banks.

14. A system for facilitating a transaction between a first entity and a second entity using a digital currency issued by a bank or an entity with a bank charter, comprising:
a computing node, wherein the computing node is included in a plurality of computing nodes participating in a distributed ledger, wherein the distributed ledger stores transaction information representing transactions in a digital currency that is issued by a bank or an entity with a bank charter and is fixed with respect to a fiat currency, wherein at least one computing node in the plurality of computing nodes stores and maintains a respective copy of the distributed ledger, and wherein the computing node is configured to:
receive a transaction for transferring an amount of the digital currency from the first entity to the second entity;
determine that the transaction is authorized by the first entity based on a digital signature or identifier for the first entity;
generate new transaction information representing the transaction in the digital currency for addition to the distributed ledger;
transmit the new transaction information to at least one of the plurality of computing nodes participating in the distributed ledger;
receive, from the at least one of the plurality of computing nodes, an indication of validity of the new transaction information; and
based on the indication of validity, insert the new transaction information into the copy of the distributed ledger to complete the transaction for transferring the amount of the digital currency from the first entity to the second entity.

15. The system of claim 14, wherein:
the new transaction information is generated at the bank or the entity with the bank charter and transmitted to an other entity for insertion into a distributed ledger for the other entity, or
the new transaction information is generated at the other entity and transmitted to the bank or the entity with the bank charter for insertion into the distributed ledger.

16. The system of claim 15, wherein the other entity is a government entity.

17. The system of claim 15, wherein the other entity is a payment processor company.

18. The system of claim 15, wherein the other entity is a technology company.

19. The system of claim 15, wherein the other entity is a cloud company.

20. The system of claim 15, wherein the other entity is a syndicate of banks.

21. The system of claim 15, wherein the other entity is a clearing house.

22. A digital wallet for one or more digital currencies from one or more financial institutions, comprising:
one or more pairs of public and private keys for a user holding one or more digital currencies from one or more of financial institutions, including a digital currency issued by a financial institution and that is fixed with respect to a fiat currency, wherein:
the digital wallet is a self-hosted digital wallet,
a plurality of computing nodes participate in a distributed ledger for the financial institution and/or a clearing house,
the distributed ledger stores transaction information representing one or more transactions in the digital currency,
at least one computing node in the plurality of computing nodes:
receives a transaction for the user to receive from and/or send to the user or another user an amount of the digital currency,
generates new transaction information representing the transaction for addition to the distributed ledger,
transmits the new transaction information to at least one of the plurality of computing nodes,
receives, from the at least one of the plurality of computing nodes, an indication of validity of the new transaction information, and
based on the indication of validity, inserts the new transaction information into the distributed ledger to complete the transaction, and
one of a pair of public and private keys for the digital currency is used for the user to receive from and/or send to the user or the another user the digital currency and to record the transaction in the distributed ledger for the financial institution and/or the clearing house.

23. The system of claim 22, wherein the one or more financial institutions comprise a government entity.

24. The system of claim 22, wherein the one or more financial institutions comprise a technology company.

25. The system of claim 22, wherein the one or more financial institutions comprise a syndicate of banks.

26. The system of claim 22, wherein the one or more financial institutions comprise a clearing house.

27. The system of claim 22, wherein the government institution is the custodian of the digital currency.

28. A digital wallet for one or more digital currencies from one or more financial institutions, comprising:
one or more pairs of public and private keys for a user holding one or more digital currencies from one or more of financial institutions, including a line of credit based on a digital currency issued by a financial institution and that is fixed with respect to a fiat currency, wherein:
a plurality of computing nodes participate in a distributed ledger for the financial institution,
the distributed ledger stores transaction information representing one or more transactions in the digital currency,
at least one computing node in the plurality of computing nodes:
receives a transaction for the user to draw on the line of credit for an amount of the digital currency,
generates new transaction information representing the transaction for addition to the distributed ledger,
transmits the new transaction information to at least one of the plurality of computing nodes,
receives, from the at least one of the plurality of computing nodes, an indication of validity of the new transaction information, and
based on the indication of validity, inserts the new transaction information into the distributed ledger to complete the transaction, and
one of a pair of public and private keys for the line of credit based on the digital currency is used for the user to draw on the line of credit based on the digital currency and to record the transaction in the distributed ledger for the financial institution.
